(19) United States
(12) Patent Application Publication
(10) Pub. No.: US 2012/0122629 A1
(43) Pub. Date: May 17, 2012

(54) POWER PLANT

(75) Inventors: Shigemitsu Akutsu, Saitama-ken (JP); Masashi Bando, Saitama-ken (JP); Kota Kasaoka, Saitama-ken (JP); Noriyuki Abe, Saitama-ken (JP)

(73) Assignee: HONDA MOTOR CO., LTD., Tokyo (JP)

(21) Appl. No.: 13/386,673

(22) PCT Filed: Jul. 23, 2010
(86) PCT No.: PCT/JP2010/062426

§ 371 Date: Jan. 24, 2012

(30) Foreign Application Priority Data
Jul. 29, 2009 (JP) 2009-176286

(51) Int. Cl. B60W 10/04; B60W 20/00

(52) U.S. Cl. 477/3; 180/65.265

(57) ABSTRACT

A power plant which is capable of preventing losses due to power circulation and enhancing driving efficiency thereof in an EV operation mode. In the power plant 1, power transmission mechanisms PS1 and PS2 have first to fourth elements R1, C1, S2, S1, C2, and R2 configured such that they rotate during transmission of motive power therebetween while holding a collinear relationship with respect to rotational speed and are sequentially aligned in a collinear chart representing the relationship with respect to the rotational speed are connected to a first rotating machine 11, a prime mover 3, driven parts DW and DW and a second rotating machine 21, respectively. Further, during the EV operation mode, the operations of the first and second rotating machines 11 and 21 are controlled such that no power circulation occurs in which part of motive power output from one of the rotating machines 11 and 21 is input to the one in a state converted to electric power by the other, whereby the part of the motive power is output again from the one as motive power.

### TECHNICAL FIELD

The present invention relates to a power plant for driving driven parts, and more particularly to a power plant equipped with a plurality of motive power sources different from each other.

### BACKGROUND ART

Conventionally, as the power plant of this kind, one disclosed in Patent Literature 1 is known. This power plant is applied to a vehicle, and is equipped with an internal combustion engine, first and second rotating machines as motive power sources, and a Ravigneaux type planetary gear unit for transmitting motive power to the drive wheels of the vehicle. This planetary gear unit comprises a first sun gear, a ring gear, a carrier and a second sun gear. The rotational speeds of these first sun gear, ring gear, carrier and second sun gear are in a collinear relationship with each other, and in the collinear relationship indicative of the relationship between the rotational speeds thereof, straight lines representing the respective rotational speeds are arranged in order. Further, the first sun gear, the ring gear, the carrier and the second sun gear are connected to the first rotating machine, the engine, the drive wheels, and the second rotating machine, respectively, and a clutch is disposed between the engine and the ring gear. Furthermore, connected to the respective first and second rotating machines are electric circuits for controlling the operations thereof.

In the conventional power plant configured as above, in an EV standing start mode, using only the first and second rotating machines as motive power sources, the drive wheels are driven in the following manner: The clutch disconnects the engine from the ring gear. In this state, by inputting electric power to the first rotating machine, motive power is caused to be output from the first rotating machine to cause the first rotating machine to perform normal rotation together with the first sun gear. In accordance therewith, part of the motive power of the first rotating machine is transmitted to the second rotating machine via the planetary gear unit to cause the second rotating machine to perform reverse rotation. Further, the motive power thus transmitted to the second rotating machine is used to generate electric power in the second rotating machine, and along therewith, braking torque acts on the second sun gear. The torque of the first rotating machine transmitted to the first sun gear is transmitted to the drive wheels via the carrier using the braking torque as a reaction force, whereby the drive wheels are driven for normal rotation. In this conventional power plant, during the EV standing start mode, the first and second rotating machines are caused to perform normal rotation and reverse rotation, respectively, as described above, to thereby prevent overheating due to flowing of electric power only through a specific one of the above-mentioned electric circuits.

### CITATION LIST

### Patent Literature

[PTL 1] Japanese Patent Publication No. 4239923

### SUMMARY OF INVENTION

### Technical Problem

In the above-described conventional power plant, however, in a case where electric power generated in the second rotating machine is input to the first rotating machine, there occurs, during transmission of motive power to the drive wheels, the following power circulation: Part of the motive power output from the first rotating machine is transmitted to the second rotating machine via the planetary gear unit, and is input to the first rotating machine in a state converted to electric power by the second rotating machine. After being output from the first rotating machine as motive power again, and then it is transmitted to the drive wheels. When such power circulation occurs, losses occur when the part of the motive power is transmitted to the second rotating machine via the planetary gear unit, when the transmitted motive power is converted to electric power in the second rotating machine, when the electric power converted from the motive power is input to the first rotating machine, and when the input electric power is output from the first rotating machine again as motive power. As described above, losses are increased by the power circulation, which results in degraded driving efficiency in driving the drive wheels.

The present invention has been made to provide a solution to the above-described problems, and an object thereof is to provide a power plant which is capable of preventing losses due to power circulation and enhancing the driving efficiency thereof in driving driven parts in an EV operation mode.

### Solution to Problem

To attain the object, the invention as claimed in claim 1 is a power plant 91, 111 for driving driven parts (drive wheels DW and DW in embodiments (the same applies hereinafter in this section)), comprising a prime mover (engine 3) including a first output portion (crankshaft 3a) for outputting motive power, a first rotating machine 11 (second rotating machine 21) including a second output portion (first rotor 13, second rotor 23), a power transmission mechanism (first planetary gear unit PS1, second planetary gear unit PS2) including a first element (first sun gear S1, second sun gear S2), a second element (first carrier C1, second carrier C2), and a third element (first ring gear R1, second ring gear R2) that are capable of transmitting motive power therebetween, the first to third elements being configured to rotate while holding a collinear relationship therebetween with respect to rotational speed, and be sequentially aligned in a collinear chart representing the collinear relationship with respect to the rotational speed, a second rotating machine 71 (first rotating machine 61) including an unmovable stator (second stator 73, first stator 63) for generating a rotating magnetic field, a first rotor 64 (third rotor 74) formed by magnets (permanent magnets 74a, permanent magnets 64a) and disposed in a manner opposed to the stator, and a second rotor 65 (fourth rotor 75) formed by a soft magnetic material (cores 75a, cores 65a) and disposed between the stator and the first rotor 64, the second rotating machine 71 being configured such that electric power and motive power are input and output between the stator and the first and second rotors 64, 65 along with generation of the rotating magnetic field, and such that the rotating magnetic field, the second rotor 65, and the first rotor 64 rotate while holding a collinear relationship therebetween, and are sequentially aligned in a collinear chart representing the collinear relationship with respect to the rotational speed, and a control system (ECU 2, first PDU 31, second PDU 32, VCU 33) for controlling operations of the first and second rotating machines 11, 71, wherein one of a pair of the second element and the first rotor 64 and a pair of the first element and the second rotor 65 are connected to the first output portion while the other of the pair of the second element and the first rotor 64 and the pair of the first element and the second rotor 65 are connected to the driven parts, and the third element is connected to the second output portion, wherein the first rotating machine 11 and the stator are configured to be capable of giving and receiving electric power therebetween, and wherein the control system controls the operations of the first and second rotating machines 11, 71 such that during an EV operation mode for driving the driven parts by controlling the operations of the first and second rotating machines 11, 71 during stoppage of the prime mover, power circulation is not caused in which part of motive power output from one of the first and second rotating machines 11, 71 is input to the one of the first and second rotating machines 11, 71 in a state converted to electric power by the other of the first and second rotating machines 11, 71, whereby the part of the motive power is output again from the one of the first and second rotating machines 11, 71 as motive power (FIGS. 31, 36).

According to this power plant, in the power transmission mechanism, the first to third elements are capable of transmitting motive power therebetween. The first to third elements rotate while holding the collinear relationship therebetween with respect to the rotational speed, and are sequentially aligned in the collinear chart representing the relationship between the rotational speeds of the first to third elements. Further, in the second rotating machine, electric power and motive power are input and output between the stator and the first and second rotors along with generation of the rotating magnetic field in the stator, and the rotating magnetic field, the second rotor, and the first rotor rotate while holding the collinear relationship therebetween with respect to the rotational speed, and are sequentially aligned in the collinear chart representing the relationship between the rotational speeds thereof.

Further, one of the pair of the second element and the first rotor and the pair of the first element and the second rotor are connected to the first output portion of the prime mover, the other of the pair of the second element and the first rotor and the pair of the first element and the second rotor are connected to the driven parts, and the third element is connected to the second output portion of the first rotating machine. The first rotating machine and the stator are configured to be capable of giving and receiving electric power therebetween. Further, the operations of the first and second rotating machines are controlled by the control system. With the arrangement described above, the driven parts can be driven using the motive power from the prime mover and the first and second rotating machines.

Further, in the EV operation mode, during stoppage of the prime mover, the driven parts are driven by controlling the operations of the first and second rotating machines. During this EV operation mode, the operations of the first and second rotating machines are controlled such that there occurs no power circulation in which part of motive power output from one of the first and second rotating machines is input to the one of the first and second rotating machines in a state converted to electric power by the other of the first and second rotating machines, whereby the part of the motive power is output again from the one of the first and second rotating machines as motive power. Therefore, in the EV operation mode, it is possible to prevent losses due to the power circulation, thereby making it possible to enhance the driving efficiency of the power plant in driving the driven parts. Note that it is assumed that the term “connect” used in the specification and the claims is intended to encompass not only connecting the various elements using a shaft, gears, a pulley, a chain, or the like but also directly connecting (direct connection of) the elements using e.g. a shaft, without via a transmission, such as gears.

The invention as claimed in claim 2 is the power plant 91 as claimed in claim 1, wherein the second element (first carrier C1) and the first rotor (third rotor 74) are connected to the first output portion, while the first element (first sun gear S1) and the second rotor (fourth rotor 75) are connected to the driven parts, and wherein during the EV operation mode, the control system controls the operations of the first and second rotating machines 11, 71 such that rotational speeds of the second element and the first rotor become equal to or lower than rotational speeds of the first element and the second rotor, respectively (FIG. 31).

During the EV operation mode for driving the driven parts by the first and second rotating machines during stoppage of the prime mover, as the rotational speed of the first output portion of the prime mover is higher, that is, as motive power transmitted from the first and second rotating machines to the first output portion is larger, the driving efficiency in driving the drive wheels is lower.

According to the above-described construction, the operations of the first and second rotating machines are controlled such that the rotational speeds of the second element and the first rotor connected to the first output portion become equal to or lower than the rotational speeds of the first element and the second rotor connected to the driven parts, respectively. This makes it possible to hold the rotational speed of the first output portion in a relatively low state, so that it is possible to prevent motive power from being wastefully transmitted from the first and second rotating machines to the first output portion, whereby it is possible to further enhance the driving efficiency.

The invention as claimed in claim 3 is the power plant 91 as claimed in claim 2, wherein during the EV operation mode, the control system controls the operations of the first and second rotating machines 11, 71 such that a rotational speed (first rotating machine rotational speed NM1) of the second output portion (first rotor 13) becomes higher than 0 (FIG. 31).

As described hereinabove, in the second rotating machine, the rotating magnetic field and the second and first rotors rotate while holding the collinear relationship therebetween with respect to the rotational speed, and are sequentially aligned in the collinear chart representing the relationship between the rotational speeds thereof. Further, the first to third elements are configured to rotate while holding the collinear relationship therebetween with respect to the rotational speed, and be sequentially aligned in the collinear chart representing the relationship between the rotational speeds thereof. Furthermore, according to the arrangement described above, the third element is connected to the second output portion of the first rotating machine, the second element and the first rotor are connected to the first output portion of the prime mover, and the first element and the second rotor are connected to the driven parts.

With the arrangement described above, during the EV operation mode, to control the rotational speeds of the second element and the first rotor connected to the first output portion such that they become lower, in a state where the above-described power circulation is not caused, so as to suppress wasteful transmission of motive power to the first output portion, as described above as to the operation of claim 2, it is preferable to control the rotational speed of the second output portion to which the third element is connected, such that it becomes equal to 0.

However, for example, in a case where a rotating machine including multi-phase coils for generating a rotating magnetic field is used as the first rotating machine, and electric power is input to the first rotating machine from an electric circuit, such as an inverter having switching elements, when the rotational speed of the second output portion of the first rotating machine is controlled such that it becomes equal to 0, as described above, there can occur the following inconvenience: In this case, there is a fear that electric current flows through only a specific phase coil of the first rotating machine, and only a switching element associated with the specific phase coil is turned on, so that the coil and the switching element are overheated. When the maximum value of the electric current input to the first rotating machine is made smaller so as to suppress such overheating of the coil and the switching element, the output torque of the first rotating machine becomes small.

According to the above-described construction of the present invention, during the EV operation mode, the operations of the first and second rotating machines are controlled such that the rotational speed of the second output portion becomes higher than 0, and hence it is possible to prevent the above-mentioned overheating of the first rotating machine and the electric circuit and ensure a sufficiently large output torque of the first rotating machine.

The invention as claimed in claim 4 is the power plant 111 as claimed in claim 1, wherein the first element (second sun gear S2) and the second rotor 65 are connected to the first output portion, while the second element (second carrier C2) and the first rotor 64 are connected to the driven parts, and wherein during the EV operation mode, the control system controls the operations of the first and second rotating machines (second and first rotating machines 21, 61) such that rotational speeds of the first element and the second rotor 65 become equal to or lower than rotational speeds of the second element and the first rotor 64, respectively (FIG. 36).

During the EV operation mode for driving the driven parts by the first and second rotating machines during stoppage of the prime mover, as the rotational speed of the first output portion of the prime mover is higher, that is, as motive power transmitted from the first and second rotating machines to the first output portion is larger, the driving efficiency in driving the drive wheels is lower.

According to the above-described arrangement, the operations of the first and second rotating machines are controlled such that the rotational speeds of the first element and the second rotor connected to the first output portion become equal to or lower than the rotational speeds of the second element and the first rotor connected to the driven parts, respectively. This makes it possible to hold the rotational speed of the first output portion in a relatively low state, and hence it is possible to prevent motive power from being wastefully transmitted from the first and second rotating machines to the first output portion, whereby it is possible to further enhance the driving efficiency.

The invention as claimed in claim 5 is the power plant 111 as claimed in claim 4, wherein during the EV operation mode, the control system controls the operations of the first and second rotating machines such that a rotational speed (first magnetic field rotational speed NMF1) of the rotating magnetic field becomes higher than 0.

As described heretofore, in the second rotating machine, the rotating magnetic field, the second rotor, and the first rotor rotate while holding the collinear relationship therebetween with respect to the rotational speed, and are sequentially aligned in the collinear chart representing the relationship between the rotational speeds thereof. Further, the first to third elements are arranged such that they rotate while holding the collinear relationship therebetween with respect to the rotational speed, and are sequentially aligned in the collinear chart representing the relationship between the rotational speeds thereof. Furthermore, according to the above-described arrangement, the first element and the second rotor are connected to the first output portion of the prime mover, the second element and the first rotor are connected to the driven parts, and the third element is connected to the second output portion of the first rotating machine.

With the arrangement described above, during the EV operation mode, to control the rotational speeds of the first element and the second rotor connected to the first output portion such that they become lower, in the state where the above-described power circulation is not caused, so as to suppress wasteful transmission of motive power to the first output portion, as described above as to the operation of claim 4, it is preferable to control the rotational speed of the rotating magnetic field such that it becomes equal to 0.

However, for example, in a case where the stator of the second rotating machine is formed e.g. by multi-phase coils for generating a rotating magnetic field, and electric power is input to the stator from an electric circuit, such as an inverter having switching elements, when the rotational speed of the rotating magnetic field is controlled such that it becomes equal to 0, as described above, there can occur the following inconvenience: In this case, there is a fear that electric current flows through only a specific phase coil of the stator, and only a switching element associated with the specific phase coil is turned on, so that the coil and the switching element are overheated. When the maximum value of the electric current input to the stator is made smaller so as to suppress such overheating of the coil and the switching element, the output torque of the second rotating machine becomes small.

According to the above-described arrangement of the present invention, during the EV operation mode, the operations of the first and second rotating machines are controlled such that the rotational speed of the rotating magnetic field becomes higher than 0, and hence it is possible to prevent overheating of the above-mentioned second rotating machine and the electric circuit and ensure a sufficiently large output torque of the second rotating machine.

The invention as claimed in claim 6 is the power plant 91, 111 as claimed in any one of claims 1 to 5, wherein a predetermined plurality of magnet magnetic poles arranged in a circumferential direction are formed by the magnets, and a magnetic pole row is formed by arranging the plurality of magnet magnetic poles such that each two magnet magnetic poles adjacent to each other have polarities different from each other, wherein the first rotor 64 is configured to be rotatable in the circumferential direction, wherein the stator has an armature row (iron core 73a, U-phase to W-phase coils 73b, iron core 63a, U-phase to W-phase coils 63c to 63e) that generates a predetermined plurality of armature magnetic poles, to thereby cause the rotating magnetic field rotating in the circumferential direction to be generated between the armature row and the magnetic pole row, wherein the soft magnetic material is formed by a predetermined plurality of soft magnetic material elements arranged in the circumferential direction in a manner spaced from each other, and a soft magnetic material element row formed by the plurality of soft magnetic material elements is disposed between the magnetic pole row and the armature row, wherein the second rotor 65 is configured to be rotatable in the circumferential direction, and wherein a ratio between the number of the armature magnetic poles, the number of the magnet magnetic poles, and the number of the soft magnetic material elements is set to 1:m:(1+m)/2 (m≠1.0).

With this arrangement, for a reason described hereinafter, by setting the ratio between the number of the armature magnetic poles, the number of the magnet magnetic poles, and the number of the soft magnetic material elements as desired, within a range satisfying the condition of 1:m:(1+m)/2 (m≠1.0), it is possible to set the collinear relationship between the rotating magnetic field and the first and second rotors with respect to the rotational speed, as desired. Therefore, it is possible to enhance the degree of freedom in design of the second rotating machine.

Further, as described above as to the operation of claim 5, during the EV operation mode, to prevent occurrence of the above-described power circulation, and to suppress wasteful transmission of motive power to the first output portion, it is preferable to set the distance between a straight line representing the rotational speed of the second rotor and a straight line representing the rotational speed of the rotating magnetic field to be small, in the collinear chart representing the relationship between the rotational speeds of the rotating magnetic field and the first and second rotors, since the first and second rotors are connected to the driven parts and the first output portion, respectively, as described above. According to the present invention, the collinear relationship between the rotational speeds of the rotating magnetic field and the first and second rotors of the second rotating machine can be set as desired, as described above, and hence it is possible to easily make the above-mentioned preferable setting, thereby making it possible to efficiently obtain the advantageous effects provided by the above-described claims 4 and 5.

To attain the object, the invention as claimed in claim 7 provides a power plant 1 for driving driven parts (drive wheels DW and DW in the embodiment (the same applies hereinafter in this section)), comprising a prime mover (engine 3) including an output portion (crankshaft 3a) for outputting motive power, a first rotating machine 11 including a first rotor 13, a second rotating machine 21 including a second rotor 23, a control system (ECU 2, first PDU 31, second PDU 32, VCU 33) for controlling operations of the first and second rotating machines 11, 21, and a power transmission mechanism (first planetary gear unit PS1, second planetary gear unit PS2) including at least a first element (first ring gear R1), a second element (first carrier C1, second sun gear S2), a third element (first sun gear S1, second carrier C2), and a fourth element (second ring gear R2) that are capable of transmitting motive power therebetween, the first to fourth elements being configured to rotate while holding a collinear relationship therebetween with respect to rotational speed, and be sequentially aligned in a collinear chart representing the collinear relationship with respect to the rotational speed, wherein the first to fourth elements are connected to the first rotor 13, the output portion, the driven parts, and the second rotor 23, respectively, wherein the first and second rotating machines 11, 21 are configured to be capable of giving and receiving electric power therebetween, and wherein the control system controls the operations of the first and second rotating machines 11, 21 such that during an EV operation mode for driving the driven parts by controlling the operations of the first and second rotating machines 11, 21 during stoppage of the prime mover, power circulation is not caused in which part of motive power output from one of the first and second rotating machines 11, 21 is input to the one of the first and second rotating machines 11, 21 in a state converted to electric power by the other of the first and second rotating machines 11, 21, whereby the part of the motive power is output again from the one of the first and second rotating machines 11, 21 as motive power (FIG. 5).

With this arrangement, in the power transmission mechanism, the first to fourth elements are capable of transmitting motive power therebetween, rotate while holding the collinear relationship therebetween with respect to the rotational speed, and are sequentially aligned in the collinear chart representing the relationship therebetween with respect to the rotational speed. Further, the first to fourth elements are connected to the first rotor of the first rotating machine, the output portion of the prime mover, the driven parts, and the second rotor of the second rotating machine, respectively, and the first and second rotating machines are configured to be capable of giving and receiving electric power therebetween. Further, the operations of the first and second rotating machines are controlled by the control system. With the arrangement described above, the driven parts can be driven by the motive power from the prime mover and the first and second rotating machines.

Further, in the EV operation mode, during stoppage of the prime mover, the driven parts are driven by controlling the operations of the first and second rotating machines. During this EV operation mode, the operations of the first and second rotating machines are controlled such that there occurs no power circulation in which part of motive power output from one of the first and second rotating machines is input to the one of the first and second rotating machines in a state converted to electric power by the other of the first and second rotating machines, whereby the part of the motive power is output again from the one of the first and second rotating machines as motive power. Therefore, in the EV operation mode, it is possible to prevent losses due to the power circulation, thereby making it possible to enhance the driving efficiency of the power plant in driving driven parts.

The invention as claimed in claim 8 is the power plant 1 as claimed in claim 7, wherein during the EV operation mode, the control system controls the operations of the first and second rotating machines 11, 21 such that a rotational speed of the second element becomes equal to or lower than a rotational speed of the third element (FIG. 5).

As described hereinabove, the first to fourth elements are connected to the first rotor, the output portion of the prime mover, the driven parts, and the second rotor, respectively, and hence during the EV operation mode for driving the driven parts by the first and second rotating machines during stoppage of the prime mover, the motive power of the first and second rotating machines is transmitted not only to the driven parts but also to the output portion. Therefore, during the EV operation mode, as the rotational speed of the output portion of the prime mover is higher by the transmission of the motive power from the first and second rotating machines, that is, as motive power wastefully transmitted to the output portion is larger, the driving efficiency in driving the drive wheels is lower.

According to the above-described arrangement, during the EV operation mode, the operations of the first and second rotating machines are controlled such that the rotational speed of the second element connected to the output portion becomes equal to or lower than the rotational speed of the third element connected to the driven parts. This makes it possible to hold the rotational speed of the output portion in a relatively low state, and hence it is possible to prevent motive power from being wastefully transmitted from the first and second rotating machines to the output portion, thereby making it possible to further enhance the driving efficiency.

The invention as claimed in claim 9 is the power plant 1 as claimed in claim 8, wherein during the EV operation mode, the control system controls the operations of the first and second rotating machines 11, 21 such that a rotational speed of the first rotor 13 (first rotating machine rotational speed NM1) becomes higher than 0 (FIG. 5).

As described hereinabove, the first to fourth elements are configured such that they rotate while holding the collinear relationship therebetween with respect to the rotational speed, and are sequentially aligned in the collinear chart representing the relationship between the rotational speeds thereof. Further, the first to fourth elements are connected to the first rotor, the output portion of the prime mover, the driven parts, and the second rotor, respectively.

With the arrangement described above, during the EV operation mode, to control the rotational speed of the second element connected to the output portion such that it becomes lower, in the state where the above-described power circulation is not caused, so as to suppress wasteful transmission of motive power to the output portion, as described above as to the operation of claim 8, it is preferable to control the rotational speed of the first rotor to which the first element is connected, such that it becomes equal to 0.

However, for example, in a case where a rotating machine including multi-phase coils for generating the first rotating magnetic field is used as the first rotating machine, and electric power is input to the first rotating machine from an electric circuit, such as an inverter having switching elements, when the rotational speed of the first rotor thereof is controlled such that it becomes equal to 0, as described above, there can occur the following inconvenience: In this case, there is a fear that electric current flows through only a specific phase coil of the first rotating machine, and only a switching element associated with the specific phase coil is turned on, so that the coil and the switching element are overheated. When the maximum value of the electric current input to the first rotating machine is made smaller so as to suppress such overheating of the coil and the switching element, the output torque of the first rotating machine becomes small.

According to the above-described construction of the present invention, during the EV operation mode, the operations of the first and second rotating machines are controlled such that the rotational speed of the first rotor becomes higher than 0, and hence it is possible to prevent the above-mentioned overheating of the first rotating machine and the electric circuit and ensure a sufficiently large output torque of the first rotating machine.

To attain the object, the invention as claimed in claim 10 provides a power plant 51 for driving driven parts (drive wheels DW and DW in the embodiment (the same applies hereinafter in this section)), comprising a prime mover (engine 3) including an output portion (crankshaft 3a) for outputting motive power, a first rotating machine 61 including an unmovable first stator 63 for generating a first rotating magnetic field, a first rotor 64 formed by first magnets (permanent magnets 64a) and disposed in a manner opposed to the first stator 63, and a second rotor 65 formed by a first soft magnetic material (cores 65a) and disposed between the first stator 63 and the first rotor 64, the first rotating machine 61 being configured such that electric power and motive power are input and output between the first stator 63 and the first and second rotors 64, 65 along with generation of the first rotating magnetic field, and such that the first rotating magnetic field, the second rotor 65, and the first rotor 64 rotate while holding a collinear relationship therebetween with respect to rotational speed, and are sequentially aligned in a collinear chart representing the collinear relationship with respect to the rotational speed, a second rotating machine 71 including an unmovable second stator 73 for generating a second rotating magnetic field, a third rotor 74 formed by second magnets (permanent magnets 74a) and disposed in a manner opposed to the second stator 73, and a fourth rotor 75 formed by a second soft magnetic material (cores 75a) and disposed between the second stator 73 and the third rotor 74, the second rotating machine 71 being configured such that electric power and motive power are input and output between the second stator 73 and the third and fourth rotors 74, 75 along with generation of the second rotating magnetic field, and such that the second rotating magnetic field, the fourth rotor 75, and the third rotor 74 rotate while holding a collinear relationship therebetween with respect to rotational speed, and are sequentially aligned in a collinear chart representing the collinear relationship with respect to the rotational speed, and a control system (ECU 2, first PDU 31, second PDU 32, VCU 33) for controlling operations of the first and second rotating machines 61, 71, wherein the second and third rotors 65, 74 are connected to the output portion, while the first and fourth rotors 64, 75 are connected to the driven parts, wherein the first and second stators 63, 73 are configured to be capable of giving and receiving electric power therebetween, and wherein the control system controls the operations of the first and second rotating machines 61, 71 such that during an EV operation mode for driving the driven parts by controlling the operations of the first and second rotating machines 61, 71 during stoppage of the prime mover, power circulation is not caused in which part of motive power output from one of the first and second rotating machines 61, 71 is input to the one of the first and second rotating machines 61, 71 in a state converted to electric power by the other of the first and second rotating machines 61, 71, whereby the part of the motive power is output again from the one of the first and second rotating machines 61, 71, as motive power (FIG. 26).

According to this power plant, in the first rotating machine, along with generation of the first rotating magnetic field by the first stator, electric power and motive power are input and output between the first stator and the first and second rotors, and the first rotating magnetic field, the second rotor, and the first rotor rotate while holding the collinear relationship therebetween with respect to the rotational speed and are sequentially aligned in the collinear chart representing the relationship with respect to the rotational speed. Further, in the second rotating machine, along with generation of the second rotating magnetic field by the second stator, electric power and motive power are input and output between the second stator and the third and fourth rotors, and the second rotating magnetic field, the fourth rotor, and the third rotor rotate while holding the collinear relationship therebetween with respect to rotational speed and are sequentially aligned in the collinear chart representing the relationship with respect to the rotational speed.

Further, the second and third rotors are connected to the output portion of the prime mover while the first and fourth rotors are connected to the driven parts, and the first and second stators are configured to be capable of giving and receiving electric power therebetween. Further, the operations of the first and second rotating machines are controlled by the control system. With the arrangement described above, the driven parts can be driven by the motive power from the prime mover and the first and second rotating machines.

Further, in the EV operation mode, during stoppage of the prime mover, the driven parts are driven by controlling the operations of the first and second rotating machines. During this EV operation mode, the operations of the first and second rotating machines are controlled such that there occurs no power circulation in which part of motive power output from one of the first and second rotating machines is input to the one of the first and second rotating machines in a state converted to electric power by the other of the first and second rotating machines, whereby the part of the motive power is output again from the one of the first and second rotating machines as motive power. Therefore, in the EV operation mode, it is possible to prevent losses due to the power circulation, thereby making it possible to enhance the driving efficiency in driving driven parts.

The invention as claimed in claim 11 is the power plant 51 as claimed in claim 10, wherein during the EV operation mode, the control system controls the operations of the first and second rotating machines 61, 71 such that rotational speeds of the second rotor 65 and the third rotor 74 become equal to or lower than rotational speeds of the first rotor 64 and the fourth rotor 75, respectively (FIG. 26).

Similarly to the power plant as claimed in claim 8, during the EV operation mode for driving the driven parts by the first and second rotating machines during stoppage of the prime mover, as the rotational speed of the output portion of the prime mover is higher, that is, as motive power wastefully transmitted from the first and second rotating machines to the output portion is larger, the driving efficiency in driving the drive wheels is lower.

According to the above-described construction, the operations of the first and second rotating machines are controlled such that the rotational speeds of the second and third rotors connected to the output portion become equal to or lower than the rotational speeds of the first and fourth rotors connected to the driven parts, respectively. This makes it possible to hold the rotational speed of the output portion in a relatively low state, and hence it is possible to prevent motive power from being wastefully transmitted from the first and second rotating machines to the output portion, thereby making it possible to further enhance the driving efficiency.

The invention as claimed in claim 12 is the power plant 51 as claimed in claim 11, wherein during the EV operation mode, the control system controls the operations of the first and second rotating machines 61, 71 such that a rotational speed (first magnetic field rotational speed NMF1) of the first rotating magnetic field becomes higher than 0 (FIG. 26).

As described heretofore, the first rotating magnetic field and the second and first rotors rotate while holding the collinear relationship therebetween with respect to the rotational speed, and are sequentially aligned in the collinear chart representing the relationship between the rotational speeds thereof. Similarly, the second rotating magnetic field, the fourth rotor, and the third rotor rotate while holding the collinear relationship therebetween with respect to the rotational speed and are sequentially aligned in the collinear chart representing the relationship between the rotational speeds thereof. Further, the second and third rotors are connected to the output portion of the prime mover, while the first and fourth rotors are connected to the driven parts.

With the arrangement described above, during the EV operation mode, to control the rotational speeds of the second and first rotors connected to the output portion such that they become lower, in the state where the above-described power circulation is not caused, so as to suppress wasteful transmission of motive power to the output portion, as described above as to the operation of claim 11, it is preferable to control the rotational speed of the first rotating magnetic field such that it becomes equal to 0.

However, for example, in a case where the first stator is formed e.g. by multi-phase coils for generating the first rotating magnetic field, and electric power is input to the first stator from an electric circuit, such as an inverter having switching elements, when the rotational speed of the first rotating magnetic field is controlled such that it becomes equal to 0, there can occur the following inconvenience: In this case, there is a fear that electric current flows through only a specific phase coil of the first stator, and only a switching element associated with the specific phase coil is turned on, so that the coil and the switching element are overheated. When the maximum value of the electric current input to the first stator is made smaller so as to suppress such overheating of the coil and the switching element, the output torque of the first rotating machine becomes small.

According to the above-described arrangement of the present invention, during the EV operation mode, the operations of the first and second rotating machines are controlled such that the rotational speed of the first rotating magnetic field becomes higher than 0, and hence it is possible to prevent the above-mentioned overheating of the first rotating machine and the electric circuit and ensure a sufficiently large output torque of the first rotating machine.

The invention as claimed in claim 13 is the power plant 51 as claimed in any one of claims 10 to 12, wherein a predetermined plurality of first magnet magnetic poles arranged in a first circumferential direction are formed by the first magnets, and a first magnetic pole row is formed by arranging the plurality of first magnet magnetic poles such that each two first magnet magnetic poles adjacent to each other have polarities different from each other, wherein the first rotor 64 is configured to be rotatable in the first circumferential direction, wherein the first stator 63 has a first armature row (iron core 63a, U-phase to W-phase coils 63c to 63e) that generates a predetermined plurality of first armature magnetic poles, to thereby cause the first rotating magnetic field rotating in the first circumferential direction to be generated between the first armature row and the first magnetic pole row, wherein the first soft magnetic material is formed by a predetermined plurality of first soft magnetic material elements arranged in the first circumferential direction in a manner spaced from each other, and a first soft magnetic material element row formed by the plurality of first soft magnetic material elements is disposed between the first magnetic pole row and the first armature row, wherein the second rotor 65 is configured to be rotatable in the first circumferential direction, wherein a ratio between the number of the first armature magnetic poles, the number of the first magnet magnetic poles, and the number of the first soft magnetic material elements is set to 1:m:(1+m)/2 (m≠1.0), wherein a predetermined plurality of second magnet magnetic poles arranged in a second circumferential direction are formed by the second magnets, and a second magnetic pole row is formed by arranging the plurality of second magnet magnetic poles such that each two second magnet magnetic poles adjacent to each other have polarities different from each other, wherein the third rotor 74 is configured to be rotatable in the second circumferential direction, wherein the second stator 73 has a second armature row (iron core 73a, U-phase to W-phase coils 73b) that generates a predetermined plurality of second armature magnetic poles, to thereby cause the second rotating magnetic field rotating in the second circumferential direction to be generated between the second armature row and the second magnetic pole row, wherein the second soft magnetic material is formed by a predetermined plurality of second soft magnetic material elements arranged in the second circumferential direction in a manner spaced from each other, and a second soft magnetic material element row formed by the plurality of second soft magnetic material elements is disposed between the second magnetic pole row and the second armature row, wherein the fourth rotor 75 is configured to be rotatable in the second circumferential direction, and wherein a ratio between the number of the second armature magnetic poles, the number of the second magnet magnetic poles, and the number of the second soft magnetic material elements is set to 1:n:(1+n)/2 (n≠1.0).

With this arrangement, in the first rotating machine, for a reason described hereinafter, if the ratio between the number of the first armature magnetic poles, the number of the first magnet magnetic poles, and the number of the first soft magnetic material elements is set as desired, within the range satisfying the condition of 1:m:(1+m)/2 (m≠1.0), it is possible to set the collinear relationship between the rotational speeds of the first rotating magnetic field and the first and second rotors, as desired. This makes it possible to enhance the degree of freedom in design of the first rotating machine. Similarly, in the second rotating machine, for a reason described hereinafter, by setting the ratio between the number of the second armature magnetic poles, the number of the second magnet magnetic poles, and the number of the second soft magnetic material elements, as desired, within the range satisfying the condition of 1:n:(1+n)/2 (n≠1.0), it is possible to set the collinear relationship between the rotational speeds of the second rotating magnetic field and the third and fourth rotors, as desired. This makes it possible to enhance the degree of freedom in design of the second rotating machine.

Further, as described above as to the operation of claim 12, during the EV operation mode, in order to prevent occurrence of the above-described power circulation and to suppress wasteful transmission of motive power to the output portion, it is preferable to set the distance between a straight line representing the rotational speed of the second rotor and a straight line representing the rotational speed of the first rotating magnetic field to be small, in a collinear chart representing the relationship between the rotational speeds of the first rotating magnetic field and the first and second rotors, since the first and second rotors are connected to the driven parts and the output portion, respectively, as described above. According to the present invention, the collinear relationship between the rotational speeds of the first rotating magnetic field and the first and second rotors of the first rotating machine, can be set as desired, as described above, and hence it is possible to easily make the above-mentioned preferable setting, whereby it is possible to efficiently obtain the advantageous effects provided by the above-described claims 11 and 12.

To attain the object, the invention as claimed in claim 14 provides a power plant 1, 51, 91, 111 for driving driven parts (drive wheels DW and DW in the embodiments (the same applies hereinafter in this section)), comprising a prime mover (engine 3) including an output portion (crankshaft 3a) for outputting motive power, an electric power and motive power input/output device (first rotating machine 11, second rotating machine 21, first planetary gear unit PS1, second planetary gear unit PS2, first rotating machine 61, second rotating machine 71) including first rotating magnetic field-generating means (first stator 12, 63) unmovable for generating a first rotating magnetic field, second rotating magnetic field-generating means (second stator 22, 73) unmovable for generating a second rotating magnetic field, a first element (first carrier C1, second sun gear S2, second rotor 65, third rotor 74) which is rotatable, and a second element (first sun gear S1, second carrier C2, first rotor 64, fourth rotor 75) which is rotatable, the electric power and motive power input/output device being configured such that electric power and motive power are input and output between the first rotating magnetic field-generating means, the first element, the second element, and the second rotating magnetic field-generating means, along with generation of the first and second rotating magnetic fields, and such that the first rotating magnetic field, the first element, the second element, and the second rotating magnetic field rotate while holding a collinear relationship therebetween with respect to rotational speed, and are sequentially aligned in a collinear chart representing the collinear relationship with respect to the rotational speed, and a control system (ECU 2, first PDU 31, second PDU 32, VCU 33) for controlling an operation of the electric power and motive power input/output device, wherein the first and second elements are connected to the output portion and the driven parts, respectively, wherein the first and second rotating magnetic field-generating means are configured to be capable of giving and receiving electric power therebetween, and wherein the control system controls the operation of the electric power and motive power input/output device such that during an EV operation mode for driving the driven parts by controlling the operation of the electric power and motive power input/output device during stoppage of the prime mover, power circulation is not caused in which part of motive power output by inputting electric power to one of the first and second rotating magnetic field-generating means is input to the one of the first and second rotating magnetic field-generating means in a state converted to electric power by the other of the first and second rotating magnetic field-generating means, whereby the part of the motive power is output again as motive power (FIGS. 5, 26, 31, 36).

According to this power plant, in the electric power and motive power input/output device, electric power and motive power are input and output between the first rotating magnetic field-generating means, the first element, the second element, and the second rotating magnetic field-generating means, along with generation of the first and second rotating magnetic fields by the first and second rotating magnetic field-generating means, and the first rotating magnetic field, the first and second elements, and the second rotating magnetic field rotate while holding a collinear relationship therebetween with respect to rotational speed, and are sequentially aligned in a collinear chart representing the relationship with respect to the rotational speed.

Further, the first element is connected to the output portion of the prime mover while the second element is connected to the driven parts, and the first and second rotating magnetic field-generating means are configured to be capable of giving and receiving electric power therebetween. Further, the operations of the electric power and motive power input/output device are controlled by the control system. With the arrangement described above, the driven parts can be driven by the motive power from the prime mover and the electric power and motive power input/output device.

Further, in the EV operation mode, during stoppage of the prime mover, the driven parts are driven by controlling the operations of the electric power and motive power input/output device. During this EV operation mode, the operations of the electric power and motive power input/output device are controlled such that no power circulation occurs in which part of motive power output from one of the first and second rotating magnetic field-generating means is input to the one of the first and second rotating magnetic field-generating means in a state converted to electric power by the other of the first and second rotating magnetic field-generating means, whereby the part of the motive power is output again from the one of the first and second rotating magnetic field-generating means as motive power. Therefore, in the EV operation mode, it is possible to prevent losses due to the power circulation, thereby making it possible to enhance the driving efficiency in driving driven parts.

The invention as claimed in claim 15 is the power plant 1, 51, 91, 111 as claimed in claim 14, wherein during the EV operation mode, the control system controls the operation of the electric power and motive power input/output device such that a rotational speed of the first element becomes equal to or lower than a rotational speed of the second element (FIGS. 5, 26, 31, 36).

Similarly to the power plant as claimed in claim 8, during the EV operation mode for driving the driven parts by the electric power and motive power input/output device during stoppage of the prime mover, as the rotational speed of the output portion of the prime mover is higher, that is, as motive power wastefully transmitted from the electric power and motive power input/output device to the output portion is larger, the driving efficiency in driving the drive wheels is lower.

According to the above-described arrangement, the operation of the electric power and motive power input/output device is controlled such that the rotational speed of the first element connected to the output portion becomes equal to or lower than the rotational speed of the second element connected to the driven parts. This makes it possible to hold the rotational speed of the output portion in a relatively low state, and hence it is possible to prevent motive power from being wastefully transmitted from the electric power and motive power input/output device to the output portion, thereby making it possible to further enhance the driving efficiency.

The invention as claimed in claim 16 is the power plant 1, 51, 91, 111 as claimed in claim 15, wherein during the EV operation mode, the control system controls the operation of the electric power and motive power input/output device such that a rotational speed of the first rotating magnetic field (first rotating machine rotational speed NM1, first magnetic field rotational speed NMF1) becomes higher than 0 (FIGS. 5, 26, 31, 36).

As described heretofore, the first rotating magnetic field, the first element, the second element, and the second rotating magnetic field rotate while holding the collinear relationship therebetween with respect to the rotational speed, and are sequentially aligned in the collinear chart representing the relationship between the rotational speeds thereof. Further, the first element is connected to the output portion of the prime mover, while the second element is connected to the driven parts.

With the arrangement described above, during the EV operation mode, to control the rotational speed of the first element connected to the output portion of the prime mover such that it becomes lower, in the state where the above-described power circulation is not caused, so as to suppress wasteful transmission of motive power to the output portion, as described above as to the operation of claim 14, it is preferable to control the rotational speed of the first rotating magnetic field such that it becomes equal to 0.

However, for example, in a case where the first rotating magnetic field-generating means is formed e.g. by multi-phase coils for generating the first rotating magnetic field, and electric power is input to the first rotating magnetic field-generating means from an electric circuit, such as an inverter having switching elements, when the rotational speed of the first rotating magnetic field is controlled such that it becomes equal to 0, there can occur the following inconvenience: In this case, there is a fear that electric current flows through only a specific phase coil of the first rotating magnetic field-generating means, and only a switching element associated with the specific phase coil is turned on, so that the coil and the switching element are overheated. When the maximum value of the electric current input to the first rotating magnetic field-generating means is made smaller so as to suppress such overheating of the coil and the switching element, the output torque of the electric power and motive power input/output device becomes small.

According to the above-described construction of the present invention, during the EV operation mode, the operation of the electric power and motive power input/output device is controlled such that the rotational speed of the first rotating magnetic field becomes higher than 0, and hence it is possible to prevent above-mentioned overheating of the electric power and the motive power input/output device and electric circuit and ensure a sufficiently large output torque of the electric power and motive power input/output device.

### BRIEF DESCRIPTION OF DRAWINGS

FIG. 1 A skeleton diagram of a power plant according to a first embodiment of the present invention together with drive wheels to which the power plant is applied.

FIG. 2 A block diagram showing an ECU etc. of the power plant according to the first embodiment.

FIG. 3 A velocity collinear chart illustrating an example of the relationship between the rotational speeds of rotary elements of the power plant shown in FIG. 1 and the relationship between torques thereof, during an EV creep mode.

FIG. 4 A velocity collinear chart illustrating an example of the relationship between the rotational speeds of the rotary elements of the power plant shown in FIG. 1 and the relationship between the torques thereof, during an EV standing start mode.

FIG. 5 A velocity collinear chart illustrating an example of the relationship between the rotational speeds of the rotary elements of the power plant shown in FIG. 1 and the relationship between the torques thereof, during an EV traveling mode.

FIG. 6 A skeleton diagram of a power plant according to a second embodiment of the present invention together with drive wheels to which the power plant is applied.

FIG. 7 A block diagram showing an ECU etc. of the power plant according to the second embodiment.

FIG. 8 An enlarged cross-sectional view of a first rotating machine appearing in FIG. 6.

FIG. 9 A schematic development view showing a first stator and first and second rotors of the first rotating machine appearing in FIG. 6, in a state developed in the circumferential direction.

FIG. 10 A diagram showing an equivalent circuit of the first rotating machine appearing in FIG. 6, in a case where the equivalent circuit comprises two first armature magnetic poles, four first magnet magnetic poles, and three cores.

FIG. 11 A velocity collinear chart illustrating an example of the relationship between a magnetic field electrical angular velocity, and first and second rotor electrical angular velocities of the first rotating machine appearing in FIG. 6.

FIG. 12 Diagrams illustrating the operation of the first rotating machine appearing in FIG. 6 in a case where electric power is supplied to the first stator in a state of the first rotor being held unrotatable.

FIG. 13 Diagrams illustrating a continuation of the operation illustrated in FIG. 12.

FIG. 14 Diagrams illustrating a continuation of the operation illustrated in FIG. 13.

FIG. 15 A diagram illustrating the positional relationship between the first armature magnetic poles and the cores in a case where the first armature magnetic poles have rotated through an electrical angle of 2π from the state shown in FIG. 12.

FIG. 16 Diagrams illustrating the operation of the first rotating machine appearing in FIG. 6 in a case where electric power is supplied to the first stator in a state of the second rotor being held unrotatable.

FIG. 17 Diagrams illustrating a continuation of the operation illustrated in FIG. 16.

FIG. 18 Diagrams illustrating a continuation of the operation illustrated in FIG. 17.

FIG. 19 A diagram illustrating an example of changes in U-phase to W-phase counter-electromotive force voltages in the first rotating machine appearing in FIG. 6, in a case where the number of the first armature magnetic poles, the number of the cores and the number of the first magnet magnetic poles are set to 16, 18 and 20, respectively, and the first rotor is held unrotatable.

FIG. 20 A diagram illustrating an example of changes in a first driving equivalent torque and first and second rotor-transmitted torques in the first rotating machine appearing in FIG. 6, in the case where the number of the first armature magnetic poles, the number of the cores and the number of the first magnet magnetic poles are set to 16, 18 and 20, respectively, and the first rotor is held unrotatable.

FIG. 21 A diagram illustrating an example of changes in the U-phase to W-phase counter-electromotive force voltages in the first rotating machine appearing in FIG. 6, in a case where the number of the first armature magnetic poles, the number of the cores and the number of the first magnet magnetic poles are set to 16, 18 and 20, respectively, and the second rotor is held unrotatable.

FIG. 22 A diagram illustrating an example of changes in the first driving equivalent torque and the first and second rotor-transmitted torques in the first rotating machine appearing in FIG. 6, in the case where the number of the first armature magnetic poles, the number of the cores and the number of the first magnet magnetic poles are set to 16, 18 and 20, respectively, and the second rotor is held unrotatable.

FIG. 23 An enlarged cross-sectional view of a second rotating machine appearing in FIG. 6.

FIG. 24 A velocity collinear chart illustrating an example of the relationship between the rotational speeds of rotary elements of the power plant shown in FIG. 6 and the relationship between torques thereof, during the EV creep mode.

FIG. 25 A velocity collinear chart illustrating an example of the relationship between the rotational speeds of the rotary elements of the power plant shown in FIG. 6 and the relationship between the torques thereof, during the EV standing start mode.

FIG. 26 A velocity collinear chart illustrating an example of the relationship between the rotational speeds of the rotary elements of the power plant shown in FIG. 6 and the relationship between the torques thereof, during the EV traveling mode.

FIG. 27 A skeleton diagram of a power plant according to a third embodiment of the present invention together with drive wheels to which the power plant is applied.

FIG. 28 A block diagram showing an ECU etc. of the power plant according to the third embodiment.

FIG. 29 A velocity collinear chart illustrating an example of the relationship between the rotational speeds of rotary elements of the power plant shown in FIG. 27 and the relationship between torques thereof, during the EV creep mode.

FIG. 30 A velocity collinear chart illustrating an example of the relationship between the rotational speeds of the rotary elements of the power plant shown in FIG. 27 and the relationship between torques thereof, during the EV standing start mode.

FIG. 31 A velocity collinear chart illustrating an example of the relationship between the rotational speeds of the rotary elements of the power plant shown in FIG. 27 and the relationship between torques thereof, during the EV traveling mode.

FIG. 32 A skeleton diagram of a power plant according to a fourth embodiment of the present invention together with drive wheels to which the power plant is applied.

FIG. 33 A block diagram showing an ECU etc. of the power plant according to the fourth embodiment.

FIG. 34 A velocity collinear chart illustrating an example of the relationship between the rotational speeds of rotary elements of the power plant shown in FIG. 32 and the relationship between torques thereof, during the EV creep mode.

FIG. 35 A velocity collinear chart illustrating an example of the relationship between the rotational speeds of the rotary elements of the power plant shown in FIG. 32 and the relationship between torques thereof, during the EV standing start mode.

FIG. 36 A velocity collinear chart illustrating an example of the relationship between the rotational speeds of the rotary elements of the power plant shown in FIG. 32 and the relationship between torques thereof, during the EV traveling mode.

### BRIEF DESCRIPTION OF DRAWINGS

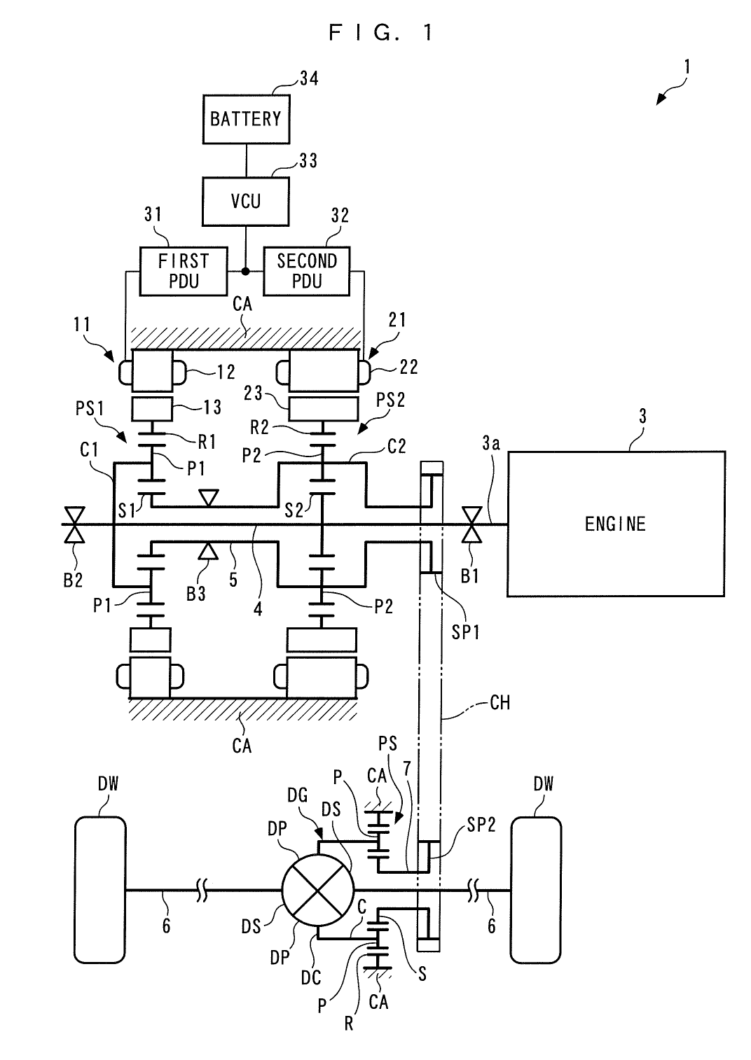

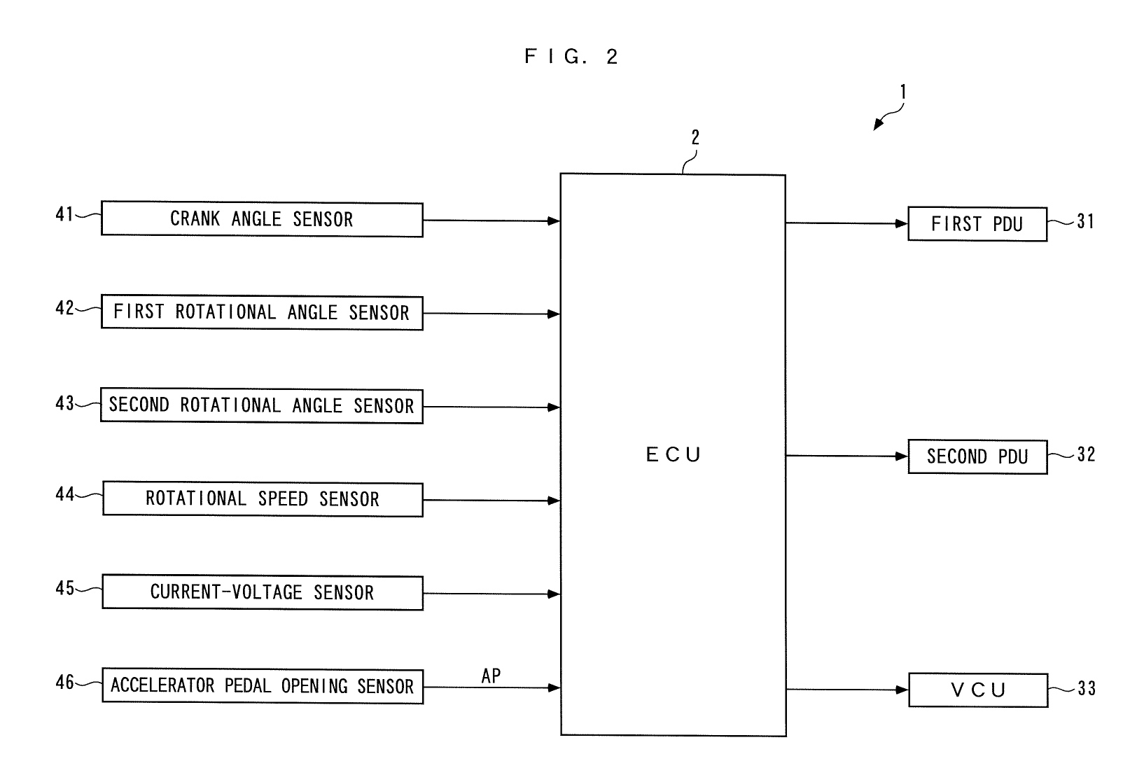

The present invention will now be described in detail with reference to the drawings showing preferred embodiments thereof. Referring to FIGS. 1 and 2, a power plant 1 according to a first embodiment of the present invention is for driving left and right drive wheels DW and DW of a vehicle (not shown). The power plant 1 includes an internal combustion engine (hereinafter referred to as the “engine”) 3, a first rotating machine 11, and a second rotating machine 21, as motive power sources, a first planetary gear unit PS1, a second planetary gear unit PS2, and a differential gear DG, for transmitting motive power, and an ECU 2 for controlling the operations of the engine 3 and the first and second rotating machines 11 and 21. Note that in FIG. 1 and other figures, referred to hereinafter, hatching in portions illustrating cross-sections is omitted for convenience, if appropriate. Hereinafter, connection between elements directly by a shaft or the like without via a transmission mechanism, such as gears, is referred to as “direct connection” as deemed appropriate.

The above-described engine 3 is a gasoline engine, and includes a crankshaft 3a for outputting motive power, fuel injection valves (not shown) and a throttle valve (not shown). The valve-opening time period of each fuel injection valve, and the degree of opening of the throttle valve are controlled by the ECU 2, whereby the amount of fuel supplied to the engine 3 and the amount of intake air drawn into the engine 3 are controlled, and in turn the motive power of the engine 3 is controlled.

The first rotating machine 11 is a general one-rotor-type brushless DC motor, and includes an unmovable first stator 12, and a rotatable first rotor 13. The first stator 12 is formed e.g. by three-phase coils, and is fixed to an immovable casing CA. Further, when electric power is supplied or generated, the first stator 12 generates a first rotating magnetic field rotating in a circumferential direction. The first rotor 13 is formed e.g. by a plurality of magnets, and is disposed in a manner opposed to the first stator 12.

The second rotating machine 21 is a general one-rotor-type brushless DC motor, similarly to the first rotating machine 11, and includes an unmovable second stator 22, and a rotatable second rotor 23. The second stator 22 is formed e.g. by three-phase coils, and is fixed to the casing CA. Further, when electric power is supplied or generated, the second stator 22 generates a second rotating magnetic field rotating in the circumferential direction. The second rotor 23 is formed e.g. by a plurality of magnets, and is disposed in a manner opposed to the second stator 22.

The first stator 12 is electrically connected to a battery 34 capable of being charged and discharged, via a first power drive unit (hereinafter referred to as the “first PDU”) 31 and a voltage control unit (hereinafter referred to as the “VCU”) 33. Further, the second stator 22 is electrically connected to the battery 34 via a second power drive unit (hereinafter referred to as the “second PDU”) 32 and the VCU 33.

Each of the first and second PDUs 31 and 32 is implemented as an electric circuit comprising an inverter having a switching element, and outputs DC power input from the battery 34 in a state converted to three-phase AC power by turning on/off the switching element. Further, the first and second PDUs 31 and 32 are electrically connected to each other. As described above, the first and second stators 12 and 22 are electrically connected to each other via the first and second PDUs 31 and 32, and are configured to be capable of mutually giving and receiving electric power therebetween.

The above-described VCU 33, which is implemented as an electric circuit comprising a DC/DC converter, outputs electric power supplied from the battery 34, to the first PDU 31 and/or the second PDU 32 in a state where the voltage of the electric power is boosted, and outputs electric power supplied from the first PDU 31 and/or the second PDU 32, to the battery 34 in a state where the voltage of the electric power is dropped. Further, the VCU 33, and the first and second PDUs 31 and 32 are electrically connected to the above-described ECU 2 (see FIG. 2).

With the above arrangement, in the first rotating machine 11, as electric power is supplied from the battery 34 to the first stator 12 via the VCU 33 and the first PDU 31, the first rotating magnetic field is generated in the first stator 12 to thereby rotate the first rotor 13. That is, the electric power supplied to the first stator 12 is converted to motive power, and is output from the first rotor 13. Further, when no electric power is supplied, when the first rotor 13 rotates relative to the first stator 12, the first rotating magnetic field is generated in the first stator 12 and generate electric power. That is, motive power input to the first rotor 13 is converted to electric power in the first stator 12. Further, both in the case where motive power is output from the first rotor 13, as described above, and in the case where electric power is generated in the first stator 12, the first rotor 13 is caused to rotate synchronously with the first rotating magnetic field.

The ECU controls the first PDU 31 and the VCU 33 to thereby control electric power supplied to the first rotating machine 11, electric power generated in the first rotating machine 11, and the rotational speed of the first rotor 13 (hereinafter referred to as the “first rotating machine rotational speed”) NM1.

Further, in the second rotating machine 21, similarly to the first rotating machine 11, as electric power is supplied from the battery 34 to the second stator 22 via the VCU 33 and the second PDU 32, the second rotating magnetic field is generated in the second stator 22 and the second rotor 23 is rotated. That is, the electric power supplied to the second stator 22 is converted to motive power, and is output from the second rotor 23. Further, when no electric power is supplied, when the second rotor 23 rotates relative to the second stator 22, the second rotating magnetic field is generated in the second stator 22 and electric power is generated. That is, motive power input to the second rotor 23 is converted to electric power in the second stator 22. Further, both in the case where motive power is output from the second rotor 23, as described above, and in the case where electric power is generated in the second stator 22, the second rotor 23 is caused to rotate synchronously with the second rotating magnetic field.

By controlling the second PDU 32 and the VCU 33, the ECU 2 controls electric power supplied to the second rotating machine 21, electric power generated in the second rotating machine 21, and the rotational speed of the second rotor 23 (hereinafter referred to as the “second rotating machine rotational speed”) NM2.

The first planetary gear unit PS1 is of a general single pinion type, and comprises a first sun gear S1, a first ring gear R1 disposed around a periphery of the first sun gear S1, a plurality of first planetary gears P1 in mesh with the gears S1 and R1, and a first carrier C1 rotatably supporting the first planetary gears P1. As is widely known, the first sun gear S1, the first carrier C1 and the first ring gear R1 are capable of transmitting motive power therebetween, and are configured such that during transmission of motive power, they rotate while holding a collinear relationship therebetween with respect to rotational speed, and straight lines representing the respective rotational speeds thereof are sequentially aligned in a collinear chart representing the relationship between the rotational speeds. Further, the first sun gear S1, the first carrier C1 and the first ring gear R1 are arranged coaxially with the crankshaft 3a of the engine 3.

The first carrier C1 is integrally formed on a first rotating shaft 4. The first rotating shaft 4 is rotatably supported by bearings B1 and B2 together with the first carrier C1, and is coaxially directly connected to the crankshaft 3a via a flywheel (not shown). Further, the first sun gear S1 is integrally formed on a hollow cylindrical second rotating shaft 5. The second rotating shaft 5 is rotatably supported by a bearing B3 together with the first sun gear S1, and is disposed coaxially with the crankshaft 3a. Further, the first rotating shaft 4 is rotatably fitted through the second rotating shaft 5. Furthermore, the first rotor 13 of the first rotating machine 11 is coaxially mounted on the first ring gear R1 such that the first ring gear R1 and the first rotor 13 are rotatable together therewith.

The second planetary gear unit PS2 is configured similarly to the first planetary gear unit PS1, and comprises a second sun gear S2, a second ring gear R2, a plurality of second planetary gears P2 in mesh with the gears S2 and R2, and a second carrier C2 rotatably supporting the second planetary gears P2. The second planetary gear unit PS2 has the same functions as those of the first planetary gear unit PS1, and is disposed between the engine 3 and the first planetary gear unit PS1. Further, the second sun gear S2, the second carrier C2, and the second ring gear R2 are arranged coaxially with the crankshaft 3a of the engine 3.

The second sun gear S2 is integrally formed on the above-mentioned first rotating shaft 4, and is directly connected to the crankshaft 3a together with the first carrier C1. Further, the second carrier C2 is integrally formed on the above-described second rotating shaft 5, and is directly connected to the first sun gear S1. Furthermore, a hollow cylindrical first sprocket SP1 is coaxially mounted on the second carrier C2. Further, the first rotating shaft 4 is rotatably fitted through the second carrier C2 and the first sprocket SP1. Furthermore, the second rotor 23 of the second rotating machine 21 is coaxially mounted on the second ring gear R2 such that the second ring gear R2 and the second rotor 23 are rotatable together.

The differential gear DG is for distributing input motive power to the left and right drive wheels DW and DW, and comprises left and right side gears DS and DS having gear teeth equal in number to each other, a plurality of pinion gears DP in mesh with the gears DS and DS, and a differential case DC rotatably supporting pinion gears DP. The left and right side gears DS and DS are connected to the left and right drive wheels DW and DW via left and right axles 6 and 6, respectively. In the differential gear DG constructed as above, motive power input to the differential case DC is distributed to the left and right side gears DS and DS via the pinion gears DP, and is further distributed to the left and right drive wheels DW and DW via the left and right axles 6 and 6.

Further, the differential case DC is provided with a planetary gear unit PS. This planetary gear unit PS is configured similarly to the first and second planetary gear units PS1 and PS2, and comprises a sun gear S, a ring gear R, a plurality of planetary gears P in mesh with the gears S and R, and a carrier C rotatably supporting the planetary gears P. The carrier C is integrally formed with the differential case DC, and the ring gear R is fixed to the casing CA. Further, the sun gear S is integrally formed on a hollow cylindrical third rotating shaft 7, and the right axle 6 is rotatably fitted through the above-mentioned third rotating shaft 7. Furthermore, a second sprocket SP2 is integrally formed on the third rotating shaft 7, and a chain CH extends around the second sprocket SP2 and the above-described first sprocket SP1. With the above arrangement, motive power transmitted to the second sprocket SP2 is transmitted to the differential gear DG in a state reduced in velocity by the planetary gear unit PS. Note that it is assumed that the rotational speeds of the left and right drive wheels DW and DW are equal to each other.

As described above, in the power plant 1, the first carrier C1 and the second sun gear S2 are mechanically directly connected to each other, and are mechanically directly connected to the crankshaft 3a. Further, the first sun gear S1 and the second carrier C2 are mechanically directly connected to each other, and are mechanically connected to the drive wheels DW and DW via the chain CH, the planetary gear unit PS, the differential gear DG, and the left and right axles of the vehicle. Furthermore, the first and second rotors 13 and 23 are mechanically directly connected to the first and second ring gears R1 and R2, respectively.

Further, a crank angle sensor 41, a first rotational angle sensor 42, and a second rotational angle sensor 43 are connected to the ECU 2. The crank angle sensor 41 detects the rotational angular position of the crankshaft 3a, and delivers a signal indicative of the detected rotational angular position to the ECU 2. The ECU 2 calculates the rotational speed of the crankshaft 3a (hereinafter referred to as the “engine speed”) NE based on the detected rotational angular position of the crankshaft 3a.

The above-described first rotational angle sensor 42 detects the rotational angular position of the first rotor 13 with respect to the first stator 12, and the above-described second rotational angle sensor 43 detects the rotational angular position of the second rotor 23 with respect to the second stator 22, to deliver respective signals indicative of the detected rotational angular positions of the first and second rotors 13 and 23 to the ECU 2. The ECU 2 calculates first and second rotating machine rotational speeds NM1 and NM2 (rotational speeds of the first and second rotors 13 and 23) based on the detection signals from the first and second rotational angle sensors 42 and 43, respectively.

Furthermore, delivered to the ECU 2 are a detection signal indicative of the rotational speed of the left and right drive wheels DW and DW (hereinafter referred to as the “drive wheel rotational speed”) NDW from a rotational speed sensor 44, detection signals indicative of the values of current and voltage input to and output from the battery 34, from a current-voltage sensor 45, and a detection signal indicative of an operation amount of an accelerator pedal (not shown) of the vehicle (hereinafter referred to as the “accelerator pedal opening”) AP from an accelerator pedal opening sensor 46. The ECU 2 calculates a charge state of the battery 34 based on the detection signal from the current-voltage sensor 45.

The ECU 2 is implemented by a microcomputer comprising an I/O interface, a CPU, a RAM and a ROM. The ECU 2 controls the operations of the engine 3 and the first and second rotating machines 11 and 21 based on the detection signals from the aforementioned sensors 41 to 46, according to control programs stored in the ROM. This causes the vehicle to be operated in various operation modes.

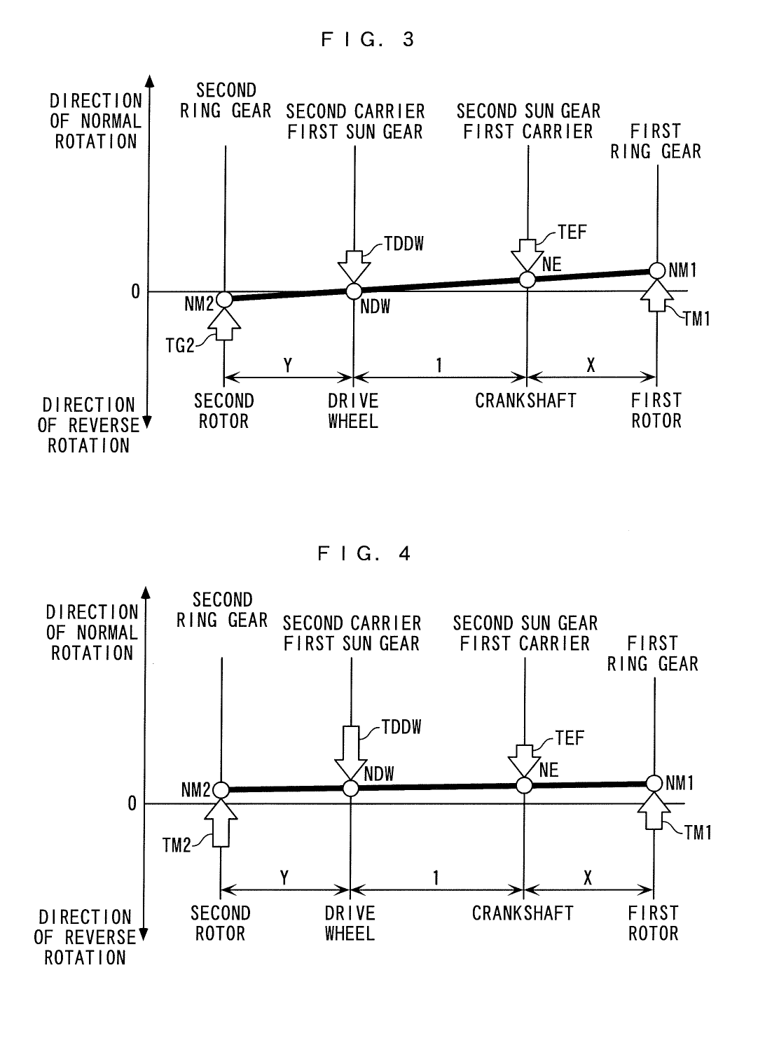

Hereinafter, the above-mentioned operation modes will be described with reference to velocity collinear charts shown in FIG. 3 and so forth. First, a description is given of the FIG. 3 velocity collinear chart. As is apparent from the above-described connection relationship between the various rotary elements of the power plant 1, the rotational speeds of the first carrier C1 and the second sun gear S2 are equal to each other, and are equal to the engine speed NE. Further, the rotational speeds of the first and second ring gears R1 and R2 are equal to the first and second rotating machine rotational speeds NM1 and NM2, respectively. Furthermore, the rotational speeds of the first sun gear S1 and the second carrier C2 are equal to each other, and are equal to the drive wheel rotational speed NDW provided that a change in speed e.g. by the planetary gear unit PS is ignored. Further, the rotational speeds of the first sun gear S1, the first carrier C1, and the first ring gear R1 are in a predetermined collinear relationship defined by the number of the gear teeth of the first sun gear S1 and that of the gear teeth of the first ring gear R1, and the rotational speeds of the second sun gear S2, the second carrier C2, and the second ring gear R2 are in a predetermined collinear relationship defined by the number of the gear teeth of the second sun gear S2 and that of the gear teeth of the second ring gear R2.

From the above, the relationship between the engine speed NE, the drive wheel rotational speed NDW, and the first and second rotating machine rotational speeds NM1 and NM2 is represented by a single velocity collinear chart as shown in FIG. 3. Note that in FIG. 3 and other velocity collinear charts, described hereinafter, vertical lines intersecting with a horizontal line indicative of a value of 0 are for representing the respective rotational speeds of parameters, and the distance from the horizontal line to a white circle shown on each vertical line corresponds to the rotational speed of each of the parameters denoted at opposite ends of the vertical line. For convenience, symbols indicative of the rotational speeds of the parameters are denoted close to the white circles associated therewith. Further, X represents the ratio of the number of the gear teeth of the first sun gear S1 to the number of the gear teeth of the first ring gear R1, and Y represents the ratio of the number of the gear teeth of the second sun gear S2 to the number of the gear teeth of the second ring gear R2.

The operation modes include an EV creep mode, an EV standing start mode and an EV traveling mode. Now, a description will be given of these operation modes, in order from the EV creep mode. Note that in the following description, the change in speed e.g. by the planetary gear unit PS is ignored.

[EV Creep Mode]

The EV creep mode is an operation mode for causing the drive wheels DW and DW to perform normal rotation at a very low rotational speed using only the first and second rotating machines 11 and 21 as motive power sources, in a state where the engine 3 is stopped. The EV creep mode is selected when the calculated charge of the battery 34 is larger than a predetermined value, and the amount of electric power remaining in the battery 34 is large enough.

During the EV creep mode, electric power is supplied from the battery 34 to the first stator 12 of the first rotating machine 11 to cause the first rotor 13 to perform normal rotation, and electric power is generated in the second stator 22 using motive power transmitted, as described hereinafter, to the second rotor 23 of the second rotating machine 21. Further, the generated electric power is further supplied to the first stator 12.

FIG. 3 illustrates the relationship between the rotational speeds of the various rotary elements and the relationship between torques thereof, during the EV creep mode. In FIG. 3, TM1 represents an output torque of the first rotating machine 11 generated along with the supply of electric power to the first stator 12 (hereinafter referred to as the “first powering torque”), and TG2 represents a braking torque of the second rotating machine 21 generated along with the electric power generation in the second stator 22 (hereinafter referred to as the “second electric power generation torque”). Further, TDDW represents a torque transmitted to the drive wheels DW and DW, and TEF represents a friction of the engine 3.

As is apparent from FIG. 3, when the first powering torque TM1 is transmitted, the first ring gear R1 performs normal rotation together with the first rotor 13. Further, the first powering torque TM1 transmitted to the first ring gear R1 is transmitted to the second rotor 23 via the second ring gear R2, using the load of the drive wheels DW and DW as a reaction force, and causes the second rotor 23 to perform reverse rotation together with the second ring gear R2.

Electric power is generated in the second stator 22, as described above, using motive power thus transmitted to the second rotor 23, and the second electric power generation torque TG2 generated along with the electric power generation acts on the second ring gear R2 performing reverse rotation in a manner braking the second ring gear R2. Further, the first powering torque TM1 is transmitted to the crankshaft 3a and the drive wheels DW and DW, using the second electric power generation torque TG2 as a reaction force. This causes the crankshaft 3a to perform normal rotation, and causes a torque for causing the drive wheels DW and DW to perform normal rotation to act on the drive wheels DW and DW, so that the drive wheels DW and DW are caused to rotate at a very low rotational speed, whereby a so-called creep operation of the vehicle is performed.

Further, during the EV creep mode, the electric power supplied to the first stator 12 and the electric power generated in the second stator 22 are controlled such that the drive wheel rotational speed NDW becomes very low and at the same time the first and second rotating machine rotational speeds NM1 and NM2 do not become high. The first and second rotating machine rotational speeds NM1 and NM2 are controlled such that they do not become high, as described above, for the following reason: During the EV creep mode, as described above, part of the motive power of the first rotating machine 11 is transmitted to the second rotating machine 21 via the first and second planetary gear units PS1 and PS2, and is converted to electric power by the second rotating machine 21, whereafter the electric power is supplied to the first rotating machine 11, for being output again from the first rotating machine 11 as motive power. Thus, during the EV creep mode, in the first and second rotating machines 11 and 21 and the first and second planetary gear units PS1 and PS2, power circulation is caused in which part of the motive power output from the first rotating machine 11 is input to the first rotating machine 11 in a state converted to electric power by the second rotating machine 21, whereby it is output again from the first rotating machine 11 as motive power, and hence the control is performed so as to suppress losses due to the power circulation.

[EV Standing Start Mode]

This EV standing start mode is an operation mode for starting the vehicle using only the first and second rotating machines 11 and 21 as motive power sources, in the state where the engine 3 is stopped, and is selected subsequent to the EV creep mode. Further, similarly to the EV creep mode, the EV standing start mode is selected when the charge of the battery 34 is larger than a predetermined value and the amount of electric power remaining in the battery 34 is large enough.

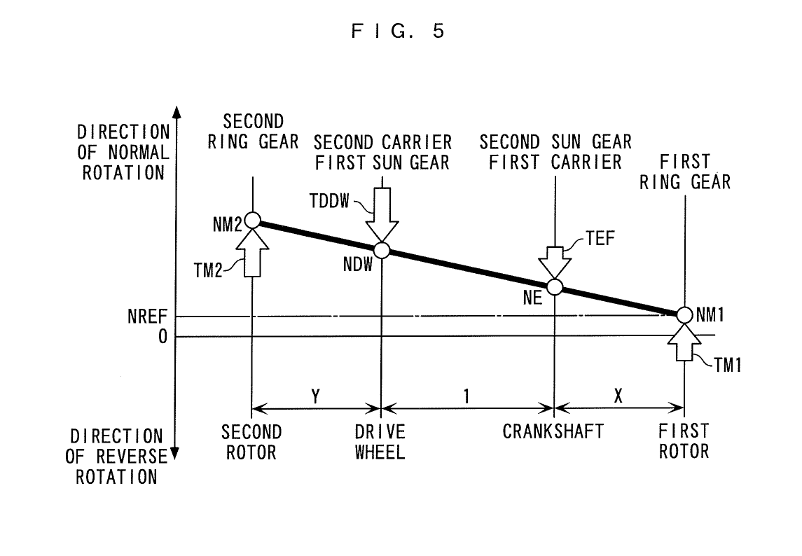

During the EV standing start mode, immediately after a shift from the EV creep mode, similarly to the case of the EV creep mode, electric power is supplied from the battery 34 to the first stator 12 to cause the first rotor 13 to perform normal rotation, and electric power is generated in the second stator 22. Further, the electric power supplied to the first stator 12 is increased, and the second rotating machine rotational speed NM2 of the second rotor 23 performing reverse rotation is controlled such that it becomes equal to 0. Then, after the second rotating machine rotational speed NM2 has become equal to 0, electric power is supplied not only to the first stator 12 but also to the second stator 22 from the battery 34 to cause the second rotor 23 to perform normal rotation. FIG. 4 shows the relationship between the rotational speeds of the rotary elements of the power plant and the relationship between torques thereof, in this case. In FIG. 4, TM2 represents an output torque of the second rotating machine 21 generated along with the supply of electric power to the second stator 22 (hereinafter referred to as the “second powering torque”).

As is apparent from FIG. 4, the second powering torque TM2 is transmitted to the drive wheels DW and DW and the crankshaft 3a, using the first powering torque TM1 as a reaction force. In other words, combined torque formed by combining the first and second powering torques TM1 and TM2 is transmitted to the drive wheels DW and DW and the crankshaft 3a. By controlling the operations of the first and second rotating machines 11 and 21 as described above, motive power transmitted from the first and second rotating machines 11 and 21 to the drive wheels DW and DW is further increased in comparison with the case of the EV creep mode, so that the drive wheel rotational speed NDW is increased in the direction of normal rotation to in turn cause the vehicle to start forward.

[EV Traveling Mode]

This EV traveling mode is an operation mode for causing the vehicle to travel using only the first and second rotating machines 11 and 21 as motive power sources, in the state where the engine 3 is stopped, and is selected subsequent to the EV standing start mode. Further, the EV traveling mode is selected when the charge of the battery 34 is larger than a predetermined value and the amount of electric power remaining in the battery 34 is large enough, and at the same time when the rotational speed of the first sun gear S1 and the second carrier C2, determined by the drive wheel rotational speed NDW, is not smaller than a predetermined value NREF (e.g. 50 rpm) slightly larger than 0. Note that the rotational speed of the first sun gear S1 and the second carrier C2 is calculated based on the drive wheel rotational speed NDW.

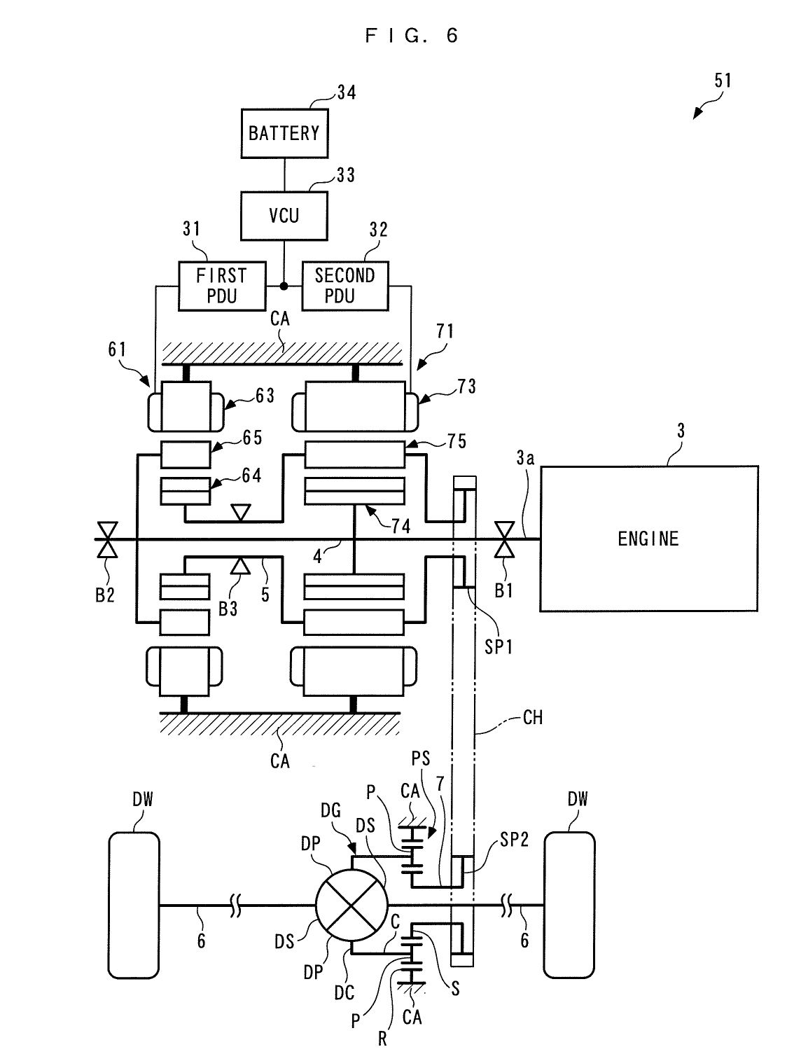

During the EV traveling mode, similarly to the case of the EV standing start mode shown in FIG. 4, electric power is supplied to both the first and second stators 12 and 22 from the battery 34 to cause the first and second rotors 13 and 23 to perform normal rotation. FIG. 5 shows the relationship between the rotational speeds of the rotary elements of the power plant and the relationship between torques thereof, in the EV traveling mode.

As is apparent from FIG. 5, during the EV traveling mode, similarly to the case of the EV standing start mode, combined torque formed by combining the first and second powering torques TM1 and TM2 is transmitted to the drive wheels DW and DW and the crankshaft 3a, whereby the drive wheels DW and DW and the crankshaft 3a continue to perform normal rotation. Further, as shown in FIG. 5, during the EV traveling mode, the first rotating machine rotational speed NM1 is controlled such that it becomes equal to the above-mentioned predetermined value NREF. Because of this fact and the fact that the EV traveling mode is selected when the rotational speed of the first sun gear S1 and the second carrier C2, determined by the drive wheel rotational speed NDW as described above, is not smaller than the predetermined value NREF, the respective rotational speed of the first carrier C1 and the second sun gear S2 becomes equal to or lower than the rotational speed of the first sun gear S1 and the second carrier C2 during the EV traveling mode.

Further, as described above, the first rotating machine rotational speed NM1 is controlled such that it becomes equal to the predetermined value NREF, and hence the second rotating machine rotational speed NM2 is controlled such that there holds the following equation (1):

NM2={(1+X+Y)NDW−Y·NREF}/(1+X) (1)

Furthermore, by controlling the electric powers supplied to the first and second stators 12 and 22, the first and second powering torques TM1 and TM2 are controlled such that the torque TDDW transmitted to the drive wheels DW and DW becomes equal to a demanded torque TREQ. In this case, since the friction TEF of the engine 3 acts on the first carrier C1 and the second sun gear S2, the electric powers supplied to the first and second stators 12 and 22 are controlled such that there hold the following equations (2) and (3), respectively:

TM1=−{Y·TREQ+(Y+1)TEF}/(Y+1+X) (2)

TM2=−{(X+1)TREQ+X·TEF}/(X+1+Y) (3)

Further, the friction TEF of the engine 3 is calculated by searching a predetermined map (not shown) according to the engine speed NE. This map is formed by determining the friction TEF of the engine 3 in advance by experiment, and mapping the same.

Note that in the power plant 1, operation modes other than the EV creep mode, the EV standing start mode, and the EV traveling mode, described heretofore, include an operation mode for starting the engine 3 during the EV traveling mode, an operation mode for transmitting the motive power from the engine 3 to the drive wheels DW and DW while steplessly changing the speed thereof, an operation mode for starting the engine 3 during stoppage of the vehicle, an operation mode for generating electric power using inertia energy of the vehicle, and charging the battery 34 with the generated electric power, during decelerating traveling of the vehicle, and so forth. Operations in these operation modes are the same as those in operation modes disclosed in Japanese Laid-Open Patent Publication (Kokai) No. 2008-179348, and hence detailed description thereof is omitted.

The above-described first embodiment corresponds to the invention as claimed in claims 1 to 3 and 12 to 14. Correspondence between the elements of the first embodiment and elements of the invention as claimed in claims 1 to 3 and 12 to 14 (hereinafter generically referred to as the “invention 1”) is as follows: The drive wheels DW and DW, the engine 3 and the crankshaft 3a of the first embodiment correspond to driven parts, a prime mover, and an output portion of the invention 1; and the ECU 2, the VCU 33, and the first and second PDUs 31 and 32 of the first embodiment correspond to a control system of the invention 1.

The first and second planetary gear units PS1 and PS2 of the first embodiment correspond to a power transmission mechanism of the invention as claimed in claims 1 to 3. Further, the first ring gear R1 of the first embodiment corresponds to a first element of the invention as claimed in claims 1 to 3, and the first carrier C1 and the second sun gear S2 of the first embodiment correspond to a second element of the invention as claimed in claims 1 to 3. Furthermore, the first sun gear S1 and the second carrier C2 of the first embodiment correspond to a third element of the invention as claimed in claims 1 to 3, and the second ring gear R2 of the first embodiment corresponds to a fourth element of the invention as claimed in claims 1 to 3.

The first and second rotating machines 11 and 21, and the first and second planetary gear units PS1 and PS2 of the first embodiment correspond to an electric power and motive power input/output device of the invention as claimed in claims 12 to 14. Further, the first and second stators 12 and 22 of the first embodiment correspond to first and second rotating magnetic field-generating means of the invention as claimed in claims 12 to 14, respectively. Further, the first carrier C1 and the second sun gear S2 of the first embodiment correspond to a first element of the invention as claimed in claims 12 to 14, and the first sun gear S1 and the second carrier C2 of the first embodiment correspond to a second element of the invention as claimed in claims 12 to 14. Furthermore, the first rotating machine rotational speed NM1 of the first embodiment corresponds to the rotational speed of a first rotating magnetic field of the invention as claimed in claim 14.

As described hereinabove, according to the first embodiment, during the EV traveling mode, when electric power is supplied from the battery 34 to both the first and second stators 12 and 22, motive power is output from both the first and second rotors 13 and 23. As described above, during the EV traveling mode, the operations of the first and second rotating machines 11 and 21 are controlled such that the above-mentioned power circulation is not caused in the first and second rotating machines 11 and 21, and the first and second planetary gear units PS1 and PS2. Therefore, in the EV traveling mode, it is possible to prevent losses due to the power circulation, thereby making it possible to enhance driving efficiency in driving the drive wheels DW and DW.

Further, during the EV traveling mode, the operations of the first and second rotating machines 11 and 21 are controlled such that the rotational speeds of the first carrier C1 and the second sun gear S2 which are directly connected to the crankshaft 3a of the engine 3 become equal to or lower than the rotational speed of the first sun gear S1 and the second carrier C2, respectively. This makes it possible to hold the engine speed NE in a relatively low state, so that it is possible to prevent motive power from being wastefully transmitted from the first and second rotating machines 11 and 21 to the crankshaft 3a, whereby it is possible to further enhance the driving efficiency.

Furthermore, during the EV traveling mode, the operations of the first and second rotating machines 11 and 21 are controlled such that the first rotating machine rotational speed NM1 becomes higher than 0. This makes it possible to prevent the first rotating machine 11 and the first PDU 31 from being overheated, and ensure a sufficiently large output torque of the first rotating machine 11.

Note that although in the first embodiment, the first carrier C1 and the second sun gear S2 are directly connected to each other, if they are mechanically connected to the crankshaft 3a, they are not necessarily required to be directly connected to each other. Further, although in the first embodiment, the first sun gear S1 and the second carrier C2 are directly connected to each other, if they are mechanically connected to the drive wheels DW and DW, they are not necessarily required to be directly connected to each other. Further, although in the first embodiment, the first carrier C1 and the second sun gear S2 are directly connected to the crankshaft 3a, they may be mechanically connected to the crankshaft 3a via gears, a pulley, a chain, a transmission, or the like.

Furthermore, although in the first embodiment, the first sun gear S1 and the second carrier C2 are connected to the drive wheels DW and DW via the chain CH and the differential gear DG, they may be mechanically directly connected to the drive wheels DW and DW. Further, although in the first embodiment, the first and second ring gears R1 and R2 are directly connected to the first and second rotors 13 and 23, respectively, they may be mechanically connected to the respective first and second rotors 13 and 23 via gears, a pulley, a chain, a transmission, or the like.

Furthermore, although in the first embodiment, the first ring gear R1 is connected to the first rotor 13, and the first sun gear S1 is connected to the drive wheels DW and DW, the above connection relationships may be inverted, that is, the first ring gear R1 may be mechanically connected to the drive wheels DW and DW, and the first sun gear S1 may be mechanically connected to the first rotor 13. Similarly, although in the first embodiment, the second ring gear R2 is connected to the second rotor 23, and the second sun gear S2 is connected to the crankshaft 3a, the above connection relationships may be inverted, that is, the second ring gear R2 may be mechanically connected to the crankshaft 3a, and the second sun gear S2 may be mechanically connected to the second rotor 23. In these cases, naturally, the first sun gear S1 and the first rotor 13, the second sun gear S2 and the second rotor 23, and the second ring gear R2 and the crankshaft 3a may be mechanically directly connected to each other, respectively. Alternatively, they may be mechanically connected to each other using gears, pulleys, chains, transmissions, and so forth. In addition, the first ring gear R1 may be mechanically connected to the drive wheels DW and DW via gears, a pulley, a chain, a transmission, or the like. Alternatively, it may be mechanically directly connected to the drive wheels DW and DW.

Further, although in the first embodiment, a combination of the first and second planetary gear units PS1 and PS2 is used as the power transmission mechanism of the invention as claimed in claim 1, another suitable power transmission mechanism, such as a so-called Ravigneaux type planetary gear unit, which has a carrier and a ring gear in shared use in a planetary gear unit of a single pinion type or a double pinion type, may be used insofar as it includes the first to fourth elements which are capable of transmitting motive power while holding the collinear relationship therebetween in respect of the rotational speed.

Next, a power plant 51 according to a second embodiment of the present invention will be described with reference to FIG. 6. The power plant 51 is distinguished from the first embodiment mainly in that it includes a first rotating machine 61 in place of the first rotating machine 11 and the first planetary gear unit PS1, and a second rotating machine 71 in place of the second rotating machine 21 and the second planetary gear unit PS2. In FIG. 6 and other figures, referred to hereinafter, the same component elements as those of the first embodiment are denoted by the same reference numerals. The following description is mainly given of different points of the power plant 51 from the first embodiment.

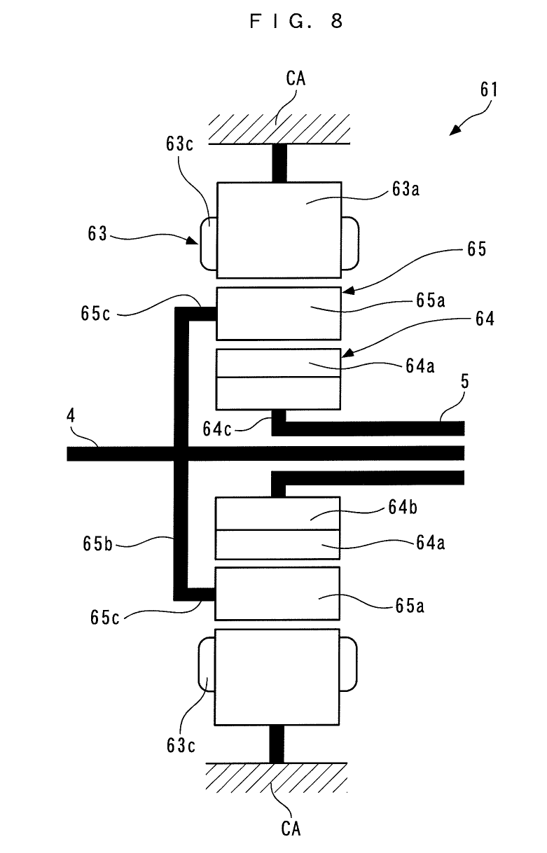

As shown in FIGS. 6 and 8, differently from the first rotating machine 11 of the first embodiment, the first rotating machine 61 is a two-rotor-type rotating machine, and includes a first stator 63, a first rotor 64 provided in a manner opposed to the first stator 63, and a second rotor 65 disposed between the two 63 and 64. The first stator 63, the second rotor 65, and the first rotor 64 are arranged coaxially with each other in the radial direction of the aforementioned first rotating shaft 4, from outside in the mentioned order.

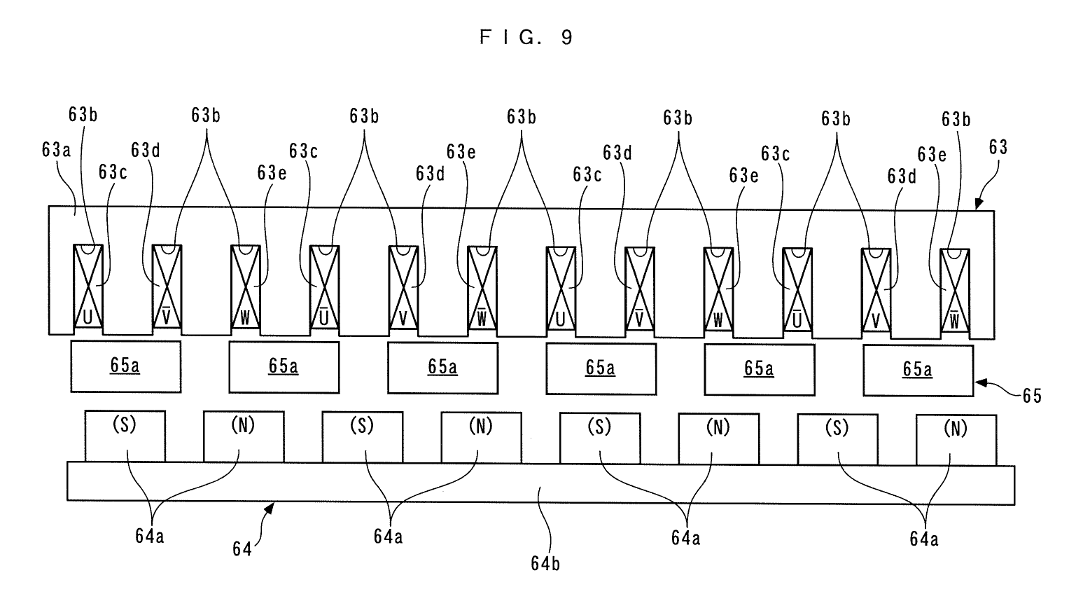

The aforementioned first stator 63 is for generating a first rotating magnetic field, and as shown in FIGS. 8 and 9, includes an iron core 63a, and U-phase, V-phase and W-phase coils 63c, 63d and 63e provided on the iron core 63a. Note that in FIG. 8, only the U-phase coil 63c is shown for convenience. The iron core 63a, which has a hollow cylindrical shape formed by laminating a plurality of steel plates, extends in the axial direction of the first rotating shaft 4 (hereinafter simply referred to as the “axial direction”), and is fixed to a casing CA. Further, the inner peripheral surface of the iron core 63a is formed with twelve slots 63b. The slots 63b extend in the axial direction, and are arranged at equally-spaced intervals in the circumferential direction of the first rotating shaft 4 (hereinafter simply referred to as the “circumferential direction”). The U-phase to W-phase coils 63c to 63e are wound in the slots 63b by distributed winding (wave winding). As shown in FIG. 6, the first stator 63 including the U-phase to W-phase coils 63c to 63e is electrically connected to the battery 34 via the above-mentioned first PDU 31 and VCU 33.

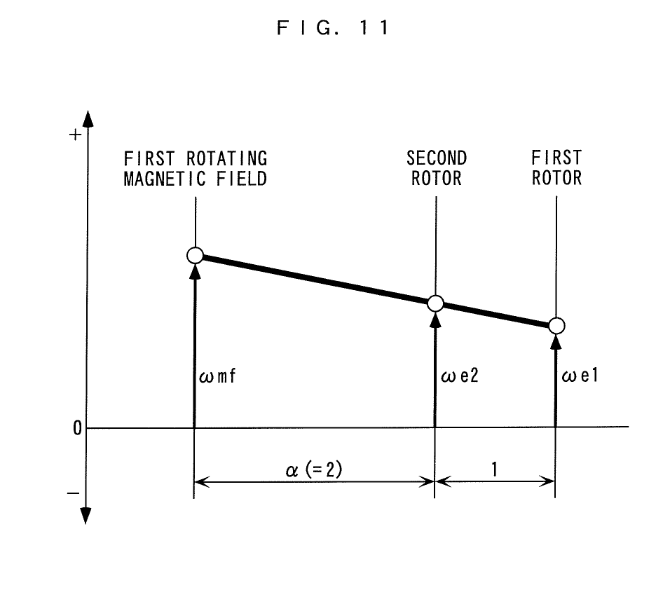

In the first stator 63 constructed as above, when electric power is supplied from the battery 34, to thereby cause electric currents to flow through the U-phase to W-phase coils 63c to 63e, or when electric power is generated, as described hereinafter, four magnetic poles are generated at respective ends of the iron core 63a toward the first rotor 64 at equally-spaced intervals in the circumferential direction (see FIG. 12), and the first rotating magnetic field generated by the magnetic poles rotates in the circumferential direction. Hereinafter, the magnetic poles generated on the iron core 63a are referred to as the “first armature magnetic poles”. Further, each two first armature magnetic poles which are circumferentially adjacent to each other have polarities different from each other. Note that in FIG. 12 and other figures, referred to hereinafter, the first armature magnetic poles are represented by (N) and (S) over the iron core 63a and the U-phase to W-phase coils 63c to 63e.

As shown in FIG. 9, the first rotor 64 includes a first magnetic pole row comprising eight permanent magnets 64a. These permanent magnets 64a are arranged at equally-spaced intervals in the circumferential direction, and the first magnetic pole row is opposed to the iron core 63a of the first stator 63. Each permanent magnet 64a extends in the axial direction, and the length thereof in the axial direction is set to the same length as that of the iron core 63a of the first stator 63.

Further, the permanent magnets 64a are mounted on an outer peripheral surface of an annular mounting portion 64b. This mounting portion 64b is formed by a soft magnetic material, such as iron or a laminate of a plurality of steel plates, and has an inner peripheral surface thereof attached to an outer peripheral surface of an annular plate-shaped flange 64c. The flange 64c is coaxially and integrally formed on the aforementioned second rotating shaft 5. Further, the permanent magnets 64a are attached to the outer peripheral surface of the mounting portion 64b formed by the soft magnetic material, as described above, and hence a magnetic pole of (N) or (S) appears on an end of each permanent magnet 64a toward the first stator 63. Note that in FIG. 9 and other figures, referred to hereinafter, the magnetic poles of the permanent magnets 64a are denoted by (N) and (S). Further, each two permanent magnets 64a circumferentially adjacent to each other have polarities different from each other.

The second rotor 65 includes a first soft magnetic material element row formed by six cores 65a. These cores 65a are arranged at equally-spaced intervals in the circumferential direction, and the first soft magnetic material element row is disposed between the iron core 63a of the first stator 63 and the first magnetic pole row of the first rotor 64, in a manner spaced therefrom by respective predetermined distances. Each core 65a is formed by a soft magnetic material, such as a laminate of a plurality of steel plates, and extends in the axial direction. Further, similarly to the permanent magnet 64a, the length of the core 65a in the axial direction is set to the same length as that of the iron core 63a of the first stator 63.

Furthermore, the core 65a is mounted on an outer end of a disk-shaped flange 65b via a hollow cylindrical connecting portion 65c slightly extending in the axial direction. This flange 65b is integrally formed on the aforementioned first rotating shaft 4. This arrangement mechanically directly connects the second rotor 65 including the cores 65a to the crankshaft 3a. Note that in FIGS. 9 and 12, the connecting portion 65c and the flange 65b are omitted from illustration for convenience.

In the first rotating machine 61 constructed as above, between the first rotor 64 and the first stator 63, the first rotating magnetic field is generated by the plurality of first armature magnetic poles, and further the cores 65a are arranged, so that each core 65a is magnetized by the magnetic poles of the permanent magnets 64a (hereinafter referred to as the “first magnet magnetic poles”) and the first armature magnetic poles. With this and the fact that the gap is provided between each adjacent two cores 65a, as described above, there are generated magnetic force lines ML in a manner connecting the first magnet magnetic poles, the cores 65a, and the first armature magnetic poles (see FIG. 12). Therefore, when the first rotating magnetic field is generated by the supply of electric power to the first stator 63, the action of magnetism of the magnetic force lines ML converts the electric power supplied to the first stator 63 to motive power, and the motive power is output from the first rotor 64 or the second rotor 65.

Now, a torque equivalent to the electric power supplied to the first stator 63 and the electrical angular velocity ωmf of the first rotating magnetic field is referred to as “first driving equivalent torque TSE1”. Hereafter, a description will be given of a relationship between the first driving equivalent torque TSE1, torques transmitted to the first and second rotors 64 and 65 (hereinafter referred to as the “first rotor-transmitted torque TR1” and the “second rotor-transmitted torque TR2”, respectively), and a relationship between the first rotating magnetic field, and the electrical angular velocities of the first and second rotors 64 and 65.

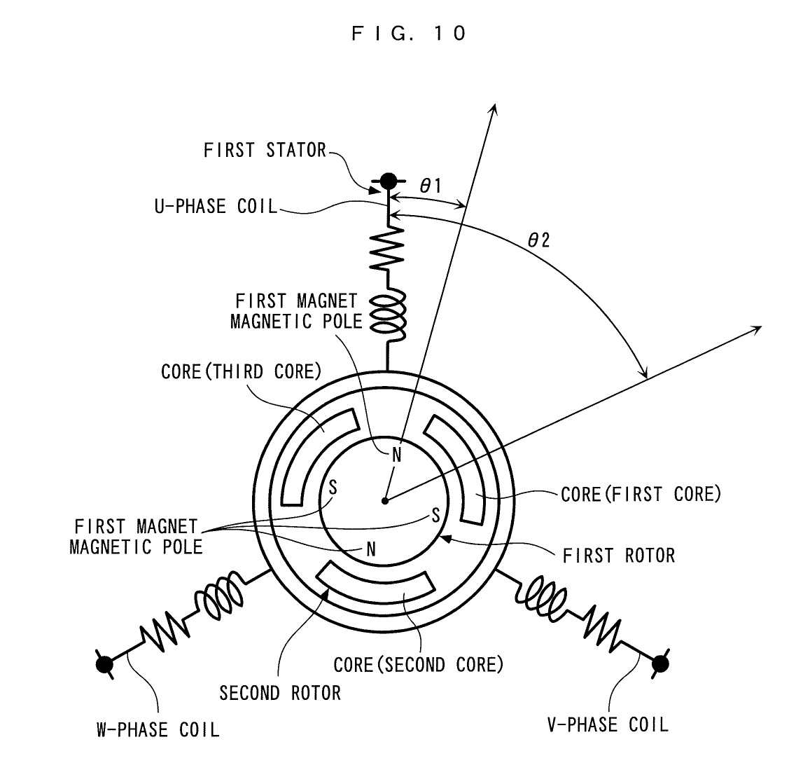

When the first rotating machine 61 is configured under the following condition (A), an equivalent circuit corresponding to the first rotating machine 61 is expressed as shown in FIG. 10.

(A) The number of the first armature magnetic poles is 2, and the number of the first magnet magnetic poles is 4, that is, a pole pair number of the first armature magnetic poles, each pair being formed by an N pole and an S pole of the first armature magnetic poles, has a value of 1, a pole pair number of the first magnet magnetic poles, each pair being formed by an N pole and an S pole of the first magnet magnetic poles, has a value of 2, and the number of the cores 65a is 3 (first to third cores).

Note that as described above, throughout the specification, the term “pole pair” is intended to mean a pair of an N pole and an S pole.

In this case, a magnetic flux Ψk1 of a first magnet magnetic pole passing through the first core of the cores 65a is expressed by the following equation (4):

Ψk1=φf·cos [2(θ2−θ1)] (4)

wherein φf represents the maximum value of the magnetic flux of the first magnet magnetic pole, and θ1 and θ2 represent a rotational angle position of the first magnet magnetic pole and a rotational angle position of the first core, with respect to the U-phase coil 63c, respectively. Further, in this case, since the ratio of the pole pair number of the first magnet magnetic poles to the pole pair number of the first armature magnetic poles is 2.0, the magnetic flux of the first magnet magnetic pole rotates (changes) at a repetition period of the twofold of the repetition period of the first rotating magnetic field, so that in the aforementioned equation (4), to represent this, (θ2−θ1) is multiplied by 2.0.

Therefore, a magnetic flux Ψu1 of the first magnet magnetic pole passing through the U-phase coil 63c via the first core is expressed by the following equation (5) obtained by multiplying the equation (4) by cos θ2.

Ψu1=φf·cos [2(θ2−θ1)] cos θ2 (5)

Similarly, a magnetic flux Ψk2 of the first magnetic pole passing through the second core of the cores 65a is expressed by the following equation (6):

$$Ψ k 2 = ψ f \cdot cos [ 2 ( θ 2 + \frac{2 π}{3} - θ 1 ) ] \qquad ( 6 )$$

In this case, the rotational angle position of the second core with respect to the first stator 63 leads that of the first core by 2π/3, so that in the aforementioned equation (6), to represent this, 2π/3 is added to θ2.

Therefore, a magnetic flux Ψu2 of the first magnet magnetic pole passing through the U-phase coil 63c via the second core is expressed by the following equation (7) obtained by multiplying the equation (6) by cos(θ2+2π/3).

$$Ψ u 2 = ψ f \cdot cos [ 2 ( θ 2 + \frac{2 π}{3} - θ 1 ) ] cos ( θ 2 + \frac{2 π}{3} ) \qquad ( 7 )$$

Similarly, a magnetic flux Ψu3 of the first magnet magnetic pole passing through the U-phase coil 63c via the third core of the cores 65a is expressed by the following equation (8):

$$Ψ u 3 = ψ f \cdot cos [ 2 ( θ 2 + \frac{4 π}{3} - θ 1 ) ] cos ( θ 2 + \frac{4 π}{3} ) \qquad ( 8 )$$

In the first rotating machine 61 as shown in FIG. 10, a magnetic flux Ψu of the first magnet magnetic pole passing through the U-phase coil 63c via the cores 65a is obtained by adding up the magnetic fluxes Ψu1 to Ψu3 expressed by the above-mentioned equations (5), (7) and (8), and hence the magnetic flux Ψu is expressed by the following equation (9):

$$Ψ u = ψ f \cdot cos [ 2 ( θ 2 - θ 1 ) ] cos θ 2 + ψ f \cdot cos [ 2 ( θ 2 + \frac{2 π}{3} - θ 1 ) ] cos ( θ 2 + \frac{2 π}{3} ) + ψ f \cdot cos [ 2 ( θ 2 + \frac{4 π}{3} - θ 1 ) ] cos ( θ 2 + \frac{4 π}{3} ) \qquad ( 9 )$$

Further, when this equation (9) is generalized, the magnetic flux Ψu of the first magnet magnetic pole passing through the U-phase coil 63c via the cores 65a is expressed by the following equation (10):

$$Ψ u = {\sum }_{i = 1}^{b} ψ f \cdot cos \{ a [ θ 2 + ( i - 1 ) \frac{2 π}{b} - θ 1 ] \} cos \{ c [ θ 2 + ( i - 1 ) \frac{2 π}{b} ] \} \qquad ( 10 )$$

wherein a, b and c represent the pole pair number of first magnet magnetic poles, the number of cores 65a, and the pole pair number of first armature magnetic poles. Further, when the above equation (10) is changed based on the formula of the sum and product of the trigonometric function, there is obtained the following equation (11):

$$Ψ u = {\sum }_{i = 1}^{b} \frac{1}{2} \cdot ψ f \{ cos [ ( a + c ) θ 2 - a \cdot θ 1 + ( a + c ) ( i - 1 ) \frac{2 π}{b} ] + cos [ ( a - c ) θ 2 - a \cdot θ 1 + ( a - c ) ( i - 1 ) \frac{2 π}{b} ] \} \qquad ( 11 )$$

When b=a+c is set in this equation (11), and the rearrangement is performed based on cos(θ+2π)=cos θ, there is obtained the following equation (12):

$$\begin{matrix}Ψ u = \frac{b}{2} \cdot ψ f \cdot cos [ ( a + c ) θ 2 - a \cdot θ 1 ] + {\sum }_{i = 1}^{b} \frac{1}{2} \cdot ψ f \{ cos [ ( a - c ) θ 2 - a \cdot θ 1 + & ( 12 )\end{matrix} ( a - c ) ( i - 1 ) \frac{2 π}{b} ] \}$$

When this equation (12) is rearranged based on the addition theorem of the trigonometric function, there is obtained the following equation (13):

$$Ψ u = \frac{b}{2} \cdot ψ f \cdot cos [ ( a + c ) θ 2 - a \cdot θ 1 ] + \frac{1}{2} \cdot ψ f \cdot cos [ ( a - c ) θ 2 - a \cdot θ 1 ] {\sum }_{i = 1}^{b} cos [ ( a - c ) ( i - 1 ) \frac{2 π}{b} ] - \frac{1}{2} \cdot ψ f \cdot sin [ ( a - c ) θ 2 - a \cdot θ 1 ] {\sum }_{i = 1}^{b} sin [ ( a - c ) ( i - 1 ) \frac{2 π}{b} ] \qquad ( 13 )$$

The second term on the right side of the equation (13) is, when rearranged based on the sum total of the series and the Euler's formula on condition that a−c≠0, equal to 0, as is apparent from the following equation (14):

$$\begin{matrix}{\sum }_{i = 1}^{b} cos [ ( a - c ) ( i - 1 ) \frac{2 π}{b} ] = {\sum }_{i = 1}^{b} \frac{1}{2} \{ {e}^{j [ ( a - c ) \frac{2 π}{b} i ]} + {e}^{- j [ ( a - c ) \frac{2 π}{b} i ]} \} \\ = \frac{1}{2} \{ \frac{{e}^{j [ ( a - c ) \frac{2 π}{b} b ]} - 1}{{e}^{j [ ( a - c ) \frac{2 π}{b} ]} - 1} + \frac{{e}^{- j [ ( a - c ) \frac{2 π}{b} b ]} - 1}{{e}^{- j [ ( a - c ) \frac{2 π}{b} ]} - 1} \} \\ = \frac{1}{2} \{ \frac{{e}^{j [ ( a - c ) 2 π ]} - 1}{{e}^{j [ ( a - c ) \frac{2 π}{b} ]} - 1} + \frac{{e}^{- j [ ( a - c ) 2 π ]} - 1}{{e}^{- j [ ( a - c ) \frac{2 π}{b} ]} - 1} \} \\ = \frac{1}{2} \{ \frac{0}{{e}^{j [ ( a - c ) \frac{2 π}{b} ]} - 1} + \frac{0}{{e}^{- j [ ( a - c ) \frac{2 π}{b} ]} - 1} \} \\ = 0\end{matrix} \qquad ( 14 )$$

Further, the third term on the right side of the above-described equation (13) is also, when rearranged based on the sum total of the series and the Euler's formula on condition that a−c≠0, equal to 0, as is apparent from the following equation (15):

$$\begin{matrix}{\sum }_{i = 1}^{b} sin [ ( a - c ) ( i - 1 ) \frac{2 π}{b} ] = {\sum }_{i = 0}^{b} \frac{1}{2} \{ {e}^{j [ ( a - c ) \frac{2 π}{b} i ]} - {e}^{- j [ ( a - c ) \frac{2 π}{b} i ]} \} \\ = \frac{1}{2} \{ \frac{{e}^{j [ ( a - c ) \frac{2 π}{b} b ]} - 1}{{e}^{j [ ( a - c ) \frac{2 π}{b} ]} - 1} - \frac{{e}^{- j [ ( a - c ) \frac{2 π}{b} b ]} - 1}{{e}^{- j [ ( a - c ) \frac{2 π}{b} ]} - 1} \} \\ = \frac{1}{2} \{ \frac{{e}^{j [ ( a - c ) 2 π ]} - 1}{{e}^{j [ ( a - c ) \frac{2 π}{b} ]} - 1} - \frac{{e}^{- j [ ( a - c ) 2 π ]} - 1}{{e}^{- j [ ( a - c ) \frac{2 π}{b} ]} - 1} \} \\ = \frac{1}{2} \{ \frac{0}{{e}^{j [ ( a - c ) \frac{2 π}{b} ]} - 1} - \frac{0}{{e}^{- j [ ( a - c ) \frac{2 π}{b} ]} - 1} \} \\ = 0\end{matrix} \qquad ( 15 )$$

From the above, when a−c≠0 holds, the magnetic flux Ψu of the first magnet magnetic pole passing through the U-phase coil 63c via the cores 65a is expressed by the following equation (16):

$$Ψ u = \frac{b}{2} \cdot ψ f \cdot cos [ ( a + c ) θ 2 - a \cdot θ 1 ] \qquad ( 16 )$$

Further, in this equation (16), if a/c=α, there is obtained the following equation (17):

$$Ψ u = \frac{b}{2} \cdot ψ f \cdot cos [ ( α + 1 ) c \cdot θ 2 - α \cdot c \cdot θ 1 ] \qquad ( 17 )$$

Furthermore, in this equation (17), if c·θ2=θe2 and c·θ1=θe1, there is obtained the following equation (18):

$$Ψ u = \frac{b}{2} \cdot ψ f \cdot cos [ ( α + 1 ) θ e 2 - α \cdot θ e 1 ] \qquad ( 18 )$$

In this equation, as is clear from the fact that θe2 is obtained by multiplying the rotational angle position θ2 of the first core with respect to the U-phase coil 63c by the pole pair number c of the first armature magnetic poles, θe2 represents the electrical angular position of the core 65a with respect to the U-phase coil 63c (hereinafter referred to as the “second rotor electrical angle”). Further, as is apparent from the fact that θe1 is obtained by multiplying the rotational angle position θ1 of the first magnet magnetic pole with respect to the U-phase coil 63c by the pole pair number c of the first armature magnetic poles, θe1 represents the electrical angular position of the first magnet magnetic pole with respect to the U-phase coil 63c (hereinafter referred to as the “first rotor electrical angle”).

Similarly, since the electrical angular position of the V-phase coil 63d leads that of the U-phase coil 63c by the electrical angle 2π/3, the magnetic flux Ψ v of the first magnet magnetic pole passing through the V-phase coil 63d via the cores 65a is expressed by the following equation (19). Further, since the electrical angular position of the W-phase coil 63e is delayed from that of the U-phase coil 63c by the electrical angle 2π/3, the magnetic flux ωw of the first magnet magnetic pole passing through the W-phase coil 63e via the cores 65a is expressed by the following equation (20):

$$\begin{matrix}Ψ v = \frac{b}{2} \cdot ψ f \cdot cos [ ( α + 1 ) θ e 2 - α \cdot θ e 1 - \frac{2 π}{3} ] & ( 19 ) \\ Ψ w = \frac{b}{2} \cdot ψ f \cdot cos [ ( α + 1 ) θ e 2 - α \cdot θ e 1 + \frac{2 π}{3} ] & ( 20 )\end{matrix}$$

Further, when the magnetic fluxes Ψu to Ψw expressed by the aforementioned equations (18) to (20), respectively, are differentiated with respect to time, the following equations (21) to (23) are obtained:

$$\begin{matrix}\frac{d Ψ u}{d t} = - \frac{b}{2} \cdot ψ f \{ [ ( α + 1 ) ω e 2 - α \cdot ω e 1 ] sin [ ( α + 1 ) θ e 2 - α \cdot θ e 1 ] \} & ( 21 ) \\ \frac{d Ψ v}{d t} = - \frac{b}{2} \cdot ψ f \{ [ ( α + 1 ) ω e 2 - α \cdot ω e 1 ] sin [ ( α + 1 ) θ e 2 - α \cdot θ e 1 - \frac{2 π}{3} ] \} & ( 22 ) \\ \frac{d Ψ w}{d t} = - \frac{b}{2} \cdot ψ f \{ [ ( α + 1 ) ω e 2 - α \cdot ω e 1 ] sin [ ( α + 1 ) θ e 2 - α \cdot θ e 1 + \frac{2 π}{3} ] \} & ( 23 )\end{matrix}$$

wherein ωe1 represents a first rotor electrical angular velocity, which is a value obtained by differentiating the first rotor electrical angle θe1 with respect to time, i.e. a value obtained by converting an angular velocity of the first rotor 64 with respect to the first stator 63 to an electrical angular velocity. Furthermore, ωe2 represents a second rotor electrical angular velocity, which is a value obtained by differentiating the second rotor electrical angle θe2 with respect to time, i.e. a value obtained by converting an angular velocity of the second rotor 65 with respect to the first stator 63 to an electrical angular velocity.

Further, magnetic fluxes of the first magnet magnetic poles that directly pass through the U-phase to W-phase coils 63c to 63e without via the cores 65a are very small, and hence influence thereof is negligible. Therefore, dΨu/dt to dΨw/dt (equations (21) to (23)), which are values obtained by differentiating with respect to time the magnetic fluxes Ψu to Ψw of the first magnet magnetic poles, which pass through the U-phase to W-phase coils 63c to 63e via the cores 65a, respectively, represent counter-electromotive force voltages (induced electromotive voltages), which are generated in the U-phase to W-phase coils 63c to 63e as the first magnet magnetic poles and the cores 65a rotate with respect to the first stator 63 (hereinafter referred to as the “U-phase counter-electromotive force voltage Vcu”, the “V-phase counter-electromotive force voltage Vcv” and the “W-phase counter-electromotive force voltage Vcw”, respectively).

From the above, electric currents Iu, Iv and Iw, flowing through the U-phase, V-phase and W-phase coils 63c to 63e, respectively, are expressed by the following equations (24), (25) and (26):

$$\begin{matrix}Iu = I \cdot sin [ ( α + 1 ) θ e 2 - α \cdot θ e 1 ] & ( 24 ) \\ Iv = I \cdot sin [ ( α + 1 ) θ e 2 - α \cdot θ e 1 - \frac{2 π}{3} ] & ( 25 ) \\ Iw = I \cdot sin [ ( α + 1 ) θ e 2 - α \cdot θ e 1 + \frac{2 π}{3} ] & ( 26 )\end{matrix}$$

wherein I represents the amplitude (maximum value) of electric currents Iu to Iw flowing through the U-phase to W-phase coils 63c to 63e, respectively.

Further, from the above equations (24) to (26), the electrical angular position θmf of the vector of the first rotating magnetic field with respect to the U-phase coil 63c is expressed by the following equation (27), and the electrical angular velocity ωmf of the first rotating magnetic field with respect to the U-phase coil 63c (hereinafter referred to as the “magnetic field electrical angular velocity”) is expressed by the following equation (28):

θmf=(α+1)θe2−α·θe1 (27)

ωmf=(α+1)ωe2−α·ωe1 (28)

Therefore, the relationship between the magnetic field electrical angular velocity ωmf and the first and second rotor electrical angular velocities ωe1 and ωe2, which is represented in a so-called collinear chart, is illustrated e.g. as in FIG. 11. Note that in FIG. 11 and other velocity collinear charts, described hereinafter, similarly to the velocity collinear chart shown in FIG. 3, referred to hereinabove, vertical lines intersecting with a horizontal line indicative of a value of 0 are for representing the respective angular velocities (rotational speeds) of parameters, and the distance from the horizontal line to a white circle shown on each vertical line corresponds to the angular velocity (rotational speed) of each of the parameters.

Further, the mechanical output (motive power) W, which is output to the first and second rotors 64 and 65 by the flowing of the respective electric currents Iu to Iw through the U-phase to W-phase coils 63c to 63e, is represented, provided that an reluctance-associated portion is excluded therefrom, by the following equation (29):

$$W = \frac{d Ψ u}{d t} \cdot Iu + \frac{d Ψ v}{d t} \cdot Iv + \frac{d Ψ w}{d t} \cdot Iw \qquad ( 29 )$$

When the above equations (21) to (26) are substituted into this equation (29) for rearrangement, there is obtained the following equation (30):

$$W = - \frac{3 \cdot b}{4} \cdot ψ f \cdot I [ ( α + 1 ) ω e 2 - α \cdot ω e 1 ] \qquad ( 30 )$$

Furthermore, the relationship between this mechanical output W, the aforementioned first and second rotor-transmitted torques TR1 and TR2, and the first and second rotor electrical angular velocities ωe1 and ωe2 is expressed by the following equation (31):

W=TR1·ωe1+TR2·ωe2 (31)

As is apparent from the above equations (30) and (31), the first and second rotor-transmitted torques TR1 and TR2 are expressed by the following equations (32) and (33), respectively:

$$\begin{matrix}TR 1 = α \cdot \frac{3 \cdot b}{4} \cdot ψ f \cdot I & ( 32 ) \\ TR 2 = - ( α + 1 ) \cdot \frac{3 \cdot b}{4} \cdot ψ f \cdot I & ( 33 )\end{matrix}$$

Further, due to the fact that the electric power supplied to the first stator 63 and the mechanical output W are equal to each other (provided that losses are ignored), and from the aforementioned equations (28) and (30), the above-described first driving equivalent torque TSE1 (torque equivalent to the electric power supplied to the first stator 63 and the magnetic field electrical angular velocity ωmf) is expressed by the following equation (34):

$$TSE 1 = \frac{3 \cdot b}{4} \cdot ψ f \cdot I \qquad ( 34 )$$

Further, by using the above equations (32) to (34), there is obtained the following equation (35):

$$TSE 1 = \frac{TR 1}{α} = \frac{- TR 2}{( α + 1 )} \qquad ( 35 )$$

The relationship between the torques, expressed by the equation (35), and the relationship between the electrical angular velocities, expressed by the equation (28), are quite the same as the relationship between the torques and the relationship between the rotational speeds of the sun gear, ring gear and carrier of a planetary gear unit.

Further, as described above, on condition that b=a+c and a−c≠0, the relationship between the electrical angular velocities, expressed by the equation (28), and the relationship between the torques, expressed by the equation (35), hold. The above condition b=a+c is expressed by b=(p+q)/2, i.e. b/q=(1+p/q)/2, assuming that the number of the first magnet magnetic poles is p and that of the first armature magnetic poles is q. Here, as is apparent from the fact that if p/q=m, b/q=(1+m)/2 is obtained, the satisfaction of the above condition of b=a+c represents that the ratio between the number of the first armature magnetic poles, the number of the first magnet magnetic poles, and the number of the cores 65a is 1:m:(1+m)/2. Further, the satisfaction of the above condition of a−c≠0 represents that m≠1.0 holds.

As is apparent from the above, if the ratio between the number of the first armature magnetic poles, the number of the first magnet magnetic poles, and the number of the cores 65a is set to 1:m:(1+m)/2 (m≠1.0), the first rotating machine 61 properly operates, and the relationship between the electrical angular velocities, expressed by the equation (28), and the relationship between the torques, expressed by the equation (35) hold. In the present embodiment, as described hereinabove, the number of the first armature magnetic poles is 4, the number of the first magnet magnetic poles is 8, and the number of the cores 65a is 6, i.e. the number of the first armature magnetic poles, the number of the first magnet magnetic poles, and the number of the cores 65a is 1:2:(1+2)/2. Therefore, the first rotating machine 61 properly operates, and the relationship between the electrical angular velocities, expressed by the equation (28), and the relationship between the torques, expressed by the equation (35) hold.

Next, a more specific description will be given of how electric power supplied to the first stator 63 is converted to motive power and is output from the first rotor 64 and the second rotor 65. First, a case where electric power is supplied to the first stator 63 in a state in which the first rotor 64 is held unrotatable will be described with reference to FIGS. 12 to 14. Note that in FIGS. 12 to 14, reference numerals indicative of a plurality of component elements are omitted from illustration for convenience. This also applies to other figures, referred to hereinafter. Further, in FIGS. 12 to 14, one identical first armature magnetic pole and one identical core 65a are indicated by hatching for clarity.

First, as shown in FIG. 12(a), from a state where the center of a certain core 65a and the center of a certain permanent magnet 64a are circumferentially coincident with each other, and the center of a third core 65a from the certain core 65a and the center of a fourth permanent magnet 64a from the certain permanent magnet 64a are circumferentially coincident with each other, the first rotating magnetic field is generated such that it rotates leftward, as viewed in the figure. At the start of generation of the first rotating magnetic field, the positions of two first armature magnetic poles adjacent but one to each other that have the same polarity are caused to circumferentially coincide with the centers of ones of the permanent magnets 64a the centers of which are coincident with the centers of cores 65a, respectively, and the polarity of these first armature magnetic poles is made different from the polarity of the first magnet magnetic poles of these permanent magnets 64a.

Since the first rotating magnetic field is generated by the first stator 63, between the same and the first rotor 64, and the second rotor 65 having the cores 65a is disposed between the first stator 63 and the first rotor 64, as described hereinabove, the cores 65a are magnetized by the first armature magnetic poles and the first magnet magnetic poles. Because of this fact and the fact that the cores 65a adjacent to each other are spaced from each other, magnetic force lines ML are generated in a manner connecting between the first armature magnetic poles, the cores 65a, and the first magnet magnetic poles. Note that in FIGS. 12 to 14, magnetic force lines ML at the iron core 63a and the mounting portion 64b are omitted from illustration for convenience. This also applies to other figures, referred to hereinafter.

In the state shown in FIG. 12(a), the magnetic force lines ML are generated in a manner connecting the first armature magnetic poles, cores 65a and first magnet magnetic poles the circumferential positions of which are coincident with each other, and at the same time in a manner connecting first armature magnetic poles, cores 65a and first magnet magnetic poles which are adjacent to the above-mentioned first armature magnetic poles, cores 65a, and first magnet magnetic poles, on respective circumferentially opposite sides thereof. Further, in this state, since the magnetic force lines ML are straight, no magnetic forces for circumferentially rotating the cores 65a act on the cores 65a.

When the first armature magnetic poles rotate from the positions shown in FIG. 12(a) to respective positions shown in FIG. 12(b) in accordance with rotation of the first rotating magnetic field, the magnetic force lines ML are bent, and accordingly magnetic forces act on the cores 65a in such a manner that the magnetic force lines ML are made straight. In this case, the magnetic force lines ML are bent at the cores 65a in a manner convexly curved in an opposite direction to a direction of rotation of the first rotating magnetic field (hereinafter, this direction is referred to as the “magnetic field rotation direction”) with respect to the straight lines each connecting a first armature magnetic pole and a first magnet magnetic pole which are connected to each other by an associated one of the magnetic force lines ML. Therefore, the above-described magnetic forces act on the cores 65a to drive the same in the magnetic field rotation direction. The cores 65a are driven in the magnetic field rotation direction by such action of the magnetic forces caused by the magnetic force lines ML, for rotation to respective positions shown in FIG. 12(c), and the second rotor 65 provided with the cores 65a also rotates in the magnetic field rotation direction. Note that broken lines in FIGS. 12(b) and 12(c) represent very small magnetic flux amounts of the magnetic force lines ML, and hence weak magnetic connections between the first armature magnetic poles, the cores 65a, and the first magnet magnetic poles.

This also applies to other figures, referred to hereinafter.

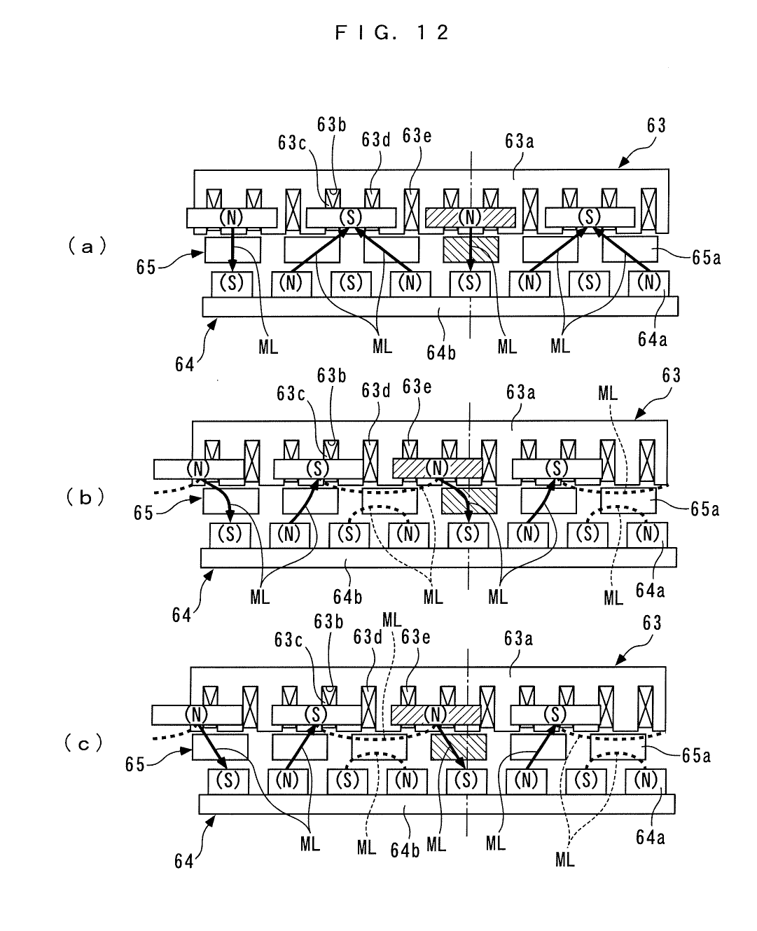

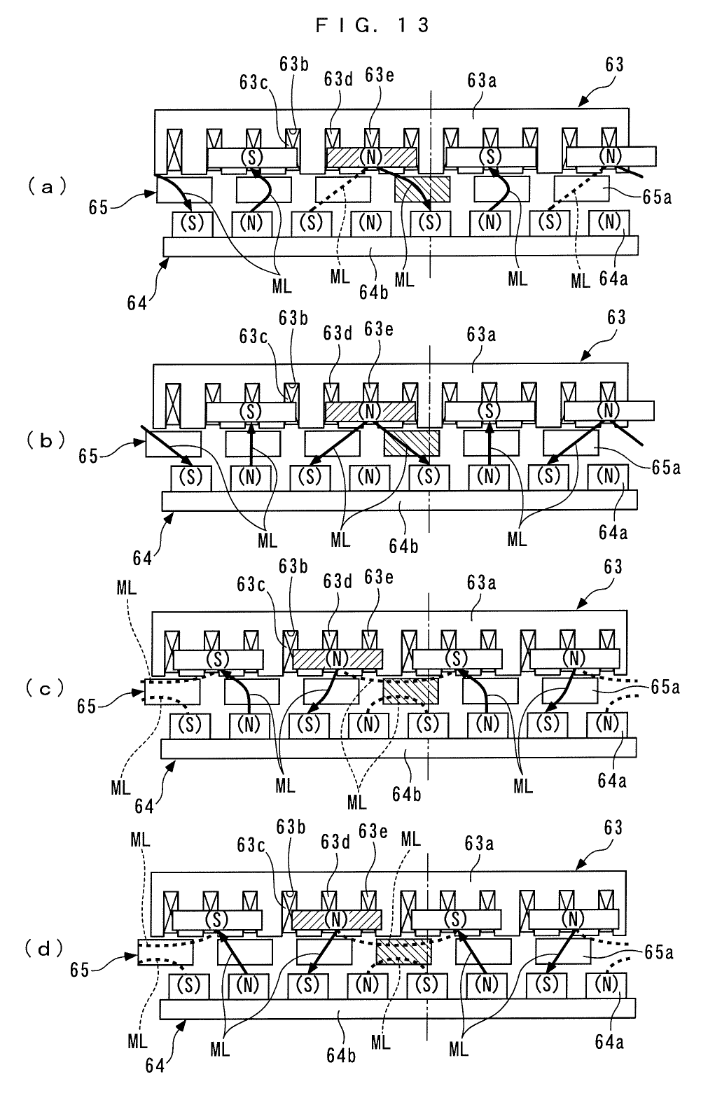

As the first rotating magnetic field further rotates, a sequence of the above-described operations, that is, the operations that “the magnetic force lines ML are bent at the cores 65a in a manner convexly curved in the direction opposite to the magnetic field rotation direction→the magnetic forces act on the cores 65a in such a manner that the magnetic force lines ML are made straight→the cores 65a and the second rotor 65 rotate in the magnetic field rotation direction” are repeatedly performed as shown in FIGS. 13(a) to 13(d), and FIGS. 14(a) and 14(b). As described above, in the case where electric power is supplied to the first stator 63 in the state of the first rotor 64 being held unrotatable, the action of the magnetic forces caused by the magnetic force lines ML as described above converts electric power supplied to the first stator 63 to motive power, and outputs the motive power from the second rotor 65.

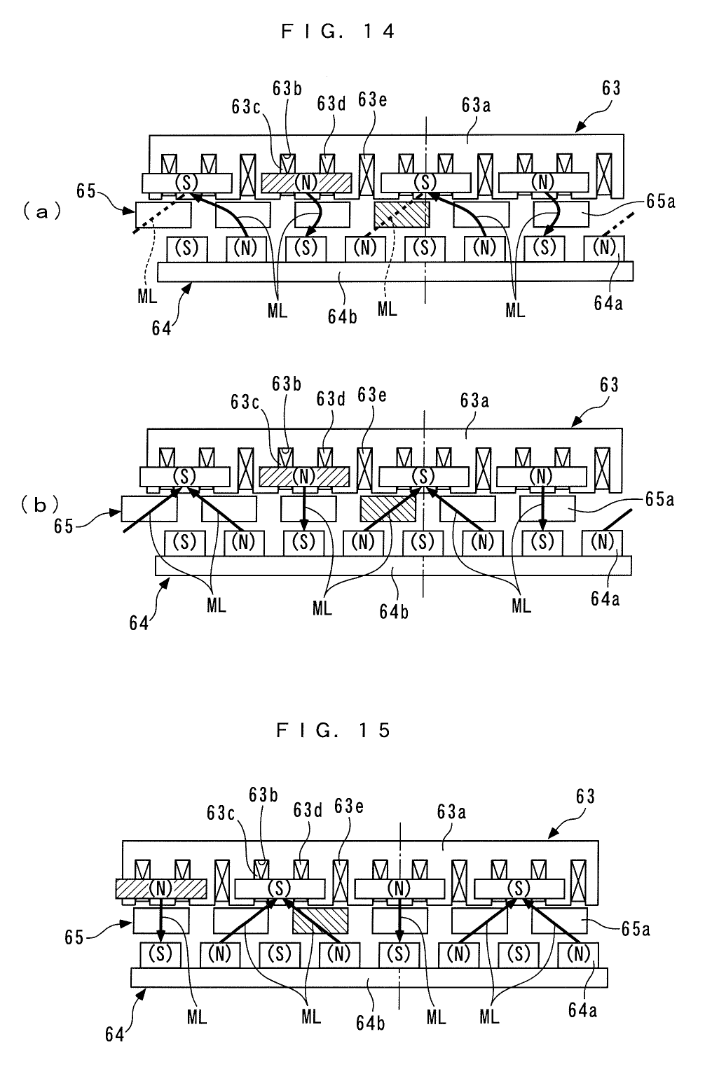

FIG. 15 shows a state in which the first armature magnetic poles have rotated from the FIG. 12(a) state through an electrical angle of 2π. As is apparent from a comparison between FIG. 15 and FIG. 12(a), it is understood that the cores 65a have rotated in the same direction through ⅓ of a rotational angle of the first armature magnetic poles. This agrees with the fact that by substituting ωe1=0 into the aforementioned equation (28), ωe2=ωmf/(α+1)=ωmf/3 is obtained.

Next, an operation in a case where electric power is supplied to the first stator 63 in a state in which the second rotor 65 is held unrotatable will be described with reference to FIGS. 16 to 18. Note that in FIGS. 16 to 18, one identical first armature magnetic pole and one identical permanent magnet 64a are indicated by hatching for clarity. First, as shown in FIG. 16(a), similarly to the above-described case shown in FIG. 12(a), from a state where the center of a certain core 65a and the center of a certain permanent magnet 64a are circumferentially coincident with each other, and the center of the third core 65a from the certain core 65a and the center of the fourth permanent magnet 64a from the certain permanent magnet 64a are circumferentially coincident with each other, the first rotating magnetic field is generated such that it rotates leftward, as viewed in the figure. At the start of generation of the first rotating magnetic field, the positions of first armature magnetic poles adjacent but one to each other that have the same polarity are caused to circumferentially coincide with the centers of corresponding ones of the respective permanent magnets 64a having centers coincident with the centers of cores 65a, and the polarity of these first armature magnetic poles is made different from the polarity of the first magnet magnetic poles of these permanent magnets 64a.

In the state shown in FIG. 16(a), similarly to the case shown in FIG. 12(a), magnetic force lines ML are generated in a manner connecting the first armature magnetic poles, cores 65a and first magnet magnetic poles the circumferential positions of which are coincident with each other, and at the same time in a manner connecting first armature magnetic poles, cores 65a and first magnet magnetic poles which are adjacent to the above-mentioned first armature magnetic pole, core 65a, and first magnet magnetic pole, on respective circumferentially opposite sides thereof. Further, in this state, since the magnetic force lines ML are straight, no magnetic forces for circumferentially rotating the permanent magnets 64a act on the permanent magnets 64a.

When the first armature magnetic poles rotate from the positions shown in FIG. 16(a) to respective positions shown in FIG. 16(b) in accordance with rotation of the first rotating magnetic field, the magnetic force lines ML are bent, and accordingly magnetic forces act on the permanent magnets 64a in such a manner that the magnetic force lines ML are made straight. In this case, the permanent magnets 64a are each positioned forward of a line of extension from a first armature magnetic pole and a core 65a which are connected to each other by an associated one of the magnetic force lines ML, in the magnetic field rotation direction, and therefore the above-described magnetic forces act on the permanent magnets 64a such that each permanent magnet 64a is caused to be positioned on the extension line, i.e. such that the permanent magnet 64a is driven in a direction opposite to the magnetic field rotation direction. The permanent magnets 64a are driven in a direction opposite to the magnetic field rotation direction by such action of the magnetic forces caused by the magnetic force lines ML, and rotate to respective positions shown in FIG. 16(c). The first rotor 64 provided with the permanent magnets 64a also rotates in the direction opposite to the magnetic field rotation direction.

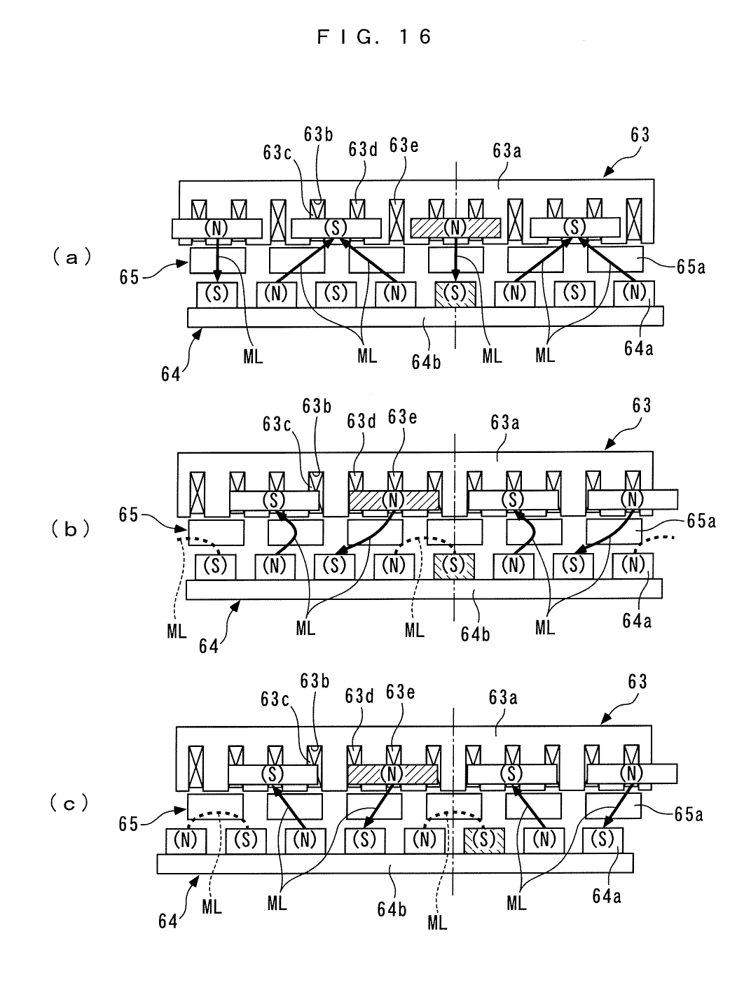

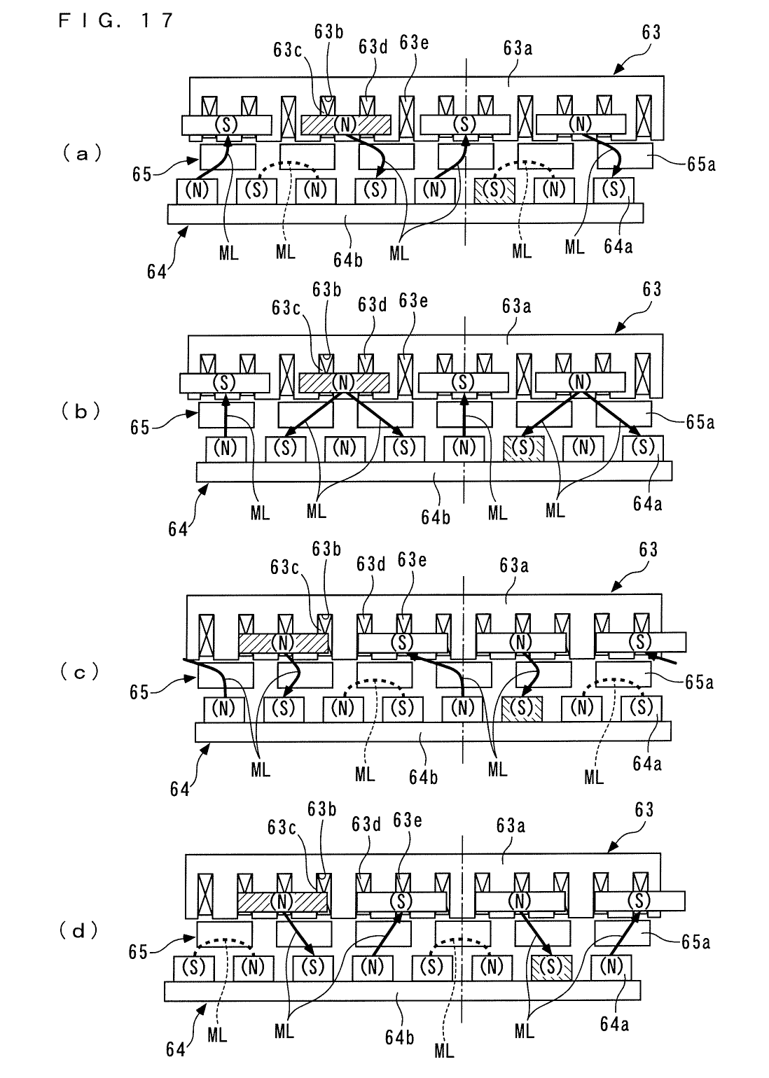

As the first rotating magnetic field further rotates, a sequence of the above-described operations, that is, the operations that “the magnetic force lines ML are bent and the permanent magnets 64a are each positioned forward of a line of extension from a first armature magnetic pole and a core 65a which are connected to each other by an associated one of the magnetic force lines ML, in the magnetic field rotation direction→the magnetic forces act on the permanent magnets 64a in such a manner that the magnetic force lines ML are made straight→the permanent magnets 64a and the first rotor 64 rotate in the direction opposite to the magnetic field rotation direction” are repeatedly performed as shown in FIGS. 17(a) to 17(d), and FIGS. 18(a) and 18(b). As described above, in the case where electric power is supplied to the first stator 63 in the state of the second rotor 65 being held unrotatable, the above-described action of the magnetic forces caused by the magnetic force lines ML converts electric power supplied to the first stator 63 to motive power, and outputs the motive power from the first rotor 64.

FIG. 18(b) shows a state in which the first armature magnetic poles have rotated from the FIG. 16(a) state through the electrical angle of 2π. As is apparent from a comparison between FIG. 18(b) and FIG. 16(a), it is understood that the permanent magnets 64a have rotated in the opposite direction through ½ of a rotational angle of the first armature magnetic poles. This agrees with the fact that by substituting ωe2=0 into the aforementioned equation (28), −ωe1=ωmf/α=ωmf/2 is obtained.

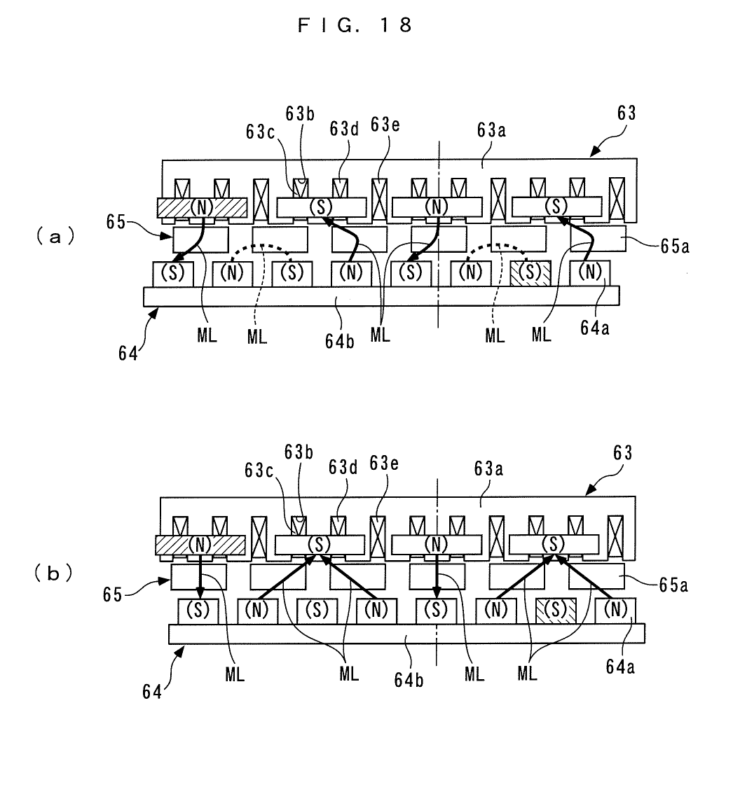

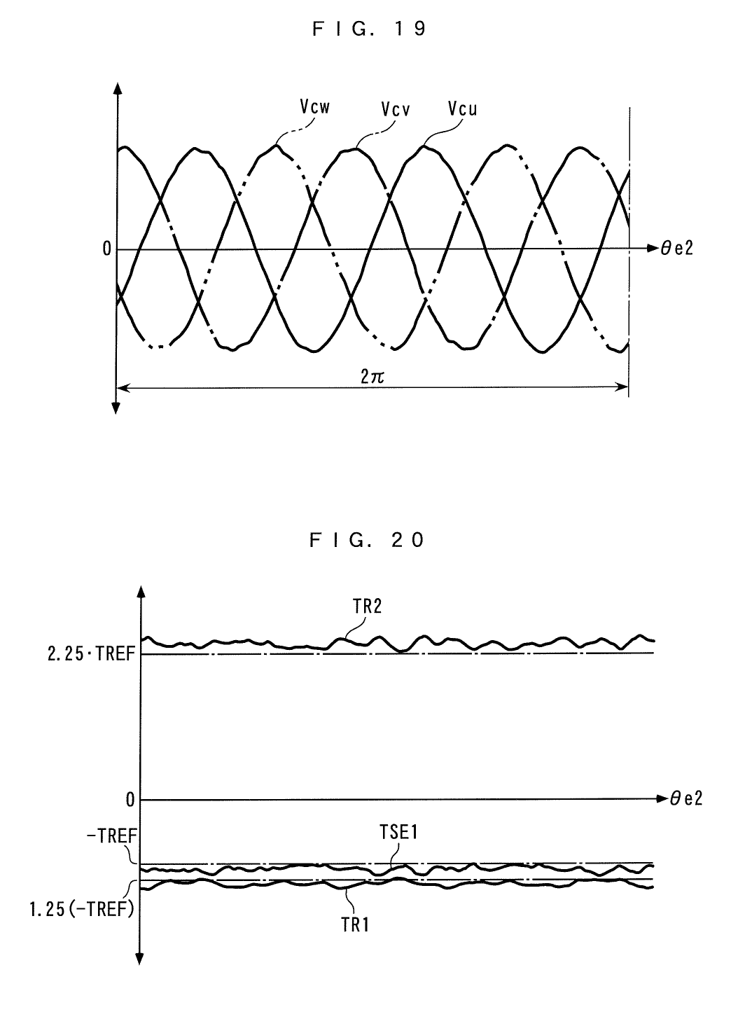

FIGS. 19 and 20 show results of a simulation of control in which the numbers of the first armature magnetic poles, the cores 65a, and the first magnet magnetic poles are set to 16, 18 and 20, respectively; the first rotor 64 is held unrotatable; and motive power is output from the second rotor 65 by supplying electric power to the first stator 63. FIG. 19 shows an example of changes in the U-phase to W-phase counter-electromotive force voltages Vcu to Vcw during a time period over which the second rotor electrical angle θe2 changes from 0 to 2π.

In this case, due to the fact that the first rotor 64 is held unrotatable, and the fact that the pole pair numbers of the first armature magnetic poles and the first magnet magnetic poles are equal to 8 and 10, respectively, and from the aforementioned equation (28), the relationship between the magnetic field electrical angular velocity ωmf and the first and second rotor electrical angular velocities ωe1 and ωe2 is expressed by ωmf=2.25·ωe2. As shown in FIG. 19, during a time period over which the second rotor electrical angle θe2 changes from 0 to 2π, the U-phase to W-phase counter-electromotive force voltages Vcu to Vcw are generated over approximately 2.25 repetition periods thereof. Further, FIG. 19 shows changes in the U-phase to W-phase counter-electromotive force voltages Vcu to Vcw, as viewed from the second rotor 65. As shown in the figure, with the second rotor electrical angle θe2 as the horizontal axis, the counter-electromotive force voltages are arranged in the order of the W-phase counter-electromotive force voltage Vcw, the V-phase counter-electromotive force voltage Vcv, and the U-phase counter-electromotive force voltage Vcu. This represents that the second rotor 65 rotates in the magnetic field rotation direction. The simulation results described above with reference to FIG. 19 agree with the relationship of w mf=2.25·ωe2, based on the aforementioned equation (28).

Further, FIG. 20 shows an example of changes in the first driving equivalent torque TSE1, and the first and second rotor-transmitted torques TR1 and TR2. In this case, due to the fact that the pole pair numbers of the first armature magnetic poles and the first magnet magnetic poles are equal to 8 and 10, respectively, and from the aforementioned equation (35), the relationship between the first driving equivalent torque TSE1, and the first and second rotor-transmitted torques TR1 and TR2 is represented by TSE1=TR1/1.25=−TR2/2.25. As shown in FIG. 20, the first driving equivalent torque TSE1 is approximately equal to −TREF; the first rotor-transmitted torque TR1 is approximately equal to 1.25·(−TREF); and the second rotor-transmitted torque TR2 is approximately equal to 2.25·TREF. This symbol TREF represents a predetermined torque value (e.g. 200 Nm). The simulation results described above with reference to FIG. 20 agree with the relationship of TSE1=TR1/1.25=−TR2/2.25, based on the aforementioned equation (35).

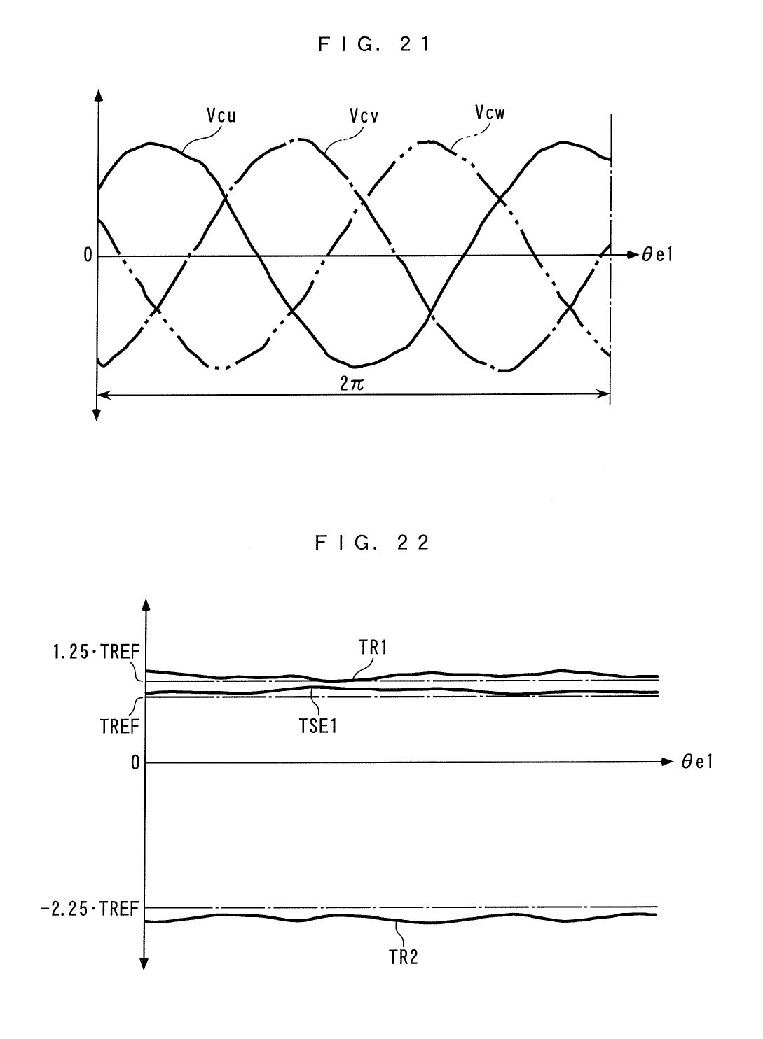

FIGS. 21 and 22 show results of a simulation of control in which the numbers of the first armature magnetic poles, the cores 65a, and the first magnet magnetic poles are set in the same manner as in the cases illustrated in FIGS. 19 and 20; the second rotor 65 is held unrotatable in place of the first rotor 64; and motive power is output from the first rotor 64 by supplying electric power to the first stator 63. FIG. 21 shows an example of changes in the U-phase to W-phase counter-electromotive force voltages Vcu to Vcw during a time period over which the first rotor electrical angle θe1 changes from 0 to 2π.

In this case, due to the fact that the second rotor 65 is held unrotatable, and the fact that the pole pair numbers of the first armature magnetic poles and the first magnet magnetic poles are equal to 8 and 10, respectively, and from the aforementioned equation (28), the relationship between the magnetic field electrical angular velocity ωmf, and the first and second rotor electrical angular velocities ωe1 and ωe2 is expressed by ωmf=−1.25·ωe1. As shown in FIG. 21, during a time period over which the first rotor electrical angle θe1 changes from 0 to 2π, the U-phase to W-phase counter-electromotive force voltages Vcu to Vcw are generated over approximately 1.25 repetition periods thereof. Further, FIG. 21 shows changes in the U-phase to W-phase counter-electromotive force voltages Vcu to Vcw, as viewed from the first rotor 64. As shown in the figure, with the first rotor electrical angle θe1 as the horizontal axis, the counter-electromotive force voltages are arranged in the order of the U-phase counter-electromotive force voltage Vcu, the V-phase counter-electromotive force voltage Vcv, and the W-phase counter-electromotive force voltage Vcw. This represents that the first rotor 64 rotates in the direction opposite to the magnetic field rotation direction. The simulation results described above with reference to FIG. 21 agree with the relationship of ωmf=−1.25·ωe1, based on the aforementioned equation (28).

Further, FIG. 22 shows an example of changes in the first driving equivalent torque TSE1 and the first and second rotor-transmitted torques TR1 and TR2. Also in this case, similarly to the FIG. 20 case, the relationship between the first driving equivalent torque TSE1, and the first and second rotor-transmitted torques TR1 and TR2 is represented by TSE1=TR1/1.25=−TR2/2.25 from the aforementioned equation (35). As shown in FIG. 22, the first driving equivalent torque TSE1 is approximately equal to TREF; the first rotor-transmitted torque TR1 is approximately equal to 1.25·TREF; and the second rotor-transmitted torque TR2 is approximately equal to −2.25·TREF. The simulation results described above with reference to FIG. 22 agree with the relationship of TSE1=TR1/1.25=−TR2/2.25, based on the aforementioned equation (35).

As described above, in the first rotating machine 61, when the first rotating magnetic field is generated by supplying electric power to the first stator 63, magnetic force lines ML are generated in a manner connecting between the aforementioned first magnet magnetic poles, the core 65a, and the first armature magnetic poles, and the action of the magnetism of the magnetic force lines ML converts the electric power supplied to the first stator 63 to motive power. The motive power is output from the first rotor 64 or the second rotor 65, and the aforementioned relationship between the electrical angular velocities and relationship between the torques hold. Therefore, by inputting motive power to at least one of the first and second rotors 64 and 65 in a state where electric power is not being supplied to the first stator 63, to thereby cause the same to rotate with respect to the first stator 63, electric power is generated in the first stator 63, and the first rotating magnetic field is generated. In this case as well, such magnetic force lines ML that connect between the first magnet magnetic poles, the core 65a and the first armature magnetic poles are generated, and the action of the magnetism of the magnetic force lines ML causes the electrical angular velocity relationship shown in the equation (28) and the torque relationship shown in the equation (35) to hold.

That is, assuming that torque equivalent to the generated electric power and the magnetic field electrical angular velocity ωmf is referred to as the first electric power-generating equivalent torque TGE1, a relationship shown in the equation (35) also holds between the first electric power-generating equivalent torque TGE1 and the first and second rotor-transmitted torques TR1 and TR2. As is apparent from the above, the first rotating machine 61 according to the present embodiment has the same functions as those of an apparatus formed by combining a planetary gear unit and a general one-rotor-type rotating machine.

Further, in the first rotating machine 61, the relationship between the rotational speed of the first rotating magnetic field (hereinafter referred to as the “first magnetic field rotational speed) NMF1, the rotational speed of the first rotor 64 (hereinafter referred to as the “first rotor rotational speed”) NR1, and the rotational speed of the second rotor 65 (hereinafter referred to as the “second rotor rotational speed”) NR2 holds if m (the number of the first magnet magnetic poles p/the number of the first armature magnetic poles q)≠1.0 holds insofar as the equation (28) is satisfied. Furthermore, the relationship between the first driving equivalent torque TSE1 (the first electric power-generating equivalent torque TGE1), and the first and second rotor-transmitted torques TR1 and TR2 holds if p/q≠1.0 holds insofar as the equation (35) is satisfied. Therefore, by setting α (=a/c) in the above equations (28) and (35), that is, the ratio of the pole pair number a of the first magnet magnetic poles to the pole pair number c of the first armature magnetic poles (hereinafter referred to as the “first pole pair number ratio”), it is possible to freely set the relationship between the first magnetic field rotational speed NMF1, and the first and second rotor rotational speeds NR1 and NR2, and the relationship between the first driving equivalent torque TSE1 (the first electric power-generating equivalent torque TGE1), and the first and second rotor-transmitted torques TR1 and TR2, thereby making it possible to enhance the degree of freedom in design of the first rotating machine 61. The same advantageous effects can be obtained also when the number of phases of the coils 63c to 63e of the first stator 63 is other than the aforementioned 3.

Note that in the present embodiment, since the first pole pair number ratio α=2.0 holds, the relationship between the first magnetic field rotational speed NMF1, and the first and second rotor rotational speeds NR1 and NR2 is represented by NMF1=3·NR2−2·NR1, and the relationship between the first driving equivalent torque TSE1 (the first electric power-generating equivalent torque TGE1), and the first and second rotor-transmitted torques TR1 and TR2 is represented by TSE1(TGE1)=TR1/2=−TR2/3.

Through the control of the first PDU 31 and the VCU 33, the ECU 2 controls the electric power supplied to the first stator 63 and the first magnetic field rotational speed NMF1 of the first rotating magnetic field generated in accordance with the supply of electric power. Further, through the control of the first PDU 31 and the VCU 33, the ECU 2 controls the electric power generated by the first stator 63 and the first magnetic field rotational speed NMF1 of the first rotating magnetic field generated along with the electric power generation.

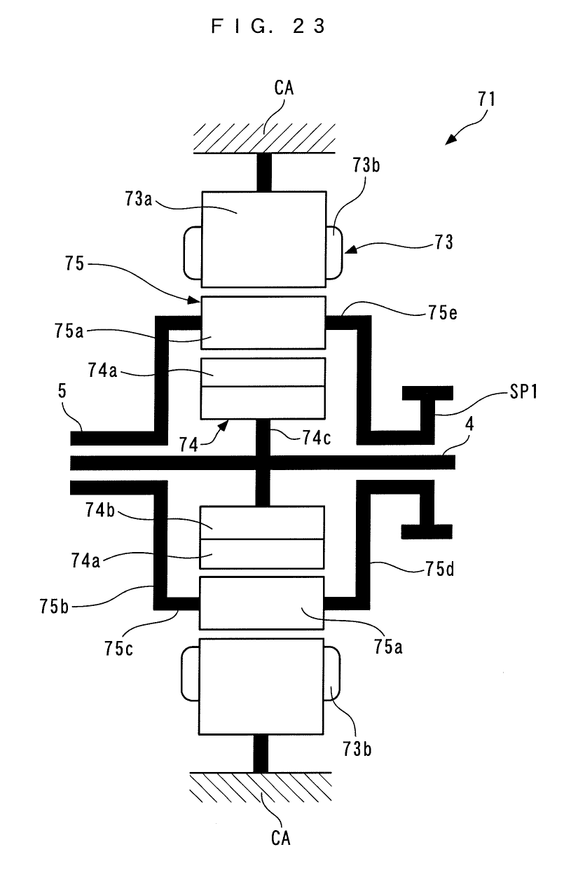

Further, the second rotating machine 71 is configured similarly to the first rotating machine 61, and therefore a brief description will be given hereinafter of the construction and the operations thereof. As shown in FIGS. 6 and 23, the second rotating machine 71 includes a second stator 73, a third rotor 74 disposed in a manner opposed to the second stator 73, and a fourth rotor 75 disposed between the two 73 and 74. The second stator 73, the fourth rotor 75 and the third rotor 74 are arranged coaxially with each other in the radial direction from outside in the mentioned order.

The aforementioned second stator 73 is for generating a second rotating magnetic field, and includes an iron core 73a, and U-phase, V-phase and W-phase coils 73b provided on the iron core 73a. The iron core 73a, which has a hollow cylindrical shape formed by laminating a plurality of steel plates, extends in the axial direction, and is fixed to the casing CA. Further, the inner peripheral surface of the iron core 73a is formed with twelve slots (not shown). The slots are arranged at equally-spaced intervals in the circumferential direction. The above-described U-phase to W-phase coils 73b are wound in the slots by distributed winding (wave winding). The second stator 73 including the U-phase to W-phase coils 73b is electrically connected to the battery 34 via the above-mentioned second PDU 32 and VCU 33. Further, as described hereinabove, the first and second PDUs 31 and 32 are electrically connected to each other. As described above, the first and second stators 63 and 73 are electrically connected to each other via the first and second PDUs 31 and 32, and is configured to be capable of mutually giving and receiving electric power therebetween.

In the second stator 73 constructed as above, when electric power is supplied from the battery 34, to thereby cause electric currents to flow through the U-phase to W-phase coils 73b, or when electric power is generated, four magnetic poles are generated at respective ends of the iron core 73a toward the third rotor 74 at equally-spaced intervals in the circumferential direction, and the second rotating magnetic field generated by the magnetic poles rotates in the circumferential direction. Hereinafter, the magnetic poles generated on the iron core 73a are referred to as the “second armature magnetic poles”. Further, each two second armature magnetic poles which are circumferentially adjacent to each other have polarities different from each other.

The third rotor 74 includes a second magnetic pole row comprising eight permanent magnets 74a (only two of which are shown). These permanent magnets 74a are arranged at equally-spaced intervals in the circumferential direction, and the second magnetic pole row is opposed to the iron core 73a of the second stator 73. Each permanent magnet 74a extends in the axial direction, and the length thereof in the axial direction is set to the same length as that of the iron core 73a of the second stator 73.

Further, the permanent magnets 74a are mounted on an outer peripheral surface of an annular mounting portion 74b. This mounting portion 74b is formed by a soft magnetic material, such as iron or a laminate of a plurality of steel plates, and has an inner peripheral surface thereof attached to the outer peripheral surface of a disk-shaped flange 74c. The flange 74c is integrally formed on the aforementioned first rotating shaft 4. Thus, the third rotor 74 including the permanent magnets 74a is mechanically directly connected to the crankshaft 3a together with the first rotating machine 61 and the second rotor 65. Further, the permanent magnets 74a are attached to the outer peripheral surface of the mounting portion 74b formed by the soft magnetic material, as described above, and hence a magnetic pole of (N) or (S) appears on an end of each permanent magnet 74a toward the second stator 73. Further, each two permanent magnets 74a circumferentially adjacent to each other have polarities different from each other.

The fourth rotor 75 includes a second soft magnetic material element row comprising six cores 75a (only two of which are shown). These cores 75a are arranged at equally-spaced intervals in the circumferential direction, and the second soft magnetic material element row is disposed between the iron core 73a of the second stator 73 and the second magnetic pole row of the third rotor 74, in a manner spaced therefrom by respective predetermined distances. Each core 75a is formed by a soft magnetic material, such as a laminate of a plurality of steel plates, and extends in the axial direction. Further, similarly to the permanent magnet 74a, the length of the core 75a in the axial direction is set to the same length as that of the iron core 73a of the second stator 73.

Furthermore, an end of the core 75a toward the first rotating machine 61 is mounted on an outer end of an annular plate-shaped flange 75b via a hollow cylindrical connecting portion 75c slightly extending in the axial direction. This flange 75b is integrally formed on the aforementioned second rotating shaft 5. This arrangement mechanically directly connects the fourth rotor 75 including the cores 75a to the first rotor 64 of the first rotating machine 61. Further, an end of the core 75a toward the engine 3 is mounted on an outer end of an annular plate-shaped flange 75d via a hollow cylindrical connecting portion 75e slightly extending in the axial direction. This flange 75d is integrally formed on the aforementioned first sprocket SP1. This arrangement mechanically connects the fourth rotor 75 including the cores 75a to the drive wheels DW and DW together with the first rotor 64.

As described hereinabove, the second rotating machine 71 includes the four second armature magnetic poles, the eight magnetic poles of the permanent magnets 74a (hereinafter referred to as the “second magnet magnetic poles”), and the six cores 75a. That is, the ratio between the number of the second armature magnetic poles, the number of the second magnet magnetic poles, and the number of the cores 75a is set to 1:2.0:(1+2.0)/2, similarly to the ratio between the number of the first armature magnetic poles, the number of the first magnet magnetic poles, and the number of the cores 65a of the first rotating machine 61. Further, the ratio of the number of pole pairs of the second magnet magnetic poles to the number of pole pairs of the second armature magnetic poles (hereinafter referred to as the “second pole pair number ratio β”) is set to 2.0, similarly to the first pole pair number ratio α of the first rotating machine 61. As described above, since the second rotating machine 71 is constructed similarly to the first rotating machine 61, it has the same functions as those of the first rotating machine 61.

More specifically, the second rotating machine 71 converts electric power supplied to the second stator 73 to motive power, for outputting the motive power from the third rotor 74 or the fourth rotor 75, and converts motive power input to the third rotor 74 or the fourth rotor 75 to electric power, for outputting the electric power from the second stator 73. Further, during such input and output of electric power and motive power, the second rotating magnetic field and the third and fourth rotors 74 and 75 rotate while holding such a collinear relationship with respect to the rotational speed, as shown in the equation (28) concerning the aforementioned first rotating machine 61. That is, in this case, between the rotational speed of the second rotating magnetic field (hereinafter referred to as the “second magnetic field rotational speed NMF2”), and the rotational speeds of the third and fourth rotors 74 and 75 (hereinafter referred to as the “third rotor rotational speed NR3” and the “fourth rotor rotational speed NR4”, respectively), there holds the following equation (36):

NMF2=(β+1)NR4−β·NR3=3·NR4−2·NR3 (36)

Further, if torque equivalent to the electric power supplied to the second stator 73 and the second magnetic field rotational speed NMF2 is referred to as the “second driving equivalent torque TSE2”, there holds the following equation (37) between the second driving equivalent torque TSE2, and torques transmitted to the third and fourth rotors 74 and 75 (hereinafter referred to as the “third rotor-transmitted torque TR3” and the “fourth rotor-transmitted torque TR4”, respectively):

TSE2=TR3/β=−TR4/(β+1)=TR3/2=−TR4/3 (37)

Furthermore, if torque equivalent to the electric power generated by the second stator 73 and the second magnetic field rotational speed NMF2 is referred to as the second electric power-generating equivalent torque TGE2, between the second electric power-generating equivalent torque TGE2 and the third and fourth rotor-transmitted torques TR3 and TR4, there holds the following equation (38). As described above, similarly to the first rotating machine 61, the second rotating machine 71 has the same functions as those of an apparatus formed by combining a planetary gear unit and a general one-rotor-type rotating machine.

TGE2=TR3/β=−TR4/(1+β)=TR3/2=−TR4/3(38)

Through the control of the second PDU 32 and the VCU 33, the ECU 2 controls the electric power supplied to the second stator 73 of the second rotating machine 71 and the second magnetic field rotational speed NMF2 of the second rotating magnetic field generated by the second stator 73 along with the supply of electric power. Further, through the control of the second PDU 32 and the VCU 33, the ECU 2 controls the electric power generated by the second stator 73 and the second magnetic field rotational speed NMF2 of the second rotating magnetic field generated by the second stator 73 along with the electric power generation.

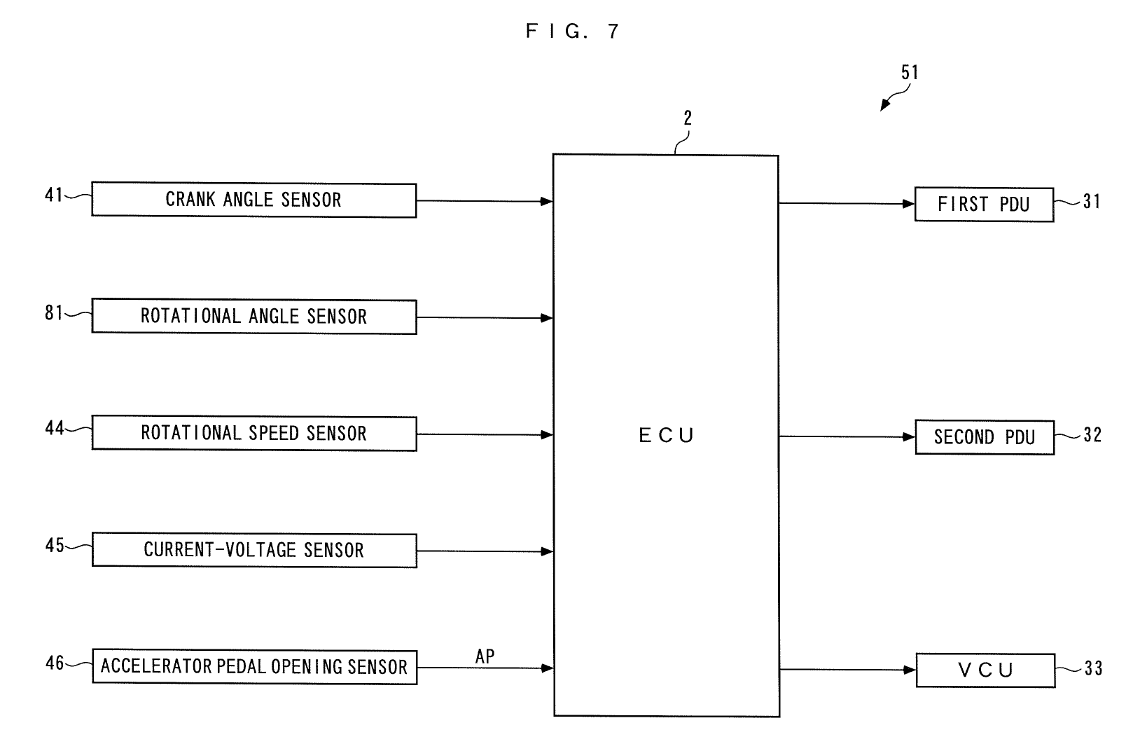

Further, as shown in FIG. 7, a rotational angle sensor 81 delivers a detection signal indicative of a detected rotational angle position of the first rotor 64 with respect to the first stator 63, to the ECU 2. The ECU 2 calculates the first rotor rotational speed NR1 based on the detected rotational angle position of the first rotor 64. Further, as described hereinabove, the first rotor 64 and the fourth rotor 75 are directly connected to each other, and hence the ECU 2 calculates the rotational angle position of the fourth rotor 75 with respect to the second stator 73, based on the detected rotational angle position of the first rotor 64, and calculates the fourth rotor rotational speed NR4. Furthermore, as described hereinabove, since the second and third rotors 65 and 74 are directly connected to the crankshaft 3a, the ECU 2 calculates the rotational angle position of the second rotor 65 with respect to the first stator 63, and the rotational angle position of the third rotor 74 with respect to the second stator 73, based on the rotational angle position of the crankshaft 3a detected by the aforementioned crank angle sensor 41, respectively, and calculates the second and third rotor rotational speed NR2 and NR3, respectively.

The ECU 2 controls the operations of the engine 3 and the first and second rotating machines 61 and 71 based on the detection signals from the aforementioned sensors 41, 44 to 46 and 81 according to control programs stored in the ROM. Similarly to the first embodiment, this causes the vehicle to be operated in various operation modes including the EV creep mode and the EV traveling mode. In this case, due to the difference in construction from the first embodiment, operations in these operation modes are different from the operations in the first embodiment. Hereinafter, a description will be given of the different points. Note that also in the following description, similarly to the first embodiment, a velocity collinear chart as shown in FIG. 24 is used. First, a description is given of this velocity collinear chart.

As is apparent from the above-described connection relationship between the various rotary elements of the power plant 51, the second and third rotor rotational speeds NR2 and NR3 are equal to each other, and are equal to the engine speed NE. Further, the first and fourth rotor rotational speeds NR1 and NR4 are equal to each other, and are equal to the drive wheel rotational speed NDW provided that a change in speed e.g. by the planetary gear unit PS is ignored. Furthermore, the first magnetic field rotational speed NMF1, and the first and second rotor rotational speeds NR1 and NR2 are in a predetermined collinear relationship expressed by the equation (28), and the second magnetic field rotational speed NMF2, and the third and fourth rotor rotational speeds NR3 and NR4 are in a predetermined collinear relationship expressed by the equation (36).

From the above, the relationship between the engine speed NE, the drive wheel rotational speed NDW, and the first and second magnetic field rotational speeds NMF1 and NMF2 is represented by a single velocity collinear chart as shown in FIG. 24. Hereafter, the operation modes will be described with reference to FIG. 24, in order from the EV creep mode.

[EV Creep Mode]

During the EV creep mode, electric power is supplied from the battery 34 to the first stator 63 of the first rotating machine 61 to cause the first rotating magnetic field to perform normal rotation, and electric power is generated by the second stator 73 using motive power transmitted, as described hereinafter, to the third rotor 74 of the second rotating machine 71. Further, the generated electric power is further supplied to the first stator 63.

As is apparent from FIG. 24, the first driving equivalent torque TSE1 is transmitted to the second and third rotors 65 and 74, and causes the two 65 and 74 to perform normal rotation together with the crankshaft 3a. Further, using the motive power thus transmitted to the third rotor 74, electric power is generated by the second stator 73, as described above, and the second rotating magnetic field is generated along with the electric power generation. In this case, since the third rotor 74 is caused to perform normal rotation, and the fourth rotor rotational speed NR4 is approximately equal to 0, the second rotating magnetic field is caused to perform reverse rotation. Furthermore, the second electric power-generating equivalent torque TGE2 generated along with the electric power generation by the second stator 73 acts on the second magnetic field rotational speed NMF2 of the second rotating magnetic field performing reverse rotation to cause the second magnetic field rotational speed NMF2 to be lowered. Further, the first driving equivalent torque TSE1 is transmitted not only to the crankshaft 3a but also to the drive wheels DW and DW, using the second electric power-generating equivalent torque TGE2 as a reaction force. This causes a torque for causing the drive wheels DW and DW to perform normal rotation to act on the drive wheels DW and DW, so that the drive wheels DW and DW are caused to rotate at a very low rotational speed, whereby the creep operation of the vehicle is performed.

Further, during the EV creep mode, the electric power supplied to the first stator 63 and the electric power generated by the second stator 73 are controlled such that the drive wheel rotational speed NDW becomes very low and at the same time the first and second magnetic field rotational speeds NMF1 and NMF2 do not become high. The first and second magnetic field rotational speeds NMF1 and NMF2 are controlled such that they do not become high, as described above, for the following reason: During the EV creep mode, as described above, part of the motive power of the first rotating machine 61 is transmitted to the second rotating machine 71, and is converted to electric power by the second rotating machine 71, whereafter the electric power is supplied to the first rotating machine 61, for being output again from the first rotating machine 61 as motive power. As described above, during the EV creep mode, in the first and second rotating machines 61 and 71, power circulation is caused in which part of the motive power output from the first rotating machine 61 is input to the first rotating machine 61 in a state converted to electric power by the second rotating machine 71, whereby it is output again from the first rotating machine 61 as motive power, and hence the control is performed so as to suppress losses due to the power circulation.

[EV Standing Start Mode]

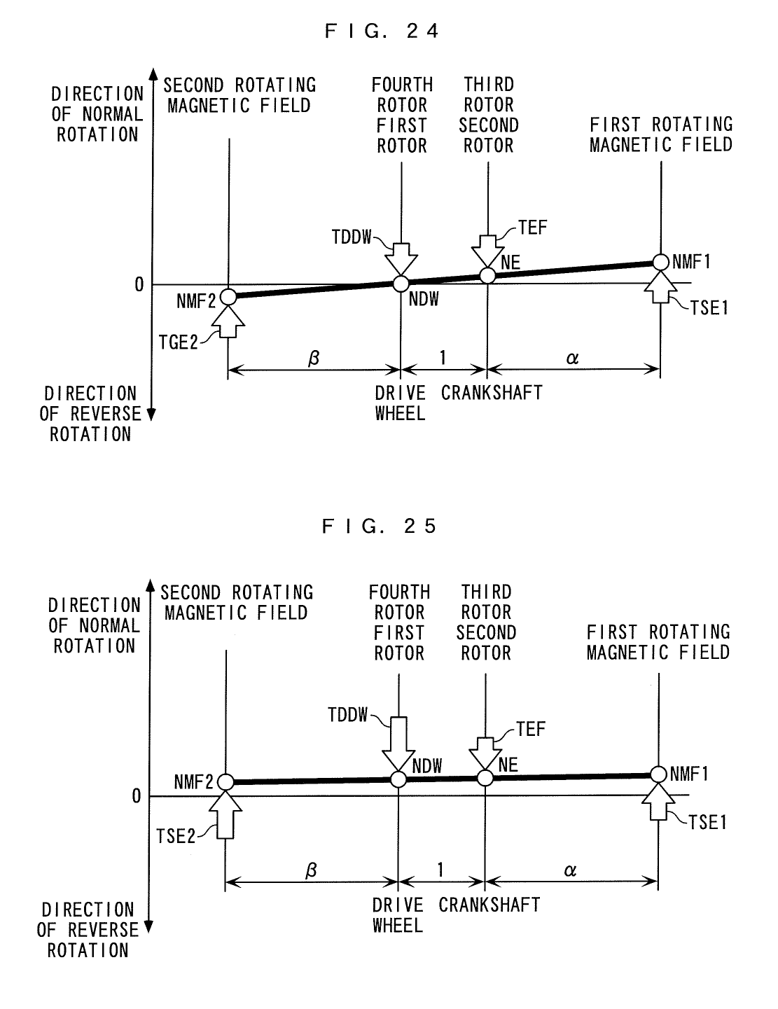

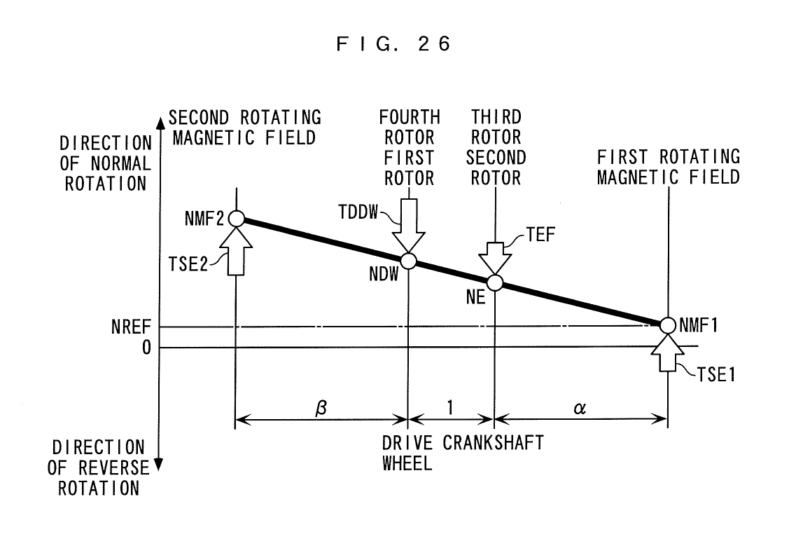

During the EV standing start mode, immediately after a shift from the EV creep mode, similarly to the case of the EV creep mode, electric power is supplied from the battery 34 to the first stator 63 to cause the first rotating magnetic field to perform normal rotation, and electric power is generated in the second stator 73. Further, the electric power supplied to the first stator 63 is increased, and the second magnetic field rotational speed NMF2 of the second rotating magnetic field performing reverse rotation is controlled such that it becomes equal to 0. Then, after the second magnetic field rotational speed NMF2 has become equal to 0, electric power is supplied not only to the first stator 63 but also to the second stator 73 from the battery 34 to cause the second rotating magnetic field to perform normal rotation. FIG. 25 shows the relationship between the rotational speeds of the rotary elements of the power plant and the relationship between torques thereof, in this case.

As is apparent from FIG. 25, the second driving equivalent torque TSE2 is transmitted to the drive wheels DW and DW and the crankshaft 3a, using the first driving equivalent torque TSE1 as a reaction force. In other words, combined torque formed by combining the first and second driving equivalent torques TSE1 and TSE2 is transmitted to the drive wheels DW and DW and the crankshaft 3a. By controlling the operations of the first and second rotating machines 61 and 71 as described above, motive power transmitted from the first and second rotating machines 61 and 71 to the drive wheels DW and DW is more increased than in the case of the EV creep mode, whereby the drive wheel rotational speed NDW is increased in the direction of normal rotation to in turn cause the vehicle to start forward.

[EV Traveling Mode]

The EV traveling mode is selected when the first and fourth rotor rotational speeds NR1 and NR4, determined by the drive wheel rotational speed NDW, are not smaller than the aforementioned predetermined value NREF. Further, during the EV traveling mode, similarly to the case of the EV standing start mode shown in FIG. 25, electric power is supplied to both the first and second stators 63 and 73 from the battery 34 and the first and second rotating magnetic fields are caused to perform normal rotation. FIG. 26 shows the relationship between the rotational speeds of the rotary elements of the power plant and the relationship between torques thereof, in the EV traveling mode.

As is apparent from FIG. 26, during the EV traveling mode, similarly to the case of the EV standing start mode, combined torque formed by combining the first and second driving equivalent torques TSE1 and TSE2 is transmitted to the drive wheels DW and DW and the crankshaft 3a, whereby the drive wheels DW and DW and the crankshaft 3a continue to perform normal rotation. Further, as shown in FIG. 26, during the EV traveling mode, the first magnetic field rotational speed NMF1 is controlled such that it becomes equal to the above-mentioned predetermined value NREF. Because of this fact and the fact that the EV traveling mode is selected when the first and fourth rotor rotational speeds NR1 and NR4, determined by the drive wheel rotational speed NDW, are not smaller than the predetermined value NREF, as mentioned above, during the EV traveling mode, the second and third rotor rotational speeds NR2 and NR3 become equal to or lower the first and fourth rotor rotational speeds NR1 and NR4, respectively.

Further, as described above, the first magnetic field rotational speed NMF1 is controlled such that it becomes equal to the predetermined value NREF, and hence the second magnetic field rotational speed NMF2 is controlled such that there holds the following equation (39):

NMF2={(1+a+β)NDW−β·NREF}/(1+α) (39)

Furthermore, by controlling the electric powers supplied to the first and second stators 63 and 73, the first and second driving equivalent torques TSE1 and TSE2 are controlled such that the torque TDDW transmitted to the drive wheels DW and DW becomes equal to the demanded torque TREQ. In this case, since the friction TEF of the engine 3 acts on the second and third rotors 65 and 74, the electric powers supplied to the first and second stators 63 and 73 are controlled such that there hold the following equations (40) and (41), respectively:

TSE1=−{β·TREQ+(β+1)TEF}/(β+1+α) (40)

TSE2=−{(α+1)TREQ+α·TEF}/(α+1+β) (41)

The above-described second embodiment corresponds to the invention as claimed in claims 4 to 6 and 12 to 15. Correspondence between the elements of the second embodiment and elements of the invention as claimed in claims 4 to 6 and 12 to 15 (hereinafter generically referred to as the “invention 2”) is as follows: The drive wheels DW and DW, the engine 3 and the crankshaft 3a of the second embodiment correspond to driven parts, a prime mover, and an output portion of the invention 2; and the ECU 2, the VCU 33, and the first and second PDUs 31 and 32 of the second embodiment correspond to a control system of the invention 2.

Further, the permanent magnets 64a and 74a of the second embodiment correspond to first and second permanent magnets of the invention as claimed in claims 4 to 6, respectively, and the cores 65a and 75a correspond to first and second soft magnetic materials of the invention as claimed in claims 4 to 6, respectively.

Further, the first and second rotating machines 61 and 71 of the second embodiment correspond to the electric power and motive power input/output device of the invention as claimed in claims 12 to 14, and the first and second stators 63 and 73 of the second embodiment correspond to the first and second rotating magnetic field-generating means of the invention as claimed in claims 12 to 14, respectively. Further, the second and third rotors 65 and 74 of the second embodiment correspond to the first element of the invention as claimed in claims 12 to 14, and the first and fourth rotors 64 and 75 of the second embodiment correspond to the second element of the invention as claimed in claims 12 to 14. Further, the first magnetic field rotational speed NMF1 of the second embodiment corresponds to the rotational speed of the first rotating magnetic field of the invention as claimed in claim 14. Furthermore, the iron core 63a and the U-phase to W-phase coils 63c to 63e of the second embodiment correspond to a first armature row of the invention as claimed in claim 15, and the iron core 73a and the U-phase to W-phase coils 73b of the second embodiment correspond to a second armature row of the invention as claimed in claim 15.

As described hereinabove, according to the second embodiment, during the EV traveling mode, when electric power is supplied from the battery 34 to both the first and second stators 63 and 73, motive power is output from both the first and second rotating machines 61 and 71. Thus, during the EV traveling mode, the operations of the first and second rotating machines 61 and 71 are controlled such that the aforementioned power circulation is not caused in the first and second rotating machines 61 and 71. Therefore, in the EV traveling mode, it is possible to prevent losses due to the power circulation, thereby making it possible to enhance driving efficiency in driving the drive wheels DW and DW.

Further, during the EV traveling mode, the operations of the first and second rotating machines 61 and 71 are controlled such that the second and third rotor rotational speeds NR2 and NR3 of the second and third rotors 65 and 74 directly connected to the crankshaft 3a of the engine 3 become equal to or lower than the first and fourth rotor rotational speeds NR1 and NR4 of the first and fourth rotors 64 and 75 connected to the drive wheels DW and DW, respectively. This makes it possible to hold the engine speed NE in a relatively low state, so that it is possible to prevent motive power from being wastefully transmitted from the first and second rotating machines 61 and 71 to the crankshaft 3a, whereby it is possible to further enhance the driving efficiency.

Furthermore, during the EV traveling mode, the operations of the first and second rotating machines 61 and 71 are controlled such that the first magnetic field rotational speed NMF1 becomes higher than 0. This makes it possible to prevent the first rotating machine 61 and the first PDU 31 from being overheated, and ensure a sufficiently large output torque of the first rotating machine 61.

Further, by setting the ratio between the number of the first armature magnetic poles, the number of the first magnet magnetic poles, and the number of the cores 65a as desired within a range satisfying the condition of 1:m:(1+m)/2 (m≠1.0), it is possible to freely set a collinear relationship between the first rotating magnetic field and the first and second rotors 64 and 65 with respect to rotational speed. This makes it possible to enhance the degree of freedom in design of the first rotating machine 61. Similarly, in the second rotating machine 71, by setting the ratio between the number of the second armature magnetic poles, the number of the second magnet magnetic poles, and the number of the cores 75a as desired within a range satisfying a condition of 1:n:(1+n)/2 (n≠1.0), it is possible to freely set a collinear relationship between the second rotating magnetic field and the third and fourth rotors 74 and 75 with respect to rotational speed. This makes it possible to enhance the degree of freedom in design of the second rotating machine 71.

For the same reason described above, by setting the aforementioned first pole pair number ratio α to a smaller value, the distance between a straight line representing the second rotor rotational speed NR2 and a straight line representing the first magnetic field rotational speed NMF1 can be set shorter in the velocity collinear chart. This makes it possible to efficiently obtain the above-mentioned effects, i.e. the effects that it is possible to prevent the first rotating machine 61 and the first PDU 31 from being overheated and ensure a sufficiently large output torque of the first rotating machine 61 while enhancing driving efficiency.

Note that although in the second embodiment, the second and third rotors 65 and 74 are directly connected to each other, if they are mechanically connected to the crankshaft 3a, they are not necessarily required to be directly connected to each other, and although the first and fourth rotors 64 and 75 are directly connected to each other, if they are mechanically connected to the drive wheels DW and DW, they are not necessarily required to be directly connected to each other. Further, although in the second embodiment, the second and third rotors 65 and 74 are directly connected to the crankshaft 3a, they may be mechanically connected to the crankshaft 3a via gears, a pulley, a chain, a transmission, or the like. Furthermore, although in the second embodiment, the first and fourth rotors 64 and 75 are connected to the drive wheels DW and DW via the chain CH and the differential gear DG, they may be mechanically directly connected to the drive wheels DW and DW.

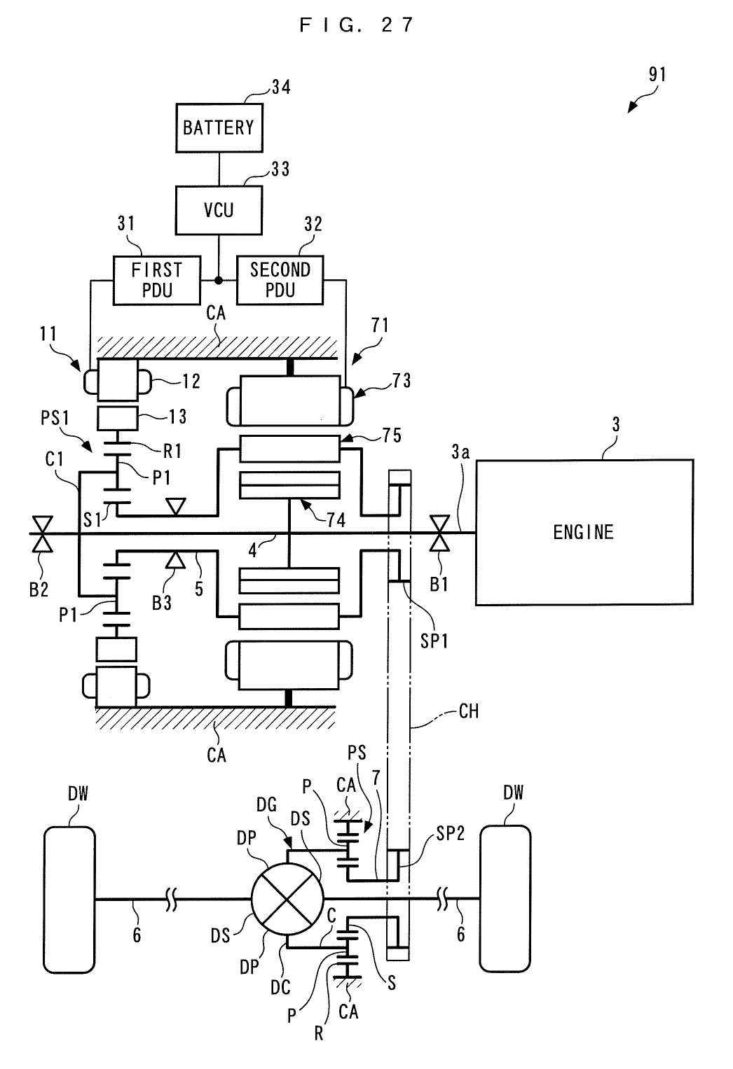

Next, a power plant 91 according to a third embodiment of the present invention will be described with reference to FIG. 27. This power plant 91 is distinguished from the first embodiment mainly in that it includes the second rotating machine 71 described in the second embodiment in place of the second rotating machine 21 and the second planetary gear unit PS2. In other words, the power plant 91 is distinguished from the second embodiment mainly in that it includes the first rotating machine 11 and the first planetary gear unit PS1 described in the first embodiment in place of the first rotating machine 61. The following description is mainly given of different points of the power plant 91 from the first and second embodiments.

As shown in FIG. 27, in the power plant 91, the first carrier C1 of the first planetary gear unit PS1 and the third rotor 74 of the second rotating machine 71 are mechanically directly connected to each other, and are mechanically directly connected to the crankshaft 3a. Further, the first sun gear S1 of the first planetary gear unit PS1 and the fourth rotor 75 of the second rotating machine 71 are mechanically directly connected to each other, and are mechanically connected to the drive wheels DW and DW via the first sprocket SP1, the planetary gear unit PS, the differential gear DG, and so forth. Furthermore, the first rotor 13 of the first rotating machine 11 is mechanically directly connected to the first ring gear R1 of the first planetary gear unit PS1. Further, the first stator 12 of the first rotating machine 11 and the second stator 73 of the second rotating machine 71 are electrically connected to each other via the first and second PDUs 31 and 32, and is configured to be capable of mutually giving and receiving electric power therebetween.

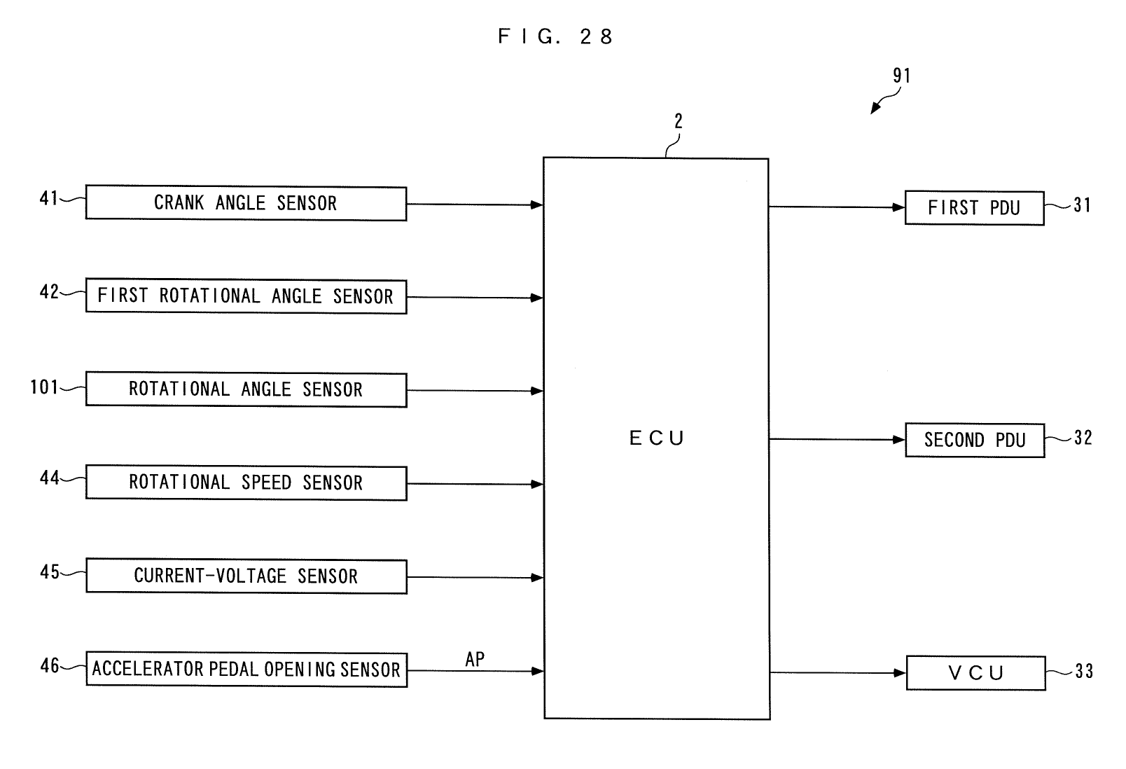

Further, as shown in FIG. 28, a rotational angle sensor 101 delivers a detection signal indicative of a detected rotational angle position of the fourth rotor 75 with respect to the second stator 73, to the ECU 2. The ECU 2 calculates the fourth rotor rotational speed NR4 based on the detected rotational angle position of the fourth rotor 75.

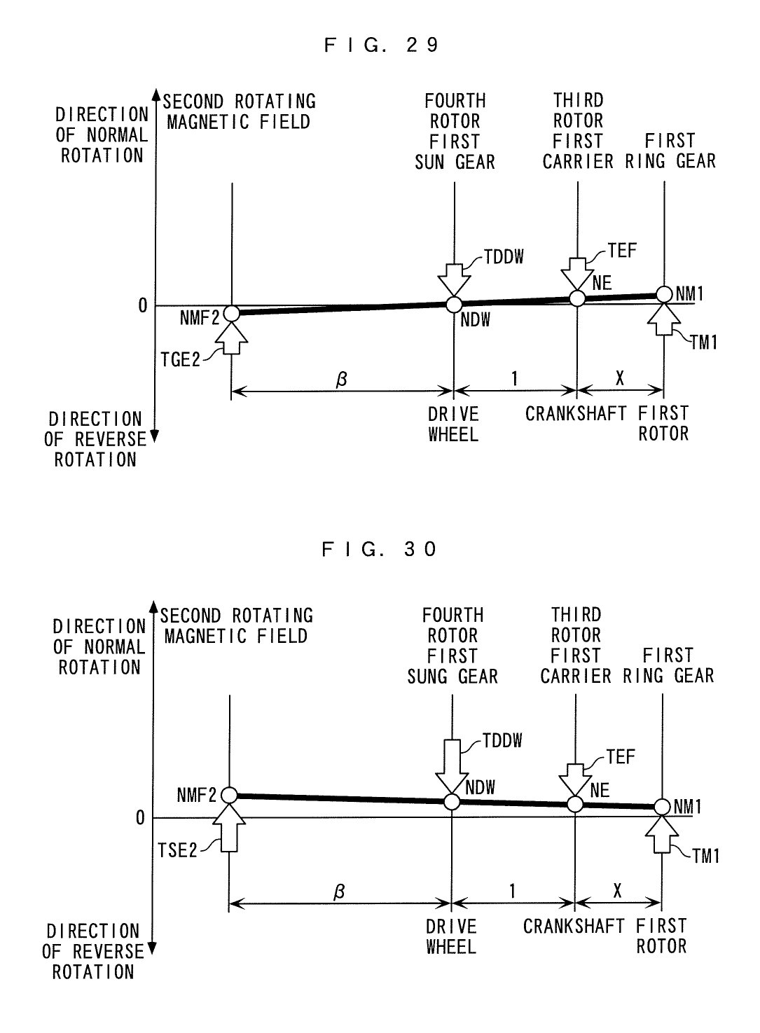

The ECU 2 controls the operations of the engine 3 and the first and second rotating machines 11 and 71 based on the detection signals from the aforementioned sensors 41, 42, 44 to 46 and 101 according to control programs stored in the ROM. Similarly to the first and second embodiments, this causes the vehicle to be operated in various operation modes including the EV creep mode, the EV standing start mode, and the EV traveling mode. In this case, due to the difference in construction from the above-described first and second embodiments, operations in these operation modes are different from the operations in the first and second embodiments. Hereinafter, a description will be given of the different points. Note that also in the following description, similarly to the first and second embodiments, a velocity collinear chart as shown in FIG. 29 is used. First, a description is given of this velocity collinear chart.

As is apparent from the above-described connection relationship between the various rotary elements of the power plant 91, the rotational speed of the first carrier C1 and the third rotor rotational speed NR3 are equal to each other, and are equal to the engine speed NE. Further, the rotational speed of the first sun gear S1 and the fourth rotor rotational speed NR4 are equal to each other, and are equal to the drive wheel rotational speed NDW provided that a change in speed e.g. by the planetary gear unit PS is ignored. Furthermore, the first sun gear S1, the first carrier C1, and the first ring gear R1 are in a predetermined collinear relationship defined by the number of the gear teeth of the first sun gear S1 and that of the gear teeth of the first ring gear R1, and the second magnetic field rotational speed NMF2, and the third and fourth rotor rotational speeds NR3 and NR4 are in a predetermined collinear relationship expressed by the aforementioned equation (36).

From the above, the relationship between the engine speed NE, the drive wheel rotational speed NDW, the first rotating machine rotational speed NM1, and the second magnetic field rotational speed NMF2 is represented by a single velocity collinear chart as shown in FIG. 29. Hereafter, the operation modes will be described with reference to FIG. 29, in order from the EV creep mode.

[EV Creep Mode]

During the EV creep mode, electric power is supplied from the battery 34 to the first stator 12 of the first rotating machine 11 to cause the first rotor 13 to perform normal rotation, and electric power is generated by the second stator 73 using motive power transmitted, as described hereinafter, to the third rotor 74 of the second rotating machine 71. Further, the generated electric power is further supplied to the first stator 12.

As is apparent from FIG. 29, the first powering torque TM1 is transmitted to the first carrier C1 and the third rotor 74, and causes the two C1 and 74 to perform normal rotation together with the crankshaft 3a. Further, electric power is generated by the second stator 73, as described above, using motive power thus transmitted to the third rotor 74, and the second rotating magnetic field is generated along with the electric power generation. In this case, since the third rotor 74 is caused to perform normal rotation, and the fourth rotor rotational speed NR4 is approximately equal to 0, the second rotating magnetic field is caused to perform reverse rotation. Furthermore, the second electric power-generating equivalent torque TGE2 generated along with the electric power generation by the second stator 73 acts on the second magnetic field rotational speed NMF2 of the second rotating magnetic field performing reverse rotation to lower the second magnetic field rotational speed NMF2. Further, the first powering torque TM1 is transmitted not only to the crankshaft 3a but also to the drive wheels DW and DW, using the second electric power-generating equivalent torque TGE2 as a reaction force. This causes a torque for causing the drive wheels DW and DW to perform normal rotation to act on the drive wheels DW and DW, so that the drive wheels DW and DW are caused to rotate at a very low rotational speed, whereby the creep operation of the vehicle is performed.

Further, during the EV creep mode, the electric power supplied to the first stator 12 and the electric power generated by the second stator 73 are controlled such that the drive wheel rotational speed NDW becomes very low and at the same time the first rotating machine rotational speed NM1 and the second magnetic field rotational speed NMF2 do not become high. The first rotating machine rotational speed NM1 and the second magnetic field rotational speed NMF2 are controlled such that they do not become high, as described above, for the following reason: During the EV creep mode, as described above, part of the motive power of the first rotating machine 11 is transmitted to the second rotating machine 71 via the first planetary gear unit PS1, and is converted to electric power by the second rotating machine 71, whereafter the electric power is supplied to the first rotating machine 11, for being output again from the first rotating machine 11 as motive power. Thus, during the EV creep mode, in the first and second rotating machines 11 and 71, power circulation is caused in which part of the motive power output from the first rotating machine 11 is input to the first rotating machine 11 in a state converted to electric power by the second rotating machine 71, and is output again from the first rotating machine 11 as motive power, and hence the control is performed so as to suppress losses due to the power circulation.

[EV Standing Start Mode]

During the EV standing start mode, immediately after a shift from the EV creep mode, similarly to the case of the EV creep mode, electric power is supplied from the battery 34 to the first stator 12 to cause the first rotor 13 to perform normal rotation, and electric power is generated by the second stator 73. Further, the electric power supplied to the first stator 12 is increased, and the second magnetic field rotational speed NMF2 of the second rotating magnetic field performing reverse rotation is controlled such that it becomes equal to 0. Then, after the second magnetic field rotational speed NMF2 has become equal to 0, electric power is supplied not only to the first stator 12 but also to the second stator 73 from the battery 34 to cause the second rotating magnetic field to perform normal rotation. FIG. 30 shows the relationship between the rotational speeds of the rotary elements of the power plant and the relationship between torques thereof, in this case.

As is apparent from FIG. 30, the second driving equivalent torque TSE2 is transmitted to the drive wheels DW and DW and the crankshaft 3a, using the first powering torque TM1 as a reaction force. In other words, combined torque formed by combining the first powering torque TM1 and the second driving equivalent torque TSE2 is transmitted to the drive wheels DW and DW and the crankshaft 3a. By controlling the operations of the first and second rotating machines 11 and 71 as described above, motive power transmitted from the first and second rotating machines 11 and 71 to the drive wheels DW and DW is more increased than in the case of the EV creep mode, so the drive wheel rotational speed NDW is increased in the direction of normal rotation to in turn cause the vehicle to start forward.

[EV Traveling Mode]

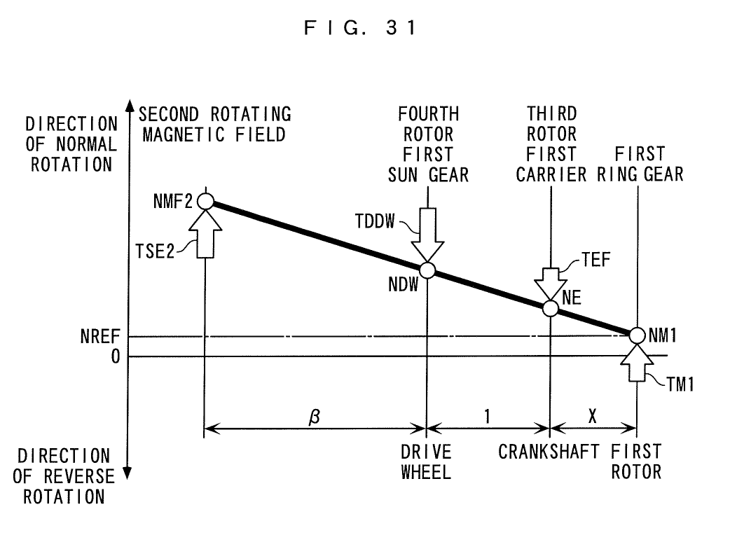

The EV traveling mode is selected when the rotational speed of the first sun gear S1 and the fourth rotor rotational speed NR4, determined by the drive wheel rotational speed NDW, are not smaller than the predetermined value NREF. Further, during the EV traveling mode, similarly to the case of the EV standing start mode shown in FIG. 30, electric power is supplied to both the first and second stators 12 and 73 from the battery 34 and the first rotor 13 and the second rotating magnetic field are caused to perform normal rotation. FIG. 31 shows the relationship between the rotational speeds of the rotary elements and the relationship between torques thereof, in the EV traveling mode.

As is apparent from FIG. 31, during the EV traveling mode, similarly to the case of the EV standing start mode, combined torque formed by combining the first powering torque TM1 and the second driving equivalent torque TSE2 is transmitted to the drive wheels DW and DW and the crankshaft 3a, whereby the drive wheels DW and DW and the crankshaft 3a continue to perform normal rotation. Further, as shown in FIG. 31, during the EV traveling mode, the first rotating machine rotational speed NM1 is controlled such that it becomes equal to the predetermined value NREF. Because of this fact and the fact that the EV traveling mode is selected when the rotational speed of the first sun gear S1 and the fourth rotor rotational speed NR4, determined by the drive wheel rotational speed NDW as described above, are not smaller than the predetermined value NREF, the rotational speeds of the first carrier C1 and the third rotor rotational speed NR3 become equal to or lower than the rotational speed of the first sun gear S1 and the fourth rotor rotational speed NR4, respectively, during the EV traveling mode.

Further, since the first rotating machine rotational speed NM1 is controlled as described above such that it becomes equal to the predetermined value NREF, the second magnetic field rotational speed NMF2 is controlled such that there holds the following equation (42):

NMF2={(1+X+β)NDW−β·NREF}/(1+X) (42)

Furthermore, by controlling the electric powers supplied to the first and second stators 12 and 73, the first powering torque TM1 and the second driving equivalent torque TSE2 are controlled such that the torque TDDW transmitted to the drive wheels DW and DW becomes equal to the demanded torque TREQ. In this case, since the friction TEF of the engine 3 acts on the first carrier C1 and the third rotor 74, the electric powers supplied to the first and second stators 12 and 73 are controlled such that there hold the following equations (43) and (44), respectively:

TM1=−{β·TREQ+(β+1)TEF}(β+1+X) (43)

TSE2=−{(X+1)TREQ+X·TEF}/(X+1+β) (44)

The above-mentioned third embodiment corresponds to the invention as claimed in claims 7 to 9 and 12 to 14. Correspondence between the elements of the third embodiment and elements of the invention as claimed in claims 7 to 9 and 12 to 14 (hereinafter referred to as the “invention 3”, when generically referred to) is as follows: The drive wheels DW and DW and the engine 3 of the third embodiment correspond to driven parts and a prime mover of the invention 3, respectively. Further, the crankshaft 3a of the third embodiment corresponds to a first output portion of the invention as claimed in claims 7 to 9, and an output portion of the invention as claimed in claims 12 to 14. Furthermore, the ECU 2, the VCU 33, and the first and second PDUs 31 and 32 of the third embodiment correspond to a control system of the invention 3.

The first rotor 13 of the third embodiment corresponds to a second output portion of the invention as claimed in claims 7 to 9, and the first planetary gear unit PS1, the first sun gear S1, the first carrier C1, and the first ring gear R1 of the third embodiment correspond to a power transmission mechanism, a first element, a second element, and a third element of the invention as claimed in claims 7 to 9, respectively. Further, the second stator 73, and the third and fourth rotors 74 and 75 of the third embodiment correspond to a stator, and first and second rotors of the invention as claimed in claims 7 to 9, respectively. Further, the permanent magnets 74a and the cores 75a of the third embodiment correspond to magnets and soft magnetic material elements of the invention as claimed in claims 7 to 9, respectively.

Furthermore, the first rotating machine 11, the first planetary gear unit PS1 and the second rotating machine 71 of the third embodiment correspond to the electric power and motive power input/output device of the invention as claimed in claims 12 to 14, and the first and second stators 12 and 73 of the third embodiment correspond to the first and second rotating magnetic field-generating means of the invention as claimed in claims 12 to 14, respectively. Further, the first carrier C1 and the third rotor 74 of the third embodiment correspond to the first element of the invention as claimed in claims 12 to 14, and the first sun gear S1 and the fourth rotor 75 of the third embodiment correspond to the second element of the invention as claimed in claims 12 to 14. Furthermore, the first rotating machine rotational speed NM1 of the third embodiment corresponds to the rotational speed of the first rotating magnetic field of the invention as claimed in claim 14. Further, the iron core 73a and the U-phase to W-phase coils 73b of the third embodiment correspond to an armature row of the invention as claimed in claim 16.

As described hereinabove, according to the third embodiment, during the EV traveling mode, when electric power is supplied from the battery 34 to both the first and second stators 12 and 73, motive power is output from both the first and second rotating machines 11 and 71. Thus, during the EV traveling mode, the operations of the first and second rotating machines 61 and 71 are controlled such that the aforementioned power circulation is not caused in the first and second rotating machines 61 and 71. Therefore, in the EV traveling mode, it is possible to prevent losses due to the power circulation, thereby making it possible to enhance driving efficiency in driving the drive wheels DW and DW.

Further, during the EV traveling mode, the operations of the first and second rotating machines 11 and 71 are controlled such that the rotational speed of the first carrier C1 directly connected to the crankshaft 3a of the engine 3 and the third rotor rotational speed NR3 of the third rotor 74 directly connected to the same become equal to or lower than the rotational speed of the first sun gear S1 connected to the drive wheels DW and DW and the fourth rotor rotational speed NR4 of the fourth rotor 75 connected to the same, respectively. This makes it possible to hold the engine speed NE in a relatively low state, so that it is possible to prevent motive power from being wastefully transmitted from the first and second rotating machines 11 and 71 to the crankshaft 3a, whereby it is possible to further enhance the driving efficiency.

Furthermore, during the EV traveling mode, the operations of the first and second rotating machines 11 and 71 are controlled such that the first rotating machine rotational speed NM1 becomes higher than 0. This makes it possible to prevent the first rotating machine 11 and the first PDU 31 from being overheated, and ensure a sufficiently large output torque of the first rotating machine 11. Further, similarly to the second embodiment, it is possible to enhance the degree of freedom in design of the second rotating machine 71.

Note that although in the third embodiment, the first carrier C1 and the third rotor 74 are directly connected to each other, if they are mechanically connected to the crankshaft 3a, they are not necessarily required to be directly connected to each other, and although the first sun gear S1 and the fourth rotor 75 are directly connected to each other, if they are mechanically connected to the drive wheels DW and DW, they are not necessarily required to be directly connected to each other. Further, although in the third embodiment, the first carrier C1 and the third rotor 74 are directly connected to the crankshaft 3a, they may be mechanically connected to the crankshaft 3a via gears, a pulley, a chain, a transmission, or the like.

Furthermore, although in the third embodiment, the first sun gear S1 and the fourth rotor 75 are connected to the drive wheels DW and DW via the chain CH and the differential gear DG, they may be mechanically directly connected to the drive wheels DW and DW. Further, although in the third embodiment, the first ring gear R1 is directly connected to the first rotor 13, it may be mechanically connected to the first rotor 13 via gears, a pulley, a chain, a transmission, or the like.

Furthermore, although in the third embodiment, the first ring gear R1 is connected to the first rotor 13, and the first sun gear S1 is connected to the drive wheels DW and DW, the connection relationships may be inverted, that is, the first ring gear R1 may be connected to the drive wheels DW and DW, and the first sun gear S1 may be connected to the first rotor 13. In this case, naturally, the first sun gear S1 and the first rotor 13 may be mechanically directly connected to each other, or they may be mechanically connected to each other using gears, a pulley, a chain, a transmission, or the like. In addition, the first ring gear R1 may be mechanically connected to the drive wheels DW and DW via gears, a pulley, a chain, a transmission, or the like. Alternatively, it may be mechanically directly connected to the drive wheels DW and DW.

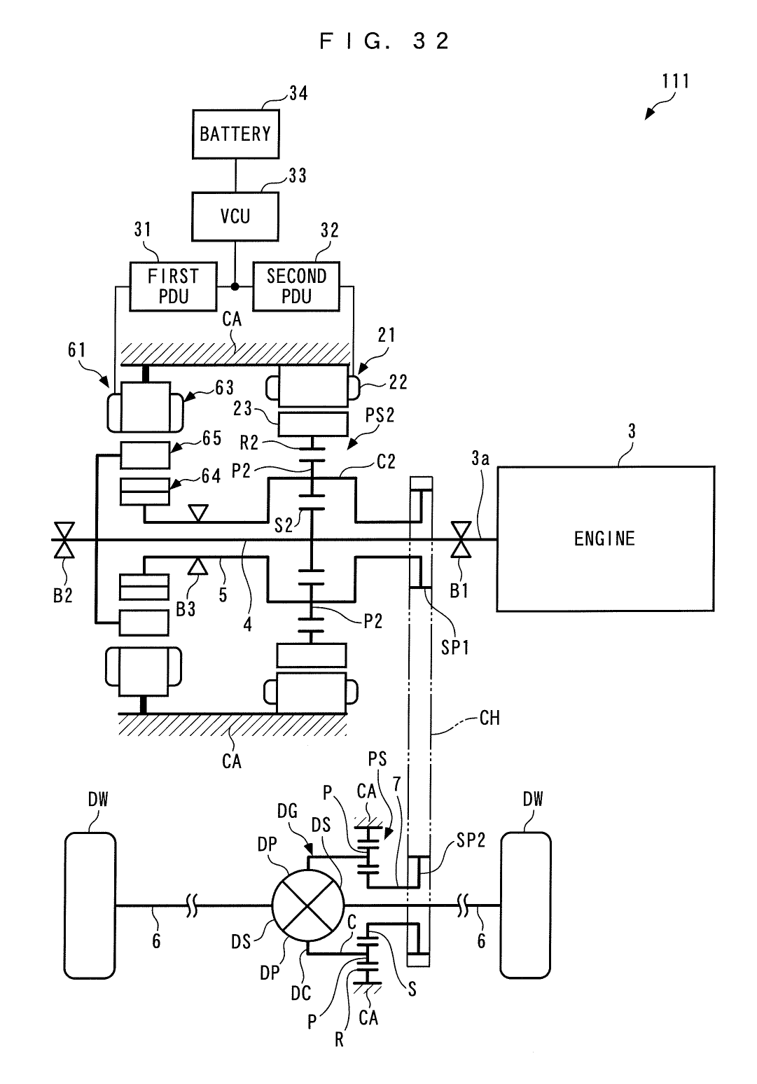

Next, a power plant 111 according to a fourth embodiment of the present invention will be described with reference to FIG. 32. This power plant 111 is distinguished from the first embodiment mainly in that it includes the first rotating machine 61 described in the second embodiment in place of the first rotating machine 11 and the first planetary gear unit PS1. In other words, the power plant 111 is distinguished from the second embodiment mainly in that it includes the second rotating machine 21 and the second planetary gear unit PS2 described in the first embodiment in place of the second rotating machine 71. The following description is mainly given of different points of the power plant 111 from the first and second embodiments.

As shown in FIG. 32, in the power plant 111, the second rotor 65 of the first rotating machine 61 and the second sun gear S2 of the second planetary gear unit PS2 are mechanically directly connected to each other, and are mechanically directly connected to the crankshaft 3a. Further, the first rotor 64 of the first rotating machine 61 and the second carrier C2 of the second planetary gear unit PS2 are mechanically directly connected to each other, and are mechanically connected to the drive wheels DW and DW via the first sprocket SP1, the planetary gear unit PS, the differential gear DG, and so forth. Furthermore, the second rotor 23 of the second rotating machine 21 is mechanically directly connected to the second ring gear R2 of the second planetary gear unit PS2. Further, the first stator 63 of the first rotating machine 61 and the second stator 22 of the second rotating machine 21 are electrically connected to each other via the first and second PDUs 31 and 32, and is configured to be capable of mutually giving and receiving electric power therebetween.

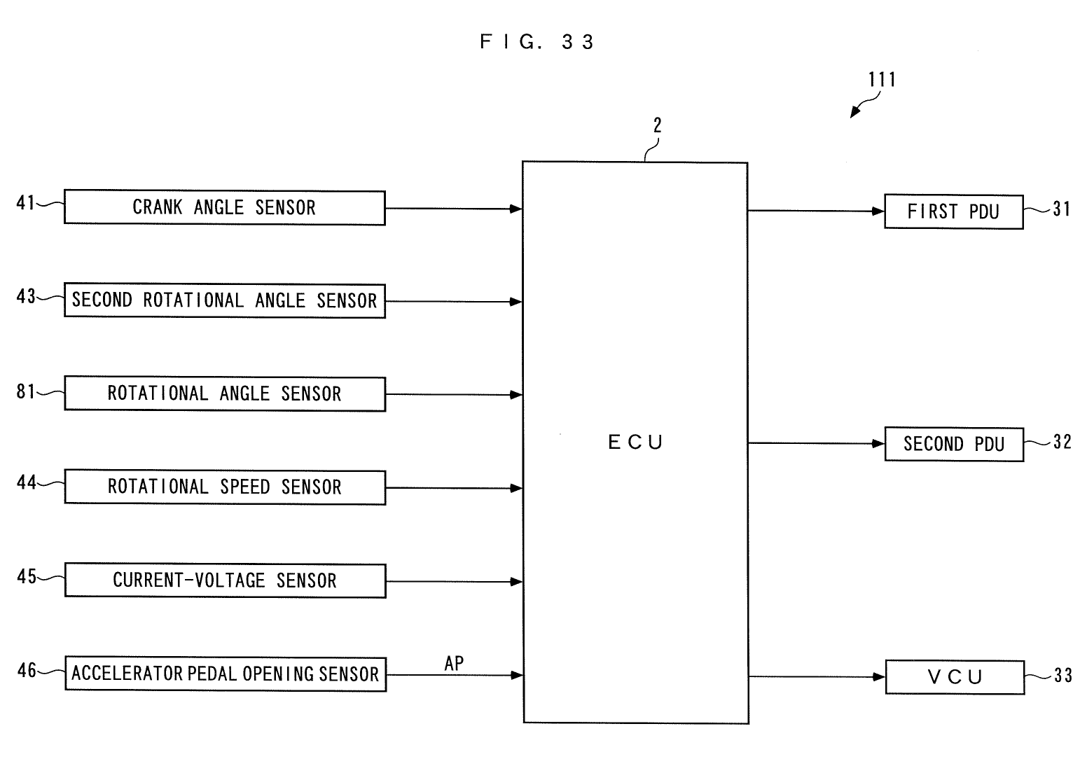

Further, similarly to the first and second embodiments, the ECU 2 calculates the second rotating machine rotational speed NM2 based on the rotational angle position of the second rotor 23 detected by the second rotational angle sensor 43 (see FIG. 33). Furthermore, the ECU 2 calculates the first rotor rotational speed NR1 based on the rotational angle position of the first rotor 64 detected by the rotational angle sensor 81. Further, the ECU 2 calculates the second rotor rotational speed NR2 based on the crank angle position detected by the crank angle sensor 41.

The ECU 2 controls the operations of the engine 3 and the first and second rotating machines 61 and 21 based on the detection signals from the aforementioned sensors 41, 43 to 46 and 81 according to control programs stored in the ROM. Similarly to the first to third embodiments, this causes the vehicle to be operated in various operation modes including the EV creep mode, the EV standing start mode, and the EV traveling mode. In this case, due to the difference in construction from the above-described first to third embodiments, operations in these operation modes are different from the operations in the case of the first to third embodiments, and hereinafter, a description will be given of the different points. Note that also in the following description, similarly to the first to third embodiments, a velocity collinear chart as shown in FIG. 34 is used. First, a description is given of this velocity collinear chart.

As is apparent from the above-described connection relationship between the various rotary elements of the power plant 111, the second rotor rotational speed NR2 and the rotational speed of the second sun gear S2 are equal to each other, and are equal to the engine speed NE. Further, the first rotor rotational speed NR1 and the rotational speed of the second carrier C2 are equal to each other, and are equal to the drive wheel rotational speed NDW provided that a change in speed e.g. by the planetary gear unit PS is ignored. Furthermore, the first magnetic field rotational speed NMF1, and the first and second rotor rotational speeds NR1 and NR2 are in a predetermined collinear relationship expressed by the aforementioned equation (28), and the rotational speeds of the second sun gear S2, the second carrier C2 and the second ring gear R2 are in a predetermined collinear relationship defined by the number of the gear teeth of the second sun gear S2 and that of the gear teeth of the second ring gear R2.

As described above, the relationship between the engine speed NE, the drive wheel rotational speed NDW, the first magnetic field rotational speed NMF1, and the second rotating machine rotational speed NM2 is represented by a single velocity collinear chart as shown in FIG. 34. Now, the operation modes will be described with reference to FIG. 34, in order from the EV creep mode. Note that in FIG. 34 and other velocity collinear charts, described hereinafter, in order to identify the second rotor 65 of the first rotating machine 61 and the second rotor 23 of the second rotating machine 21, reference numerals thereof are parenthesized.

[EV Creep Mode]

During the EV creep mode, electric power is supplied from the battery 34 to the first stator 63 of the first rotating machine 61 to cause the first rotating magnetic field to perform normal rotation, and electric power is generated by the second stator 22 using motive power transmitted, as described hereinafter, to the second rotor 23 of the second rotating machine 21. Further, the generated electric power is further supplied to the first stator 63.

As is apparent from FIG. 34, the first driving equivalent torque TSE1 is transmitted to the second rotor 65 and the second sun gear S2, causing the two 65 and S2 to perform normal rotation together with the crankshaft 3a. Further, the first driving equivalent torque TSE1 transmitted to the second sun gear S2 is transmitted to the second rotor 23 via the second ring gear R2 using the load of the drive wheels DW and DW acting on the second carrier C2 as a reaction force, causing the second rotor 23 to perform reverse rotation together with the second ring gear R2. Electric power is generated by the second stator 22, as described above, using motive power thus transmitted to the second rotor 23, and the second electric power generation torque TG2 generated along with the electric power generation acts on the second ring gear R2 performing reverse rotation to brake the second ring gear R2. Further, the first driving equivalent torque TSE1 is transmitted not only to the crankshaft 3a but also to the drive wheels DW and DW, using the second electric power generation torque TG2 as a reaction force. This causes a torque for causing the drive wheels DW and DW to perform normal rotation to act on the drive wheels DW and DW, so that the drive wheels DW and DW are caused to rotate at a very low rotational speed, whereby the creep operation of the vehicle is performed.

Further, during the EV creep mode, the electric power supplied to the first stator 63 and the electric power generated by the second stator 22 are controlled such that the drive wheel rotational speed NDW becomes very low and at the same time the first magnetic field rotational speed NMF1 and the second rotating machine rotational speed NM2 do not become high. The first magnetic field rotational speed NMF1 and the second rotating machine rotational speed NM2 are controlled such that they do not become high, as described above, for the following reason: During the EV creep mode, as described above, part of the motive power of the first rotating machine 61 is transmitted to the second rotating machine 21 via the second planetary gear unit PS2, and is converted to electric power by the second rotating machine 21, whereafter the electric power is supplied to the first rotating machine 61, for being output again from the first rotating machine 61 as motive power. Thus, during the EV creep mode, in the second planetary gear unit PS2, and the first and second rotating machines 61 and 21, power circulation is caused in which part of the motive power output from the first rotating machine 61 is input to the first rotating machine 61 in a state converted to electric power by the second rotating machine 21, and is output again from the first rotating machine 61 as motive power, and hence the control is performed so as to suppress losses due to the power circulation.

[EV Standing Start Mode]

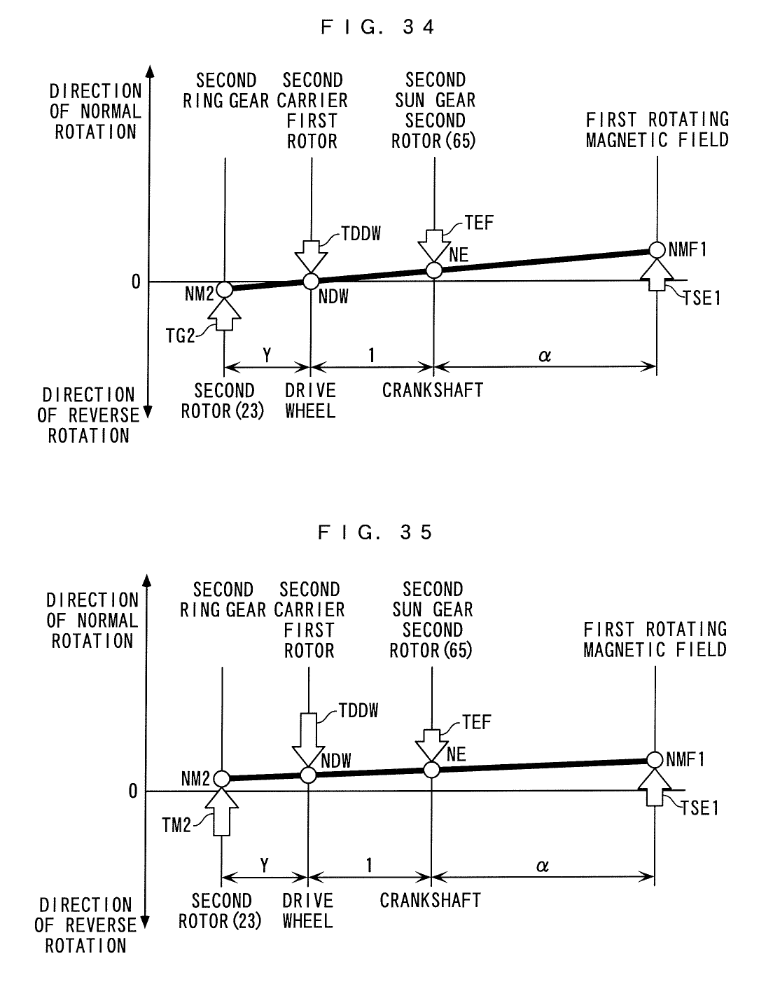

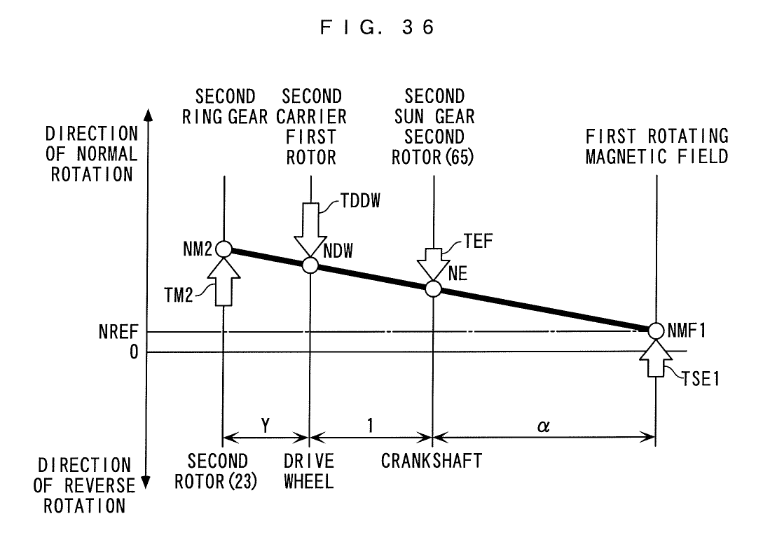

During the EV standing start mode, immediately after a shift from the EV creep mode, similarly to the case of the EV creep mode, electric power is supplied from the battery 34 to the first stator 63 to cause the first rotating magnetic field to perform normal rotation, and electric power is generated by the second stator 22. Further, the electric power supplied to the first stator 63 is increased, and the second rotating machine rotational speed NM2 of the second rotor 23 performing reverse rotation is controlled such that it becomes equal to 0. Then, after the second rotating machine rotational speed NM2 has become equal to 0, electric power is supplied not only to the first stator 63 but also to the second stator 22 from the battery 34 to cause the second rotor 23 to perform normal rotation. FIG. 35 shows the relationship between the rotational speeds of the rotary elements of the power plant and the relationship between torques thereof, in this case.

As is apparent from FIG. 35, the second powering torque TM2 is transmitted to the drive wheels DW and DW and the crankshaft 3a, using the first driving equivalent torque TSE1 as a reaction force. In other words, combined torque formed by combining the first driving equivalent torque TSE1 and the second powering torque TM2 is transmitted to the drive wheels DW and DW and the crankshaft 3a. By controlling the operations of the first and second rotating machines 61 and 21 as described above, motive power transmitted from the first and second rotating machines 61 and 21 to the drive wheels DW and DW is more increased than in the case of the EV creep mode, so that the drive wheel rotational speed NDW is increased in the direction of normal rotation to in turn cause the vehicle to start forward.

[EV Traveling Mode]

The EV traveling mode is selected when the first rotor rotational speed NR1 and the rotational speed of the second carrier C2, determined by the drive wheel rotational speed NDW, are not smaller than the aforementioned predetermined value NREF. Further, during the EV traveling mode, in the case of the EV standing start mode shown in FIG. 35, electric power is supplied to both the first and second stators 63 and 22 from the battery 34 to cause the first rotating magnetic field and the second rotor 23 to perform normal rotation. FIG. 36 shows the relationship between the rotational speeds of the rotary elements of the power plant and the relationship between torques thereof, in the EV traveling mode.

As is apparent from FIG. 36, during the EV traveling mode, similarly to the case of the EV standing start mode, combined torque formed by combining the first driving equivalent torque TSE1 and the second powering torque TM2 is transmitted to the drive wheels DW and DW and the crankshaft 3a, whereby the drive wheels DW and DW and the crankshaft 3a continue to perform normal rotation. Further, as shown in FIG. 36, during the EV traveling mode, the first magnetic field rotational speed NMF1 is controlled such that it becomes equal to the above-mentioned predetermined value NREF. Because of this fact and the fact that the EV traveling mode is selected when the first rotor rotational speed NR1 and the rotational speed of the second carrier C2, determined by the drive wheel rotational speed NDW as described above, are not smaller than the predetermined value NREF, during the EV traveling mode, the second rotor rotational speed NR2 and the rotational speed of the sun gear S2 become equal to or lower than the first rotor rotational speed NR1 and the rotational speed of the second carrier C2, respectively.

Further, as described above, the first magnetic field rotational speed NMF1 is controlled such that it becomes equal to the predetermined value NREF, and hence the second rotating machine rotational speed NM2 is controlled such that there holds the following equation (45):

NM2={(1+α+Y)NDW−Y·NREF}/(1+α) (45)

Furthermore, by controlling the electric powers supplied to the first and second stators 63 and 22, the first driving equivalent torque TSE1 and the second powering torque TM2 are controlled such that the torque TDDW transmitted to the drive wheels DW and DW becomes equal to the demanded torque TREQ. In this case, since the friction TEF of the engine 3 acts on the second rotor 65 and the second sun gear S2, the electric powers supplied to the first and second stators 63 and 22 are controlled such that there hold the following equations (46) and (47), respectively:

TSE1=−{Y·TREQ+(Y+1)TEF}/(Y+1+α) (46)

TM2=−{(α+1)TREQ+α·TEF}/(α+1+Y) (47)

The above-described fourth embodiment corresponds to the invention as claimed in claims 7, 10, 11 and 12 to 14. Correspondence between the elements of the third embodiment and elements of the invention as claimed in claims 7, 10, 11 and 12 to 14 (hereinafter generically referred to as the “invention 4”) is as follows: The drive wheels DW and DW and the engine 3 of the fourth embodiment correspond to driven parts and a prime mover of the invention 4, respectively. Further, the crankshaft 3a of the fourth embodiment corresponds to a first output portion of the invention as claimed in claims 7, 10 and 11, and an output portion of the invention as claimed in claims 12 to 14, respectively. Furthermore, the ECU 2, the VCU 33 and the first and second PDUs 31 and 32 of the fourth embodiment correspond to a control system of the invention 4.

Further, the second rotating machine 21 and the second rotor 23 of the fourth embodiment correspond to a first rotating machine and a second output portion of the invention as claimed in claims 7, 10 and 11, and the second planetary gear unit PS2, the second sun gear S2, the second carrier C2, and the second ring gear R2 of the fourth embodiment correspond to a power transmission mechanism, a first element, a second element, and a third element of the invention as claimed in claims 7, 10 and 11, respectively. Further, the first rotating machine 61 and the first stator 63 of the fourth embodiment correspond to a second rotating machine and a stator of the invention as claimed in claims 7, 10 and 11, respectively. Further, the permanent magnets 64a and the cores 65a of the fourth embodiment correspond to magnets and soft magnetic material elements of the invention as claimed in claims 7, 10 and 11, respectively.

Furthermore, the first rotating machine 61, the second planetary gear unit PS2 and the second rotating machine 21 of the fourth embodiment correspond to an electric power and motive power input/output device of the invention as claimed in claims 12 to 14, and the first and second stators 63 and 22 of the fourth embodiment correspond to first and second rotating magnetic field-generating means of the invention as claimed in claims 12 to 14, respectively. Further, the second rotor 65 and the second sun gear S2 of the fourth embodiment correspond to the first element of the invention as claimed in claims 12 to 14, and the first rotor 64 and the second carrier C2 of the fourth embodiment correspond to the second element of the invention as claimed in claims 12 to 14. Furthermore, the first magnetic field rotational speed NMF1 of the fourth embodiment corresponds to the rotational speed of the first rotating magnetic field of the invention as claimed in claim 14. Further, the iron core 63a and the U-phase to W-phase coils 63c to 63e of the fourth embodiment correspond to an armature row of the invention as claimed in claim 16.

As described hereinabove, according to the fourth embodiment, during the EV traveling mode, when electric power is supplied from the battery 34 to both the first and second stators 63 and 22, motive power is output from both the first and second rotating machines 61 and 21. As described above, during the EV traveling mode, the operations of the first and second rotating machines 61 and 21 are controlled such that the aforementioned power circulation is not caused in the first and second rotating machines 61 and 21. Therefore, in the EV traveling mode, it is possible to prevent losses due to the power circulation, thereby making it possible to enhance driving efficiency in driving the drive wheels DW and DW.

Further, during the EV traveling mode, the operations of the first and second rotating machines 61 and 21 are controlled such that the second rotor rotational speed NR2 of the second rotor 65 directly connected to the crankshaft 3a of the engine 3 and the rotational speed of the second sun gear S2 directly connected to the same become equal to or lower than the first rotor rotational speed NR1 of the first rotor 64 connected to the drive wheels DW and DW and the rotational speed of the second carrier C2 also connected to the same, respectively. This makes it possible to hold the engine speed NE in a relatively low state, so that it is possible to prevent motive power from being wastefully transmitted from the first and second rotating machines 61 and 21 to the crankshaft 3a, whereby it is possible to further enhance the driving efficiency.

Furthermore, during the EV traveling mode, the operations of the first and second rotating machines 61 and 21 are controlled such that the first magnetic field rotational speed NMF1 becomes higher than 0. This makes it possible to prevent the first rotating machine 61 and the first PDU 31 from being overheated, and ensure a sufficiently large output torque of the first rotating machine 61.

Further, similarly to the second embodiment, it is possible to enhance the degree of freedom in design of the first rotating machine 61. In addition to this, by setting the first pole pair number ratio α to a smaller value, it is possible to efficiently obtain the aforementioned advantageous effects, i.e. the effects that it is possible to prevent the first rotating machine 61 and the first PDU 31 from being overheated and ensure a sufficiently large output torque of the first rotating machine 61 while enhancing driving efficiency.

Note that although in the fourth embodiment, the second rotor 65 and the second sun gear S2 are directly connected to each other, if they are mechanically connected to the crankshaft 3a, they are not necessarily required to be directly connected to each other, and although the first rotor 64 and the second carrier C2 are directly connected to each other, if they are mechanically connected to the drive wheels DW and DW, they are not necessarily required to be directly connected to each other. Further, although in the fourth embodiment, the second rotor 65 and the second sun gear S2 are directly connected to the crankshaft 3a, they may be mechanically connected to the crankshaft 3a via gears, a pulley, a chain, a transmission, or the like.

Furthermore, although in the fourth embodiment, the first rotor 64 and the second carrier C2 are connected to the drive wheels DW and DW via the chain CH and the differential gear DG, they may be mechanically directly connected to the drive wheels DW and DW. Further, although in the fourth embodiment, the ring gear R2 is directly connected to the second rotor 23, it may be mechanically connected to the second rotor 23 via gears, a pulley, a chain, a transmission, or the like.

Further, although in the fourth embodiment, the second ring gear R2 is connected to the second rotor 23, and the second sun gear S2 is connected to the crankshaft 3a, the connection relationships may be inverted, that is, the second ring gear R2 may be mechanically connected to the crankshaft 3a, and the second sun gear S2 may be mechanically connected to the second rotor 23. In this case, naturally, the second sun gear S2 and the second rotor 23 may be mechanically directly connected to each other, or they may be mechanically connected to each other using gears, a pulley, a chain, a transmission, or the like. Further, the second ring gear R2 may be mechanically connected to the crankshaft 3a via gears, a pulley, a chain, a transmission, or the like, or it may be mechanically directly connected to the crankshaft 3a.

Further, although in the first, third and fourth embodiments, the first and second planetary gear units PS1 and PS2 of a single pinion type are used, there may be used another suitable mechanism, such as planetary gear units of a double pinion type or the differential gear DG, insofar as it includes the first to third elements that are capable of transmitting motive power while holding a collinear relationship therebetween with respect to the rotational speed. Alternatively, such a mechanism may be employed that has a plurality of rollers for transmitting motive power by friction between surfaces in place of the gears of the planetary gear unit, and has the functions equivalent to the planetary gear unit. Furthermore, although detailed description thereof is omitted, there may be employed such a mechanism as disclosed in Japanese Laid-Open Patent Publication (Kokai) No. 2008-39045, which comprises a combination of a plurality of magnets and soft magnetic material elements.

Furthermore, although in the first, third and fourth embodiments, the first and second rotating machines 11 and 21 are synchronous DC motors, other suitable devices, such as AC motors of a synchronous or induction type, may be used insofar as they are capable of converting input electric power to motive power, and outputting the motive power, and also capable of converting input motive power to electric power.

Further, in the above-described second and fourth embodiments, there are arranged four first armature magnetic poles, eight first magnet magnetic poles, and six cores 65a in the first rotating machine 61. That is, the ratio between the number of the first armature magnetic poles, the number of the first magnet magnetic poles, and the number of the cores 65a is 1:2:1.5, by way of example. However, respective desired numbers of the first armature magnetic poles, the first magnet magnetic poles and the cores 65a can be employed, insofar as the ratio therebetween satisfies 1:m:(1+m)/2 (m≠1.0). Further, although in the second and fourth embodiments, the cores 65a are formed by steel plates, they may be formed by other soft magnetic materials. Further, although in the second and fourth embodiments, the first stator 63 and the first rotor 64 are arranged at an outer location and an inner location in the radial direction, respectively, this is not limitative, but inversely, they may be arranged at an inner location and an outer location in the radial direction, respectively.

Further, although in the second and fourth embodiments, the first rotating machine 61 is constructed as a so-called radial type by arranging the first stator 63 and the first and second rotors 64 and 65 in the radial direction, the first rotating machine 61 may be constructed as a so-called axial type by arranging the first stator 63 and the first and second rotors 64 and 65 in the axial direction. Further, although in the second and fourth embodiments, one first magnet magnetic pole is formed by a magnetic pole of a single permanent magnet 64a, it may be formed by magnetic poles of a plurality of permanent magnets. For example, if one first magnet magnetic pole is formed by arranging two permanent magnets in an inverted-V shape such that the magnetic poles thereof become closer to each other toward the first stator 63, it is possible to improve the directivity of the aforementioned magnetic force line ML. Further, in the second and fourth embodiments, electromagnets may be used in place of the permanent magnets 64a.

Further, although in the second and fourth embodiments, the coils 63c to 63e are formed by three-phase coils of U-phase to W-phase, the number of phases of the coils can be set as desired insofar as the coils can generate the first rotating magnetic field. Further, it is to be understood that in the second and fourth embodiments, a desired number of slots, other than that used in the above-described embodiments may be employed as the number of the slots 63b. Further, although in the second and fourth embodiments, the U-phase to W-phase coils 63c to 63e are wound in the slots 63b by distributed winding, this is not limitative, but they may be wound by concentrated winding. Further, although in the second and fourth embodiments, the slots 63b, the permanent magnets 64a, and the cores 65a are arranged at equally-spaced intervals, they may be arranged at unequally-spaced intervals.

The above-described variations of the first rotating machine 61 similarly apply to the second rotating machine 71 in the second and third embodiments. Further, in the second to fourth embodiments, the first and second rotating machines 61 and 71 each may be replaced by another suitable device, such as a rotating machine disclosed in Japanese Laid-Open Patent Publication (Kokai) No. 2008-179344, insofar as it has the functions as claimed in the claims.

Further, although in the first to fourth embodiments (hereinafter generically referred to as the “embodiment”), the control system for controlling the engine 3, and the first and second rotating machines 11, 61, 21, and 71 are formed by the ECU 2, the VCU 33, and the first and second PDUs 31 and 32, it may be formed by a combination of a microcomputer and an electric circuit. Further, although in the embodiment, the battery 34 is used, any other suitable device, such as a capacitor, may be used insofar as it is an electric power storage device capable of being charged and discharged.

Further, although in the embodiment, the engine 3 as a prime mover is a gasoline engine, it is to be understood that a desired prime mover may be employed which has an output part capable of outputting motive power. For example, as the engine 3 there may be employed various industrial engines other than a gasoline engine, e.g. a diesel engine, and engines for ship propulsion machines, such as an outboard motor having a vertically-disposed crankshaft. Alternatively, there may be employed e.g. an external combustion engine, an electric motor, a water turbine, a windmill, and a human-powered pedal. Furthermore, in the embodiment, desired means for connecting between the rotary elements can be employed insofar as they satisfy the conditions of the present invention. For example, the gears described in the embodiment may be replaced by pulleys or the like. Further, although in the embodiment, the power plants 1, 51, 91 and 111 according to the present invention are applied to a vehicle, by way of example, this is not limitative, but it can be applied to e.g. a boat and an aircraft. It is to be further understood that various changes and modifications may be made without departing from the spirit and scope thereof without departing from the spirit and scope thereof.

### INDUSTRIAL APPLICABILITY

As described above, the power plant according to the present invention is useful in preventing losses due to power circulation during the EV operation mode, thereby enhancing the driving efficiency of the driven parts of the power plant which is provided with a plurality of motive power sources different from each other.

### BRIEF DESCRIPTION OF DRAWINGS

1 power plant
2 ECU (control system)
3 engine (prime mover)
3a crankshaft (output portion, first output portion)
11 first rotating machine (electric power and motive power input/output device)
12 first stator (first rotating magnetic field-generating means)
13 first rotor (second output portion)
21 second rotating machine (first rotating machine, electric power and motive power input/output device)
22 second stator (stator, second rotating magnetic field-generating means)
23 second rotor (second output portion)
31 first PDU (control system)
32 second PDU (control system)
33 VCU (control system)
PS1 first planetary gear unit (power transmission mechanism, electric power and motive power input/output device)
S1 first sun gear (third element, first element, second element)
C1 first carrier (second element, second element, first element)
R1 first ring gear (first element, third element)
PS2 second planetary gear unit (power transmission mechanism, electric power and motive power input/output device)
S2 second sun gear (second element, first element)
C2 second carrier (third element, second element)
R2 second ring gear (fourth element, third element)
51 power plant
61 first rotating machine (second rotating machine, electric power and motive power input/output device)
63 first stator (stator, first rotating magnetic field-generating means)
63a iron core (first armature row, armature row)
63c U-phase coil (first armature row, armature row)
63d V-phase coil (first armature row, armature row)
63e W-phase coil (first armature row, armature row)
64 first rotor (second element)
64a permanent magnet (first magnet, magnet)
65 second rotor (first element)
65a core (first soft magnetic material element, soft magnetic material element)
71 second rotating machine (electric power and motive power input/output device)
73 second stator (stator, second rotating magnetic field-generating means)
73a iron core (second armature row, armature row)
73b U-phase to W-phase coils (second armature row, armature row)
74 third rotor (first rotor, first element)
74a permanent magnet (second magnet, magnet)
75 fourth rotor (second rotor, second element)
75a core (second soft magnetic material element, soft magnetic material element)
91 power plant
111 power plant
DW, DW drive wheels (driven parts)

1. A power plant for driving driven parts, comprising:
a prime mover including a first output portion for outputting motive power;
a first rotating machine including a second output portion;
a power transmission system including a first element, a second element, and a third element that are capable of transmitting motive power therebetween, said first to third elements being configured to rotate while holding a collinear relationship therebetween with respect to rotational speed, and be sequentially aligned in a collinear chart representing the collinear relationship with respect to the rotational speed;
a second rotating machine including an unmovable stator for generating a rotating magnetic field, a first rotor formed by magnets and disposed in a manner opposed to said stator, and a second rotor formed by a soft magnetic material and disposed between said stator and said first rotor, said second rotating machine being configured such that electric power and motive power are input and output between said stator and said first and second rotors along with generation of the rotating magnetic field, and such that the rotating magnetic field, said second rotor, and said first rotor rotate while holding a collinear relationship therebetween with respect to rotational speed, and are sequentially aligned in a collinear chart representing the collinear relationship with respect to the rotational speed; and
a control system for controlling operations of said first and second rotating machines,
wherein one of a pair of said second element and said first rotor and a pair of said first element and said second rotor are connected to said first output portion while the other of the pair of said second element and said first rotor and the pair of said first element and said second rotor are connected to the driven parts, and said third element is connected to said second output portion,
wherein said first rotating machine and said stator are configured to be capable of giving and receiving electric power therebetween, and
wherein said control system controls the operations of said first and second rotating machines such that during an EV operation mode for driving the driven parts by controlling the operations of said first and second rotating machines during stoppage of said prime mover, power circulation is not caused in which part of motive power output from one of said first and second rotating machines is input to the one of said first and second rotating machines in a state converted to electric power by the other of said first and second rotating machines, whereby the part of the motive power is output again from the one of said first and second rotating machines as motive power.

2. The power plant as claimed in claim 1, wherein said second element and said first rotor are connected to said first output portion, while said first element and said second rotor are connected to the driven parts, and
wherein during the EV operation mode, said control system controls the operations of said first and second rotating machines such that rotational speeds of said second element and said first rotor become equal to or lower than rotational speeds of said first element and said second rotor, respectively.

3. The power plant as claimed in claim 2, wherein during the EV operation mode, said control system controls the operations of said first and second rotating machines such that a rotational speed of said second output portion becomes higher than 0.

4. The power plant as claimed in claim 1, wherein said first element and said second rotor are connected to said first output portion, while said second element and said first rotor are connected to the driven parts, and
wherein during the EV operation mode, said control system controls the operations of said first and second rotating machines such that rotational speeds of said first element and said second rotor become equal to or lower than rotational speeds of said second element and said first rotor, respectively.

5. The power plant as claimed in claim 4, wherein during the EV operation mode, said control system controls the operations of said first and second rotating machines such that a rotational speed of the rotating magnetic field becomes higher than 0.

6. The power plant as claimed in any one of claims 1 to 5, wherein a predetermined plurality of magnet magnetic poles arranged in a circumferential direction are formed by said magnets, and a magnetic pole row is formed by arranging the plurality of magnet magnetic poles such that each two magnet magnetic poles adjacent to each other have polarities different from each other,
wherein said first rotor is configured to be rotatable in the circumferential direction,
wherein said stator has an armature row that generates a predetermined plurality of armature magnetic poles, to thereby cause the rotating magnetic field rotating in the circumferential direction to be generated between said armature row and said magnetic pole row,
wherein said soft magnetic material is formed by a predetermined plurality of soft magnetic material elements arranged in the circumferential direction in a manner spaced from each other, and a soft magnetic material element row formed by said plurality of soft magnetic material elements is disposed between said magnetic pole row and said armature row,
wherein said second rotor is configured to be rotatable in the circumferential direction, and
wherein a ratio between the number of the armature magnetic poles, the number of the magnet magnetic poles, and the number of said soft magnetic material elements is set to 1:m:(1+m)/2 (m≠1.0).

7. A power plant for driving driven parts, comprising:
a prime mover including an output portion for outputting motive power;
a first rotating machine including a first rotor;
a second rotating machine including a second rotor;
a control system for controlling operations of said first and second rotating machines; and
a power transmission mechanism including at least a first element, a second element, a third element, and a fourth element that are capable of transmitting motive power therebetween, said first to fourth elements being configured to rotate while holding a collinear relationship therebetween with respect to rotational speed, and be sequentially aligned in a collinear chart representing the collinear relationship with respect to the rotational speed,
wherein said first to fourth elements are connected to said first rotor, said output portion, the driven parts, and said second rotor, respectively,
wherein said first and second rotating machines are configured to be capable of giving and receiving electric power therebetween, and
wherein said control system controls the operations of said first and second rotating machines such that during an EV operation mode for driving the driven parts by controlling the operations of said first and second rotating machines during stoppage of said prime mover, power circulation is not caused in which part of motive power output from one of said first and second rotating machines is input to the one of said first and second rotating machines in a state converted to electric power by the other of said first and second rotating machines, whereby the part of the motive power is output again from the one of said first and second rotating machines as motive power.

8. The power plant as claimed in claim 7, wherein during the EV operation mode, said control system controls the operations of said first and second rotating machines such that a rotational speed of said second element becomes equal to or lower than a rotational speed of said third element.

9. The power plant as claimed in claim 8, wherein during the EV operation mode, said control system controls the operations of said first and second rotating machines such that a rotational speed of said first rotor becomes higher than 0.

10. A power plant for driving driven parts, comprising:
a prime mover including an output portion for outputting motive power;
a first rotating machine including an unmovable first stator for generating a first rotating magnetic field, a first rotor formed by first magnets and disposed in a manner opposed to said first stator, and a second rotor formed by a first soft magnetic material and disposed between said first stator and said first rotor, said first rotating machine being configured such that electric power and motive power are input and output between said first stator and said first and second rotors along with generation of the first rotating magnetic field, and such that the first rotating magnetic field, said second rotor, and said first rotor rotate while holding a collinear relationship therebetween with respect to rotational speed, and are sequentially aligned in a collinear chart representing the collinear relationship with respect to the rotational speed;
a second rotating machine including an unmovable second stator for generating a second rotating magnetic field, a third rotor formed by second magnets and disposed in a manner opposed to said second stator, and a fourth rotor formed by a second soft magnetic material and disposed between said second stator and said third rotor, said second rotating machine being configured such that electric power and motive power are input and output between said second stator and said third and fourth rotors along with generation of the second rotating magnetic field, and such that the second rotating magnetic field, said fourth rotor, and said third rotor rotate while holding a collinear relationship therebetween with respect to rotational speed, and are sequentially aligned in a collinear chart representing the collinear relationship with respect to the rotational speed; and
a control system for controlling operations of said first and second rotating machines,
wherein said second and third rotors are connected to said output portion, while said first and fourth rotors are connected to the driven parts,
wherein said first and second stators are configured to be capable of giving and receiving electric power therebetween, and
wherein said control system controls the operations of said first and second rotating machines such that during an EV operation mode for driving the driven parts by controlling the operations of said first and second rotating machines during stoppage of said prime mover, power circulation is not caused in which part of motive power output from one of said first and second rotating machines is input to the one of said first and second rotating machines in a state converted to electric power by the other of said first and second rotating machines, whereby the part of the motive power is output again from the one of said first and second rotating machines as motive power.

11. The power plant as claimed in claim 10, wherein during the EV operation mode, said control system controls the operations of said first and second rotating machines such that rotational speeds of said second rotor and said third rotor become equal to or lower than rotational speeds of said first rotor and said fourth rotor, respectively.

12. The power plant as claimed in claim 11, wherein during the EV operation mode, said control system controls the operations of said first and second rotating machines such that a rotational speed of the first rotating magnetic field becomes higher than 0.

13. The power plant as claimed in any one of claims 10 to 12, wherein a predetermined plurality of first magnet magnetic poles arranged in a first circumferential direction are formed by said first magnets, and a first magnetic pole row is formed by arranging the plurality of first magnet magnetic poles such that each two first magnet magnetic poles adjacent to each other have polarities different from each other,
wherein said first rotor is configured to be rotatable in the first circumferential direction,
wherein said first stator has a first armature row that generates a predetermined plurality of first armature magnetic poles, to thereby cause the first rotating magnetic field rotating in the first circumferential direction to be generated between said first armature row and said first magnetic pole row,
wherein said first soft magnetic material is formed by a predetermined plurality of first soft magnetic material elements arranged in the first circumferential direction in a manner spaced from each other, and a first soft magnetic material element row formed by said plurality of first soft magnetic material elements is disposed between said first magnetic pole row and said first armature row,
wherein said second rotor is configured to be rotatable in the first circumferential direction, and
wherein a ratio between the number of the first armature magnetic poles, the number of the first magnet magnetic poles, and the number of said first soft magnetic material elements is set to 1:m:(1+m)/2 (m≠1.0),
wherein a predetermined plurality of second magnet magnetic poles arranged in a second circumferential direction are formed by said second magnets, and a second magnetic pole row is formed by arranging the plurality of second magnet magnetic poles such that each two second magnet magnetic poles adjacent to each other have polarities different from each other,
wherein said third rotor is configured to be rotatable in the second circumferential direction,
wherein said second stator has a second armature row that generates a predetermined plurality of second armature magnetic poles, to thereby cause the second rotating magnetic field rotating in the second circumferential direction to be generated between said second armature row and said second magnetic pole row;
wherein said second soft magnetic material is formed by a predetermined plurality of second soft magnetic material elements arranged in the second circumferential direction in a manner spaced from each other, and a second soft magnetic material element row formed by said plurality of second soft magnetic material elements is disposed between said second magnetic pole row and said second armature row;
wherein said fourth rotor is configured to be rotatable in the second circumferential direction; and
wherein a ratio between the number of the second armature magnetic poles, the number of the second magnet magnetic poles, and the number of said second soft magnetic material elements is set to 1:n:(1+n)/2 (n≠1.0).

14. A power plant for driving driven parts, comprising:
a prime mover including an output portion for outputting motive power;
an electric power and motive power input/output device including first rotating magnetic field-generating means unmovable for generating a first rotating magnetic field, second rotating magnetic field-generating means unmovable for generating a second rotating magnetic field, a first element which is rotatable, and a second element which is rotatable, said electric power and motive power input/output device being configured such that electric power and motive power are input and output between the first rotating magnetic field-generating means, said first element, said second element, and said second rotating magnetic field-generating means, along with generation of the first and second rotating magnetic fields, and such that the first rotating magnetic field, said first element, said second element, and the second rotating magnetic field rotate while holding a collinear relationship therebetween with respect to rotational speed, and are sequentially aligned in a collinear chart representing the collinear relationship with respect to the rotational speed; and
a control system for controlling an operation of said electric power and motive power input/output device,
wherein said first and second elements are connected to said output portion and the driven parts, respectively,
wherein said first and second rotating magnetic field-generating means are configured to be capable of giving and receiving electric power therebetween, and
wherein said control system controls the operation of said electric power and motive power input/output device such that during an EV operation mode for driving the driven parts by controlling the operation of said electric power and motive power input/output device during stoppage of said prime mover, power circulation is not caused in which part of motive power output by inputting electric power to one of said first and second rotating magnetic field-generating means is input to the one of said first and second rotating magnetic field-generating means in a state converted to electric power by the other of said first and second rotating magnetic field-generating means, whereby the part of the motive power is output again as motive power.

15. The power plant as claimed in claim 14, wherein during the EV operation mode, said control system controls the operation of said electric power and motive power input/output device such that a rotational speed of said first element becomes equal to or lower than a rotational speed of said second element.

16. The power plant as claimed in claim 15, wherein during the EV operation mode, said control system controls the operation of said electric power and motive power input/output device such that a rotational speed of the first rotating magnetic field becomes higher than 0.
